(19) United States
(12) Patent Application Publication
(10) Pub. No.: US 2025/0061400 A1
(43) Pub. Date: Feb. 20, 2025

(54) MID-AIR COLLISION (MAC) RISK MODELS AND SYSTEMS AND METHODS FOR GENERATING MAC RISK MAPS

(71) Applicant: The Boeing Company, Arlington, VA (US)

(72) Inventors: Brendan Patrick Williams, Brisbane (AU); Reece Alexander Clothier, Brisbane (AU); Aaron McFadyen, Brisbane (AU); Guilherme Froes Silva, Brisbane (AU)

(21) Appl. No.: 18/649,593

(22) Filed: Apr. 29, 2024

Related U.S. Application Data
(60) Provisional application No. 63/519,451, filed on Aug. 14, 2023.

(51) Int. Cl. G06Q 10/0635; G06Q 50/40

(52) U.S. Cl. CPC G06Q 10/0635; G06Q 50/40

(57) ABSTRACT

Mid-air collision (MAC) risk models and systems and methods for generating MAC risk maps are disclosed. An example apparatus disclosed herein includes at least one processor circuit to determine a horizontal distance and a vertical distance between a grid location in an airspace and a point of a flight trajectory, the flight trajectory associated with an encounter event with respect to the grid location, determine a first overlap probability between (a) a first horizontal probability distribution corresponding to the grid location and (b) a second horizontal probability distribution corresponding to the point, the second horizontal probability distribution corresponding to the horizontal distance, determine a second overlap probability between (c) a first vertical probability distribution corresponding to the grid location and (d) a second vertical probability distribution corresponding to the point, the second vertical probability distribution corresponding to the vertical distance, determine, based on the first overlap probability and the second overlap probability, a risk metric corresponding to the grid location, and generate a risk map based on the risk metric.

### RELATED APPLICATION

This patent claims the benefit of U.S. Provisional Patent Application No. 63/519,451, which was filed on Aug. 14, 2023. U.S. Provisional Patent Application No. 63/519,451 is hereby incorporated herein by reference in its entirety. Priority to U.S. Provisional Patent Application No. 63/519,451 is hereby claimed.

### FIELD OF THE DISCLOSURE

This disclosure relates generally to mid-air collision models and, more particularly, to mid-air collision (MAC) risk models and systems and methods for generating MAC risk maps.

### BACKGROUND

Some aircraft, such as uncrewed aircraft systems (UASs), are commonly used to fly relatively large distances to perform operations such as payload transportation, information gathering, etc. In some high-traffic regions of an airspace, multiple aircraft may fly in relatively close proximity to one another. As such, a flight trajectory of the aircraft is typically selected to navigate the aircraft to a target destination while avoiding collision with other aircraft.

### SUMMARY

An example apparatus disclosed herein includes interface circuitry, machine-readable instructions, and at least one processor circuit to be programmed by the machine-readable instructions to determine a horizontal distance and a vertical distance between a grid location in an airspace and a point of a flight trajectory, the flight trajectory associated with an encounter event with respect to the grid location. The at least one processor circuit is to determine a first overlap probability between (a) a first horizontal probability distribution corresponding to the grid location and (b) a second horizontal probability distribution corresponding to the point, the second horizontal probability distribution corresponding to the horizontal distance, determine a second overlap probability between (c) a first vertical probability distribution corresponding to the grid location and (d) a second vertical probability distribution corresponding to the point, the second vertical probability distribution corresponding to the vertical distance, determine, based on the first overlap probability and the second overlap probability, a risk metric corresponding to the grid location, and generate a risk map based on the risk metric.

At least one example non-transitory machine-readable medium disclosed herein includes machine-readable instructions to cause at least one processor circuit to at least determine a horizontal distance and a vertical distance between a grid location in an airspace and a point of a flight trajectory, the flight trajectory associated with an encounter event with respect to the grid location, determine a first overlap probability between (a) a first horizontal probability distribution corresponding to the grid location and (b) a second horizontal probability distribution corresponding to the point, the second horizontal probability distribution corresponding to the horizontal distance, determine a second overlap probability between (c) a first vertical probability distribution corresponding to the grid location and (d) a second vertical probability distribution corresponding to the point, the second vertical probability distribution corresponding to the vertical distance, determine, based on the first overlap probability and the second overlap probability, a risk metric corresponding to the grid location, and generate a risk map based on the risk metric.

An example method disclosed herein includes determining a horizontal distance and a vertical distance between a grid location in an airspace and a point of a flight trajectory, the flight trajectory associated with an encounter event with respect to the grid location, determining a first overlap probability between (a) a first horizontal probability distribution corresponding to the grid location and (b) a second horizontal probability distribution corresponding to the point, the second horizontal probability distribution corresponding to the horizontal distance, determining a second overlap probability between (c) a first vertical probability distribution corresponding to the grid location and (d) a second vertical probability distribution corresponding to the point, the second vertical probability distribution corresponding to the vertical distance, determining, based on the first overlap probability and the second overlap probability, a risk metric corresponding to the grid location, and generating a risk map based on the risk metric.

### BRIEF DESCRIPTION OF THE DRAWINGS

FIG. 1 illustrates an example environment in which example risk estimation circuitry can be implemented in accordance with teachings of this disclosure.

FIG. 2 is a block diagram of an example implementation of the example risk estimation circuitry of FIG. 1.

FIG. 3A illustrates an example grid location in an example airspace with respect to an example vertical plane.

FIG. 3B illustrates the example grid location in the example airspace of FIG. 3A with respect to an example horizontal plane.

FIG. 4 illustrates an example plot representative of the example airspace of FIGS. 3A and/or 3B including the grid location and an example flight trajectory.

FIG. 5A illustrates a first example plot representative of first and second horizontal positional distributions.

FIG. 5B illustrates a second example plot representative of an example overlap probability between the first and second horizontal positional distributions of FIG. 5A.

FIG. 6A illustrates a first example risk map representative of example probabilities of a near mid-air collision (NMAC) given an encounter.

FIG. 6B illustrates a second example risk map representative of example probabilities of an encounter given a movement.

FIG. 7 illustrates a third example risk map representative of example probabilities of a MAC given a movement.

FIG. 8A illustrates a fourth example risk map representative of example collision rates per flight hour.

FIG. 8B illustrates a fifth example risk map representative of example collision rates per hour.

FIG. 9 illustrates a first example quantitative model-based risk map and a first example qualitative model-based risk map corresponding to a first example altitude level.

FIG. 10 illustrates a second example quantitative model-based risk map and a second example qualitative model-based risk map corresponding to a second example altitude level.

FIG. 11 illustrates a third example quantitative model-based risk map and a third example qualitative model-based risk map corresponding to a third example altitude level.

FIG. 12 illustrates a fourth example quantitative model-based risk map and a fourth example qualitative model-based risk map corresponding to a fourth example altitude level.

FIG. 13A illustrates an example risk map generated based on data-informed gas model(s), where the first risk map is representative of example collision rates for a first geographic region using example outer airspace regions.

FIG. 13B illustrates a second example risk map generated based on data-informed gas model(s), where the second risk map is representative of example collision rates for the first geographic region of FIG. 13A using example inner airspace regions.

FIG. 14A illustrates a first example risk map generated using data-driven gas model(s) and corresponding to a first example altitude level.

FIG. 14B illustrates a second example risk map generated using data-driven gas model(s) and corresponding to a second example altitude level.

FIG. 15A illustrates a third example risk map generated using data-driven gas model(s) and corresponding to a third example altitude level.

FIG. 15B illustrates a fourth example risk map generated using data-driven gas model(s) and corresponding to a fourth example altitude level.

FIG. 16A illustrates an example risk map including an example mission trajectory generated and/or evaluated by the example risk estimation circuitry of FIGS. 1 and/or 2.

FIG. 16B illustrates an example table representative of example collision risk statistics corresponding to the example mission trajectory of FIG. 16A.

FIG. 16C illustrates a first example graph representative of expected example MAC counts corresponding to a first example flight speed.

FIG. 16D illustrates a second example graph representative of expected example MAC counts corresponding to a second example flight speed.

FIG. 17 illustrates an example risk map representative of example collision rates per hour corresponding to Aberdeen, United Kingdom, and an altitude level of 1000 feet (ft).

FIG. 18 illustrates first example quantitative model-based risk map and second example qualitative model-based risk maps representative of example collision rates per hour corresponding to Christchurch, New Zealand, at a first altitude level of 400 ft.

FIG. 19 illustrates third example quantitative model-based risk map and fourth example qualitative model-based risk maps representative of example collision rates per hour corresponding to Christchurch, New Zealand, at a second altitude level of 4000 ft.

FIG. 20A illustrates first and second example plots representative of an example Merz frame approach that may be utilized to determine turn direction of aircraft in proximity.

FIG. 20B illustrates an example diagram representative of an example geometric minimum miss-distance approach that may be utilized to determine turn direction of aircraft in proximity.

FIG. 21A illustrates a first example contour risk map in which different risk metric values are represented using corresponding example shaded areas.

FIG. 21B illustrates a second example contour map in which the different risk metric values are represented using corresponding example contour lines.

FIG. 22 illustrates an example risk map including an example flight plan generated by the example risk metric estimation circuitry of FIGS. 1 and/or 2.

FIG. 23 is a flowchart representative of example machine readable instructions and/or example operations that may be executed, instantiated, and/or performed by example programmable circuitry to implement the example risk estimation circuitry of FIGS. 1 and/or 2 to generate one or more example risk maps.

FIG. 24 is a flowchart representative of example machine readable instructions and/or example operations that may be executed, instantiated, and/or performed by example programmable circuitry to implement the example risk estimation circuitry of FIGS. 1 and/or 2 to select one or more example flight trajectories corresponding to example selected altitude level(s).

FIG. 25 is a flowchart representative of example machine readable instructions and/or example operations that may be executed, instantiated, and/or performed by example programmable circuitry to implement the example risk estimation circuitry of FIGS. 1 and/or 2 to determine one or more example closest points of approach (CPAs).

FIG. 26 is a flowchart representative of example machine readable instructions and/or example operations that may be executed, instantiated, and/or performed by example programmable circuitry to implement the example risk estimation circuitry of FIGS. 1 and/or 2 to determine example encounter counts and/or example encounter durations.

FIG. 27 is a flowchart representative of example machine readable instructions and/or example operations that may be executed, instantiated, and/or performed by example programmable circuitry to implement the example risk estimation circuitry of FIGS. 1 and/or 2 to determine example overlap probabilities.

FIG. 28 is a flowchart representative of example machine readable instructions and/or example operations that may be executed, instantiated, and/or performed by example programmable circuitry to implement the example risk estimation circuitry of FIGS. 1 and/or 2 to determine one or more example risk metrics.

FIG. 29 is a flowchart representative of example machine readable instructions and/or example operations that may be executed, instantiated, and/or performed by example programmable circuitry to implement the example risk estimation circuitry of FIGS. 1 and/or 2 to evaluate example risk metric(s) corresponding to an example mission trajectory.

FIG. 30 is a flowchart representative of example machine readable instructions and/or example operations that may be executed, instantiated, and/or performed by example programmable circuitry to implement the example risk estimation circuitry of FIGS. 1 and/or 2 to adjust a flight plan based on inferred intent of an aircraft.

FIG. 31 is a block diagram of an example processing platform including programmable circuitry structured to execute, instantiate, and/or perform the example machine readable instructions and/or perform the example operations of FIGS. 23-30 to implement the risk estimation circuitry 102 of FIG. 2.

FIG. 32 is a block diagram of an example implementation of the programmable circuitry of FIG. 31.

FIG. 33 is a block diagram of another example implementation of the programmable circuitry of FIG. 31.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Typically, flight trajectories for an aircraft are selected with the intention to reduce (e.g., minimize) risk of collision, such as mid-air collisions (MACs), with other aircraft. Known methods for determining collision avoidance maneuvers typically do not consider mid-air collision risk data. Instead, crewed aircraft rely on human real-time detection and/or intervention for avoidance of mid-air collisions, which may be prone to error.

In some instances, collision risk can be estimated and/or characterized for respective different regions of an airspace to facilitate selection and/or generation of flight trajectories. Some known approaches for characterizing collision risk within an airspace are based on gas model(s), simulation model(s) and/or qualitative model(s) where the latter classifies regions of the airspace according to predefined risk classes (e.g., Air Risk Classes (ARCs)). These known approaches do not typically account for uncertainty associated with positions of aircraft in the airspace and do not recover localized aircraft behavior(s), pattern(s), and/or structure and, thus, may inaccurately predict the presence or absence of aircraft in one or more locations of the airspace. Further, by classifying regions of an airspace based on a set of predetermined risk classes, some known approaches may suffer from averaging effects and generalizations and may not accurately capture variations in collision risk between different locations within the airspace regions.

Example methods are disclosed herein for the generation and/or utilization of example risk maps (e.g., MAC risk maps) including geo-referenced collision risk estimates that may facilitate manned and/or uncrewed aircraft system (UAS) operations in an airspace. Examples disclosed herein provide a quantitative, data-driven, and probabilistic approach to estimating the collision risk (e.g., air risk, MAC risk) for corresponding altitude level(s) and/or region(s) for which example surveillance data is available or partially available. Examples disclosed herein estimate collision risk for respective geographic location(s) based on discrete components (e.g., risk components) associated with the causal events leading to a collision (e.g., movement(s), encounter(s), near mid-air collision(s), etc.). In some examples, the risk components are calculated, combined, and/or presented using example geo-referenced risk maps including one or more example risk contours (e.g., lines and/or areas of equal and/or similar collision risk). In some examples, one or more risk maps can be generated corresponding to respective different risk profiles (e.g., different altitude level(s)) and/or risk components (e.g., MAC rates, MAC likelihoods, etc.). Disclosed examples can be well-aligned with International Civil Aviation Organization (ICAO) practices regarding representation of positional uncertainties and/or calculation of collision risk and separation standards.

In some examples, the risk map(s) can provide tactical and/or strategic information for selecting a collision avoidance maneuver for an aircraft (e.g., a UAS). For example, disclosed examples can utilize the risk map(s) to determine a collision risk gradient (e.g., a direction of a maximum and/or minimum rate of change of collision risk), where the collision risk gradient may be used to facilitate selection and/or adjustment of flight trajectories to reduce collision risk. Additionally, examples disclosed herein can infer and/or predict intent of aircraft (e.g., expected trajectories of aircraft) based on the risk map(s). For example, when another aircraft is identified in an airspace, a location of the aircraft relative to high traffic and/or high risk areas can be analyzed based on the risk map(s) to predict the intent of the aircraft. In some such examples, the flight trajectory and/or flight direction of a UAS can be adjusted based on the predicted intent to reduce risk of collision with the aircraft. Some examples disclosed herein can be incorporated into flight planning tools such as Guidance, Navigation, and Control (GNC) system(s), Flight Management System (FMS), and/or Vehicle Management System (VNS) solutions for uncrewed aircraft. As a result, examples disclosed herein enable a UAS to fly within pre-programmed risk profiles in the event of a connection to human oversight (e.g., a remote pilot) being severed. While examples disclosed herein are described with respect to uncrewed aircraft (e.g., UAS), examples disclosed herein can additionally or alternatively be utilized for any type of aircraft and/or airspace users, including but not limited to, manned aircraft (e.g., commercial aircraft).

Advantageously, examples disclosed can consider collision risks when selecting and/or generating flight trajectories and/or avoidance maneuvers for the UAS. Further, by utilizing surveillance data to estimate the collision risk at respective different locations of an airspace, examples disclosed herein can produce more detailed and/or granular risk map(s) (e.g., compared to some known qualitative and/or quantitative-based risk estimation approaches), which can improve selection of flight trajectories having reduced collision risk (e.g., compared to other possible flight trajectories in the airspace). Additionally, by utilizing probability distributions to represent positions of aircraft in the airspace, examples disclosed herein can reflect uncertainty (e.g., associated with navigation and/or surveillance of the aircraft, data errors or uncertainty, localized traffic behavior variation(s), etc.), thereby improving accuracy of risk estimates determined based on the surveillance data.

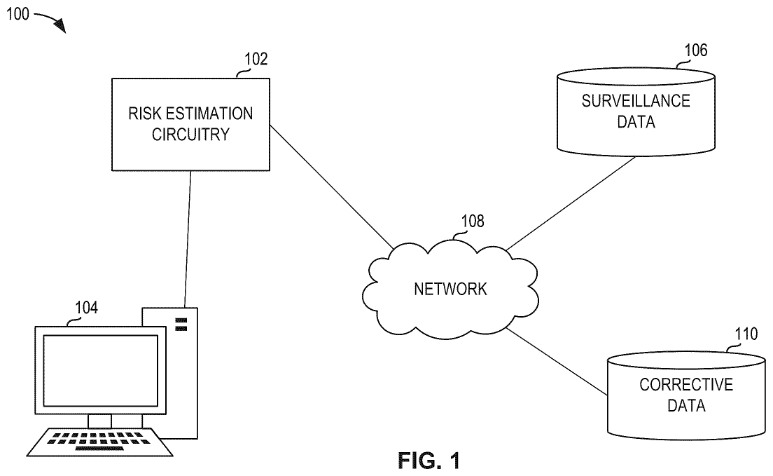

FIG. 1 illustrates an example environment 100 in which example risk estimation circuitry 102 can be implemented in accordance with teachings of this disclosure. In the illustrated example of FIG. 1, the risk estimation circuitry 102 is implemented on an example electronic device 104. In this example, the electronic device 104 is a computer, but can be implemented as any other type of electronic computing device, including a laptop, a server, an edge network device, etc.

In the illustrated example of FIG. 1, the risk estimation circuitry 102 can access, obtain, and/or receive example surveillance data (e.g., historical data) 106 and example corrective data 110 via an example network 108. In some examples, the corrective data 110 includes weather data, pressure variance data, etc. corresponding to one or more geographic regions. In some examples, the surveillance data 106 is preloaded in the risk estimation circuitry 102. In some examples, the surveillance data 106 includes Automatic Dependent Surveillance Broadcast (ADS-B) (or other Electronic Conspicuity) data, data collected from airports and/or air traffic controllers, etc. In some examples, the surveillance data is collected using ground equipment used for surveillance (e.g., radar sensor(s), primary and secondary radar(s), FLARM (Flight and Alarm), Traffic information service—broadcast (TIS-B)), etc. As used herein, surveillance data refers to data representative of one or more example flight trajectories (e.g., historical flight trajectories) of aircraft observed within a specified airspace (e.g., an airspace of interest). For example, the flight trajectories can correspond to the particular geographic region(s), particular altitude level(s), and/or particular time period(s) (e.g., time(s) of day, day(s), week(s), month(s), etc.).

In the illustrated example of FIG. 1, the risk estimation circuitry 102 estimates, based on the surveillance data 106 and/or the corrective data 110, example risk metric(s) associated with one or more locations (e.g., three-dimensional (3-D) location(s)) in a given airspace. For example, the risk metric(s) represent a collision risk (e.g., a mid-air collision risk) of aircraft, and can include a probability (e.g., a likelihood) and/or a rate (e.g., a frequency) of mid-air collisions (MAC) of aircraft expected at the corresponding location(s). In some examples, the example risk estimation circuitry 102 determines the risk metric(s) by determining one or more example risk metric components associated with events that are expected to lead to a collision. For example, the risk estimation circuitry 102 can estimate the risk metric component(s) based on overlap of probability distributions associated with positions of aircraft. By utilizing probability distributions to represent the positions of one or more aircraft, the example risk estimation circuitry 102 can account for uncertainty (e.g., error) related to navigation and/or data collection and, as a result, can comply with International Civil Aviation Organization (ICAO) practices regarding representation of positional uncertainties and/or calculation of collision risk and/or separation standards.

In the illustrated example of FIG. 1, MAC risk, as determined by the risk estimation circuitry 102, corresponds to (e.g., is proportional to) collision risk likelihoods and/or rates. As used herein, a “rate” refers to an expected number of events per unit of time, and a “probability” refers to a chance (e.g., a likelihood) of at least one event occurring. In some examples, the risk estimation circuitry 102 of FIG. 1 determines and/or estimates MAC risk (e.g., air risk) based on example relationships shown in example Equations 1A and/or 1B below.

$$AIR RISK ∝ P ( HARM \vert MAC ) \times P ( MAC ) \qquad ( Equation 1 A )$$

$$AIR RISK ∝ P ( HARM \vert MAC ) \times {λ}_{MAC} \qquad ( Equation 1 B )$$

In example Equations 1A and/or 1B above, AIR RISK represents the MAC risk, which can be based on a collision likelihood (e.g., a probability of occurrence of a collision) in Equation 1A and/or a collision rate (e.g., an expected number of collisions per hour and/or per flight hour) in Equation 1B. In example Equations 1A and/or 1B, P(MAC) represents the collision likelihood, and λ_{MAC} represents the collision rate. Additionally, P(HARM|MAC) represents a severity associated with a collision. It can be subjective and challenging to estimate the severity of UAS operations, and thus it is assumed that any collision is an undesirable event regardless of its severity.

In some examples, when the MAC risk (e.g., air risk) corresponds to a collision likelihood, the risk estimation circuitry 102 determines the MAC risk based on separable conditional probabilities of events that lead to a collision (e.g., an encounter, a near mid-air collision (NMAC), etc.). In some such examples, the risk estimation circuitry 102 determines the probability of a MAC based on example Equation 2 below.

$$P ( MAC \vert MOV ) = P ( MAC \vert NMAC ) P ( NMAC \vert ENC ) P ( ENC \vert MOV ) \qquad ( Equation 2 )$$

In example Equation 2 above, P(MAC|MOV) represents a probability of a MAC based on a movement within an airspace (e.g., a probability that a MAC will occur when a movement occurs within the airspace). Further, P(MAC|NMAC) represents a probability of a MAC given a NMAC, P(NMAC|ENC) represents a probability of a NMAC given an encounter, and P(ENC|MOV) represents a probability of an encounter given a movement. In some examples, in the event of a MAC, a movement is assumed to occur, followed by an encounter, a NMAC, and finally the MAC.

As used herein, a “movement” (e.g., MOV) refers to an event in which a portion (e.g., all) of a flight trajectory of an aircraft is observed within a specified region and/or airspace. As used herein, an “encounter” (e.g., ENC, an encounter event) refers to an event in which two aircraft are within a an example encounter volume of one another. In particular, an encounter event refers to an event in which the two aircraft are within a threshold horizontal encounter (e.g., well-clear) distance (e.g., 4000 feet (ft), 3500 ft, etc.) and a threshold vertical encounter (e.g., well-clear) distance (e.g., 750 ft, 700 ft, etc.) of one another. In some examples, a well-clear volume can be used in addition to or instead of the encounter volume, where the well-clear volume can have different dimensions compared to the encounter volume. As used herein, a “near mid-air collision” (e.g., NMAC) refers to an event in which two aircraft are within a threshold horizontal NMAC distance (e.g., 500 ft, 450 ft, etc.) and a threshold vertical NMAC distance (e.g., 100 ft, 80 ft, etc.) of one another. As used herein, a “mid-air collision” (e.g., MAC) refers to an event in which two aircraft contact one another. As used herein, “horizontal” refers to a direction parallel to a ground plane (e.g., a latitude-longitude plane), and “vertical” refers to a direction perpendicular (e.g., orthogonal) to the ground plane. In some examples, MAC risk, as determined by the risk estimation circuitry 102, can be calculated on an arbitrary plane in 3-D space (e.g., a collision plane) for which “horizonal” refers to a direction parallel to the plane and “vertical” refers a direction perpendicular to the plane.

In some examples, when the MAC risk (e.g., air risk) corresponds to a collision rate, the risk estimation circuitry 102 determines the MAC risk based on example Equation 3 below.

$${λ}_{MAC} = P ( MAC \vert NMAC ) P ( NMAC \vert ENC ) {λ}_{ENC} \qquad ( Equation 3 )$$

In example Equation 3 above, λ_{ENC} represents an encounter rate (e.g., a number of encounters expected per hour and/or per flight hour).

In example Equation 2 above, P(ENC|MOV) (e.g., the probability of an encounter given a movement) is a relative risk measure, which can vary based on a region being surveilled. For example, increasing a size of the region of interest may increase a number of flights (e.g., movements) observed in the region, thereby reducing the MAC risk determined for a given location. Conversely, decreasing the size of the region of interest may reduce the number of flights observed, thereby increasing the MAC risk for the given location. Similarly, in example Equation 3 above, λ_{ENC} (e.g., the encounter rate) can vary based on the size of the region of interest when λ_{ENC} is measured with respect to total flight hours in the region. In some examples, the region of interest can be selected and/or adjusted via user input provided to the electronic device 104 of FIG. 1.

In some examples, to estimate and/or determine risk metric(s) (e.g., the MAC risk) at one or more locations in the region of interest, the risk estimation circuitry 102 estimates the risk metric component(s) (e.g., P(MAC|NMAC), P(NMAC|ENC), P(ENC|MOV), λ_{ENC}, etc.) of example Equations 2 and/or 3 above for the corresponding one or more locations. In some examples, first one(s) of the risk metric components (e.g., P(MAC|NMAC)) may be constant and/or unchanging across the one or more locations, while second one(s) of the risk metric components (e.g., P(NMAC|ENC), P(ENC|MOV), λ_{ENC}) may vary between the locations based on localized air traffic behavior.

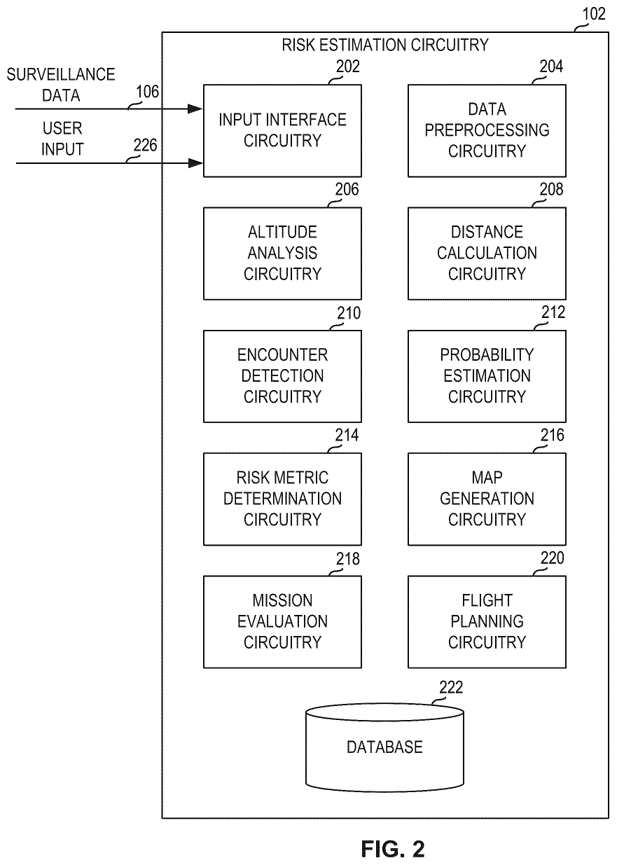

In some examples, the risk estimation circuitry 102 executes an example risk estimation process (e.g., a risk estimation algorithm) to determine and/or estimate one(s) of the risk metrics. Example pseudocode representative of the risk estimation process is shown below and is described further below in connection with FIG. 2.

| | Input | | : | surveillanceData (flight trajectories) | |
|---|---|---|---|---|---|
| | | | | flightLevels (defines required flight levels) | |
| | | | | airspace area (airspace of interest) | |
| | Output: | | | nmacEncProb (risk metric for each k location, per level) | |
| | | | | encCount (count of encounters for each k location, per level) | |
| | | | | encFh (hours flown within encounter volume of each k location, per level) | |
| | /* Code start | | | | */ |
| 1 | grid ← Create a grid of latitude-longitude coordinate pairs k for all airspace area | | | | |
| 2 | flightsLogicalMask, samplesLogicalMask ← altitudeSlicing(surveillanceData, | | | | |
| | flightLevels); /* Slice surveillanceData with samples within vertical encounter | | | | |
| | distance from current Flight Level (see Algorithm 2) */ | | | | |
| 3 | for each level in flightLevels do | | | | |
| 4 | \| | flightsAtLevel ← Use flightsLogicalMask and samplesLogicalMask to retrieve flight | | | |
| | \| | trajectories from surveillanceData that are within the vertical encounter dimension of | | | |
| | \| | level | | | |
| 5 | \| | for each flight in flightsAtLevel do | | | |
| 6 | \| | \| | boundingBox ← Create a bounding box around the flight trajectory | | |
| 7 | \| | \| | gridPts ← Retrieve grid locations that are within the boundingBox | | |
| 8 | \| | \| | encCount ← Increase ENC count for gridPts | | |
| 9 | \| | \| | for each gridPt in gridPts do | | |
| 10 | \| | \| | \| | fhInEnc, #ENC ← encCheck(grid, flight) ; | /* Time in ENC and ENC count |
| | \| | \| | \| | (see Algorithm 4) */ | |
| 11 | \| | \| | end for | | |
| 12 | \| | \| | CPAs ← CPA(flight, gridPts); | | /* Calculate 3D CPA from each grid location |
| | \| | \| | (see Algorithm 3) */ | | |
| 13 | \| | \| | horzDist ← Horizontal distances from CPAs to gridPts | | |
| 14 | \| | \| | vertDist ← Vertical distances from CPAs to gridPts | | |
| 15 | \| | \| | if horzDist smaller than ENC horizontal dimension then | | |
| | \| | \| | \| | /* Vectorised operations | */ |
| 16 | \| | \| | \| | horzOverlapP ← NDEs overlap probability (Equation (8) using NMAC horizontal | |
| | \| | \| | \| | dimension and horzDist); | /* Risk associated with horizontal proximity */ |
| 17 | \| | \| | \| | vertOverlapP ← Laplacians overlap probability (Equation (16) using NMAC vertical | |
| | \| | \| | \| | dimension and vertDist); | /* Risk associated with vertical proximity */ |
| 18 | \| | \| | \| | totalOverlapP ← horzRisk × vertRisk / #ENC; | /* [symbol] (NMAC\|ENC) map from |

| | | | |
|---|---|---|---|
| \| | \| | \| | flight i */ |

| | | | |
|---|---|---|---|
| 19 | \| | \| | end if |

| | | |
|---|---|---|
| 20 | \| | end for |
| 21 | \| | nmacEncProb ← Sum totalRisk maps from individual flights |
| 22 | \| | encFh ← Sum fhInEnc maps from individual flights |
| 23 | \| | RiskMap ← See Algorithm 5 |

| | |
|---|---|
| 24 | end for |

[symbol]

indicates data missing or illegible when filed

In some examples, as a result of determining the risk metric(s) for multiple locations in the region of interest, the risk estimation circuitry 102 generates one or more example risk maps (e.g., air risk maps) based on the risk metric(s). In some examples, the risk map(s) are representative of the risk metric(s) (e.g., the MAC probability and/or rate) determined for respective locations (e.g., geographic locations) in the region of interest. In some examples, the risk estimation circuitry 102 can cause the electronic device 104 to display and/or present the risk map(s) to an operator for use in evaluating, planning, and/or adjusting flight trajectories of aircraft. In some examples, the risk map(s) can be stored, displayed, and/or transmitted (e.g., via the network 108 of FIG. 1) to one or more other devices for presentation thereon. While some example risk maps disclosed herein are 2-D risk maps corresponding to respective altitude levels (e.g., constant altitude, altitude slices), one(s) of the risk maps can be represented using a 3-D volume, and/or can be represented by an arbitrarily oriented plane cutting the 3-D volume. In some examples, the risk map(s) can be presented and/or displayed using one or more example 2-D and/or 3-D visualization devices. In some examples, the risk estimation circuitry 102 can infer, based on the risk map(s), intent (e.g., an expected flight direction) of one or more aircraft. In some such examples, the risk estimation circuitry 102 can generate and/or adjust, based on the inferred intent, a flight plan for a second aircraft to avoid and/or reduce risk of collision.

FIG. 2 is a block diagram of an example implementation of the example risk estimation circuitry 102 of FIG. 1. The risk estimation circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the risk estimation circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the example risk estimation circuitry 102 of FIG. 2 includes example input interface circuitry 202, example data preprocessing circuitry 204, example altitude analysis circuitry 206, example distance calculation circuitry 208, example encounter detection circuitry 210, example probability estimation circuitry 212, example risk metric determination circuitry 214, example map generation circuitry 216, example mission evaluation circuitry 218, example flight planning circuitry 220, and an example database 222.

The example database 222 of FIG. 2 stores data obtained, utilized, and/or determined by the risk estimation circuitry 102. The example database 222 of FIG. 2 is implemented by any memory, storage device and/or storage disc for storing data such as, for example, flash memory, magnetic media, optical media, solid state memory, hard drive(s), thumb drive(s), etc. Furthermore, the data stored in the database 222 may be in any data format such as, for example, binary data, comma delimited data, tab delimited data, structured query language (SQL) structures, no-SQL structures, etc. While, in the illustrated example, the database 222 is illustrated as a single device, the example database 222 and/or any other data storage devices described herein may be implemented by any number and/or types of memories and/or software.

The example input interface circuitry 202 of FIG. 2 accesses, obtains, and/or receives example input data utilized by the risk estimation circuitry 102 to estimate one or more example risk metric(s) associated with an airspace. In the illustrated example of FIG. 2, the input data includes a portion (e.g., all) of the example surveillance data 106 and the corrective data 110 of FIG. 1. In some examples, the surveillance data 106 represents one or more example flight trajectories observed for a given airspace during a given time period (e.g., during a given time of day, a given day, a given week, etc.). In some examples, the flight trajectories are represented by example data samples representative of three-dimensional (3-D) locations defining the respective flight trajectories. For example, the data samples include horizontal positions (e.g., latitude-longitude coordinates) and vertical positions (e.g., altitude levels) corresponding to respective points of the respective flight trajectories.

In some examples, the input interface circuitry 202 obtains example user input 226 provided via the example electronic device 104 of FIG. 1. In some examples, the user input 226 can include example user-selected value(s) for one or more risk metric component(s) (e.g., the risk metric component(s) in the example Equations 2 and/or 3 above). For example, the user input 226 can specify a value for P(MAC|NMAC) (e.g., the probability of a MAC given a NMAC), where the value corresponds to 0.01 (e.g., IMAC for every 100 NMACs) in this example. In some examples, P(MAC|NMAC) may be different (e.g., greater than or less that 0.01). In some examples, the value for P(MAC|NMAC) can be determined based on simulation(s) of a large number (e.g., millions) of encounters, in which encounter dynamics are extrapolated from the surveillance data 106 and physical extent of an aircraft (e.g., an uncrewed aircraft system (UAS)) is based on multiple (e.g., over 60) 3-D aircraft wire-frame models. In some examples, value(s) for one(s) of the risk component metrics can be preloaded in the risk estimation circuitry 102 and/or accessed from the example database 222. In some examples, the value for P(MAC|NMAC) can be calculated based on traffic type (i.e., extent) information from the example database 222 and overlap probability calculations.

In some examples, the input interface circuitry 202 determines, based on the user input 226, one or more example model parameters to be utilized by the risk estimation circuitry 102. For example, the model parameter(s) can include a selected region of interest (e.g., an airspace) represented in the surveillance data 106, a selected time frame (e.g., a time of day, day(s), week(s), month(s), etc.), and/or a selected altitude level (or range(s) of altitude levels) for which risk metric(s) are to be estimated.

Further, in some examples, the input interface circuitry 202 identifies and/or generates, based on the user input 226, example grid locations within the selected region of interest. For example, the grid locations represent possible locations of an aircraft (e.g., an uncrewed aircraft system (UAS)) in the region of interest at which the risk metric(s) are to be determined. In some examples, the input interface circuitry 202 identifies and/or defines the grid locations based on an example spacing parameter (e.g., selected via the user input 226 and/or preloaded in the risk estimation circuitry 102). For example, the grid locations correspond to 3-D points arranged in a grid-like pattern within the region of interest, where adjacent ones of the points are spaced apart from one another (e.g., in the vertical direction and/or in the horizontal direction) by the spacing parameter. In this example, the spacing parameter corresponds to 0.1 nautical miles (NM). In some examples, the spacing parameter may be different (e.g., less than or greater than 0.1 NM). In some examples, the spacing parameter can be the same (e.g., constant) across the region of interest, and/or may vary (e.g., in the vertical direction and/or in the horizontal direction) across the region of interest. For example, while the 3-D points are arranged in a grid-like pattern in this example, a different arrangement of the 3-D points may be used instead (e.g., the spacing between adjacent one(s) of the 3-D points can vary and/or may be irregular in the vertical direction and/or the horizontal direction).

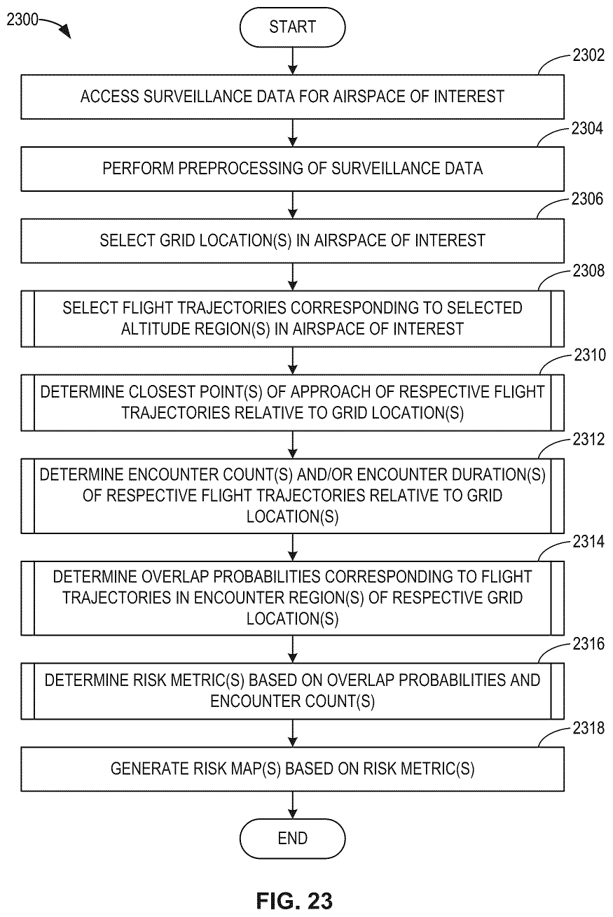

In some examples, the spacing parameter is selected to ensure sufficient overlapping encounter regions between adjacent ones of the grid locations and, thus, to enable interpolation of risk levels for intermediate locations in the region of interest. In some examples, to improve reliability of the risk estimation, the input interface circuitry 202 selects and/or adjusts the spacing parameter for outermost one(s) of the grid locations (e.g., one(s) of the grid locations at or near a boundary of the region of interest), such that the spacing parameter is at least a size of an example encounter region of a corresponding grid location (e.g., greater than or equal to the threshold encounter horizontal distance in the horizontal direction and/or greater than or equal to the threshold encounter vertical distance in the vertical direction). In some examples, the input interface circuitry 202 provides the grid locations and the input data from the surveillance data 106, the corrective data 110, and/or the user input 226 to the example database 222 for storage. In some examples, the input interface circuitry 202 is instantiated by programmable circuitry executing input interface circuitry instructions and/or configured to perform operations such as those represented by the flowchart of FIG. 23.

The example data preprocessing circuitry 204 processes example input data accessed and/or obtained by the input interface circuitry 202. For example, the data preprocessing circuitry 204 preprocesses the surveillance data 106 to improve quality of the data and/or to reduce bias in the risk metric(s) estimated based on the surveillance data 106. In some examples, the data preprocessing circuitry 204 performs at least one of a track creation process, a cleaning and splitting process, a track smoothing process, or a track correction process based on the surveillance data 106 and/or the corrective data 110.

In some examples, the surveillance data 106 is obtained by the input interface circuitry 202 as raw air traffic surveillance data (e.g., ADS-B, track data, etc.) including a series of unordered position reports corresponding to one or more aircraft. For example, the reports can include position information and/or metadata (e.g., identifiers, flight plan information, etc.) corresponding to respective tracks (e.g., flight trajectories). In some examples, an aircraft represented in the reports may use multiple different callsigns, and a callsign may be re-used in a dataset and/or across time periods. In such examples, the data preprocessing circuitry 204 performs the track creation process to assign labels (e.g., identifiers) to respective ones of the tracks (e.g., the flight trajectories). Further, the data preprocessing circuitry 204 can perform the cleaning process to remove, from the surveillance data 106, duplicate track points, tracks having less than a threshold number (e.g., two, three, etc.) of points, tracks having no altitude values, and/or tracks having inverted altitude profiles (e.g., negative profiles). In some examples, the data preprocessing circuitry 204 performs the splitting process to split (e.g., separate) one(s) of the tracks. For example, the data preprocessing circuitry 204 splits (e.g., creates multiple tracks) from one(s) of the tracks that cross and/or that leave and return the region of interest.

In some examples, the data preprocessing circuitry 204 performs the track smoothing process to filter and/or resample one(s) of the track positions and, as a result, provide a smoother, more realistic track shape. In some examples, the data preprocessing circuitry 204 performs the track smoothing process for sparsely sampled (e.g., low frequency) data (e.g., data having a sampling frequency less than 1 second). However, in some examples, such smoothing may be ineffective and, thus, may be omitted for data with higher sampling rates (e.g., 1 second to 5 seconds). In particular, the risk estimation model(s) utilized by the risk estimation circuitry 102 account for track error such that, for high-frequency samples, track shifts may be less than the uncertainty applied in the risk estimation model(s). In some examples, the data preprocessing circuitry 204 can apply one or more simple filters (e.g., a moving median filter, a Savitsky-Golay filter, etc.) to the high-frequency samples.

In some examples, track altitudes can include outlier values corresponding to intermittent null, undefined, and/or inconsistent values (e.g., relatively large negative values). In some examples, the data preprocessing circuitry 204 detects such outlier values by applying simple filter(s) (e.g., moving median filter(s)) to the track data. Once the outlier value(s) are detected, the data preprocessing circuitry 204 can remove the outlier value(s) from the track data to reduce potential bias in the track data. Additionally or alternatively, the data preprocessing circuitry 204 can replace and/or adjust one(s) of the outlier values based on nearest neighbor track values and/or linear interpolation between ones of the track values.

In some examples, the data preprocessing circuitry 204 performs a track correction process to correct track altitudes for local pressure variation to improve data quality and/or reduce data variance. In some examples, track altitudes for corresponding ones of the track values are recorded at a particular resolution (e.g., to the nearest 100 ft). In some examples, for altitudes recorded below an altitude threshold (e.g., flight level 10 (FL10)) using barometric altimeter(s), the data preprocessing circuitry 204 determines a corresponding pressure-corrected altitude (e.g., h) based on example Equation 3B below.

$$h = \hat{h} + K ( QNH - 1013.15 ) , K = 26.7 \qquad ( Equation 3 B )$$

In some examples, the data used to perform the track correction process is obtained from the corrective data 110 of FIG. 1.

In example Equation 3B above, ĥ represents a recorded altitude (e.g., from the surveillance data 106 and/or the corrective data 110) and QNH represents local pressure data recorded from a nearby reliable weather station. In some examples, when fused and/or merged track data (e.g., ADS-B and radar, etc.) is used, the data preprocessing circuitry 204 can apply one or more additional filters to the track data.

In some examples, for high altitude operations (e.g., operations above an altitude threshold, operations above FL10, etc.), barometric altimeters use standard atmospheric reference (e.g., QNH=1013). As a result, altitude correction may not be necessitated for high altitude values in some examples. In some examples, subsequent to processing and/or correction of the surveillance data 106 (e.g., based on the corrective data 110), the processed and/or corrected surveillance data can be included in and/or can replace the surveillance data 106. In some examples, the data preprocessing circuitry 204 provides the preprocessed and/or corrected surveillance data 106 to the database 222 for storage. In some examples, the data preprocessing circuitry 204 is instantiated by programmable circuitry executing data preprocessing circuitry instructions and/or configured to perform operations such as those represented by the flowchart of FIG. 23.

The example altitude analysis circuitry 206 of FIG. 2 analyzes (e.g., slices, divides, filters) the surveillance data 106 (e.g., the preprocessed surveillance data 106) based on altitude levels (and/or range(s) of altitude levels) of interest. In some examples, the altitude analysis circuitry 206 identifies the altitude level(s) of interest based on the user input 226. In some examples, the altitude analysis circuitry 206 selects, from the surveillance data 106, one(s) of the flight trajectories that are within a vertical encounter region (e.g., an encounter volume) of the altitude level(s). In some such examples, by disregarding remaining one(s) of the flight trajectories that are not within the vertical encounter region, the altitude analysis circuitry 206 can reduce a number of subsequent calculations to be performed by the risk estimation circuitry 102 and, thus, can reduce processing time and/or reduce utilization of computational resources by the risk estimation circuitry 102. In particular, because the risk metric component P(NMAC|ENC) assumes an encounter has occurred, flight trajectories that are outside of the vertical encounter region can be disregarded since such flight trajectories do not contribute to collision risk at the altitude level(s) of interest. For example, for an altitude of interest of 500 ft and an encounter region of ±750 ft, an aircraft at 1500 ft (with position uncertainty) has no impact on collision risk and, thus, can be disregarded.

Returning to FIG. 2, to perform an altitude slicing process on the surveillance data 106, the altitude analysis circuitry 206 evaluates the altitude levels corresponding to respective samples of the flight trajectories represented in the surveillance data 106. For example, for a given altitude level of interest, the altitude analysis circuitry 206 determines whether one or more samples of a given flight trajectory are within the threshold encounter vertical distance (e.g., ±750 ft) (with position uncertainty) with respect to the altitude level of interest. In some examples, when at least one of the samples satisfies (e.g., is within) the threshold encounter vertical distance (with position uncertainty), the altitude analysis circuitry 206 adds and/or stores the flight trajectory (and/or an indicator associated with the flight trajectory) in a first example logical mask (e.g., flightMaskLevel). Additionally or alternatively, the altitude analysis circuitry 206 can add and/or store the sample(s) (e.g., the one(s) of the samples that satisfy the threshold encounter vertical distance) in a second example logical mask (e.g., sampleMaskLevel). In some examples, the altitude analysis circuitry 206 repeats the above process for a portion (e.g., all) of the flight trajectories represented in the surveillance data 106 to identify the one(s) of the flight trajectories and/or the corresponding sample(s) within the encounter region of the altitude of interest. Example pseudocode representative of the example altitude slicing process performed by the altitude analysis circuitry 206 is shown below.

| | | |
|---|---|---|
| Input | : | surveillanceData (flight trajectories) |

| | flightLevels (required flight levels) |
|---|---|
| Output: | flightsLogicalMask (logical masks of which flights exist in each flight level) |

samplesLogicalMask (logical masks of which samples of each flight are in each flight

| | level) | | | |
|---|---|---|---|---|
| | /* Code start | | | */ |
| 1 | for each level in flightLevels do | | | |
| 2 | \| | for each flight in surveillanceData do | | |
| | \| | \| | /* Vectorised operation, on all samples of flight | */ |

| | | | |
|---|---|---|---|
| 3 | \| | \| | sampleMask ← True if the altitude of the sample is within the encounter horizontal |
| | \| | \| | distance of level |
| 4 | \| | \| | flightMask ← True if any entry of sampleMask is true |

| | | |
|---|---|---|
| 5 | \| | end for |
| 6 | \| | flightMaskLevel ← Collect all flightMask at level |
| 7 | \| | sampleMask ← Collect all sampleMask at level |

| | |
|---|---|
| 8 | end for |
| 9 | flightsLogicalMask ← Collect all flightMaskLevel |
| 10 | samplesLogicalMask ← Collect all sampleMaskLevel |

In some examples, the altitude analysis circuitry 206 is instantiated by programmable circuitry executing altitude analysis instructions and/or configured to perform operations such as those represented by the flowchart(s) of FIGS. 23 and/or 24.

The example distance calculation circuitry 208 of FIG. 2 selects, for respective ones of the grid locations, one or more samples (e.g., points, edges) of the respective flight trajectories identified by the altitude analysis circuitry 206. For example, for a given grid location for which risk metric(s) are to be determined, the distance calculation circuitry 208 calculates distances (e.g., 3-D distances) between the grid location and a portion (e.g., all) of the samples corresponding to a given flight trajectory within the encounter region of the grid location. In such examples, the distance calculation circuitry 208 selects, for respective ones of the flight trajectories within the encounter region, one of the samples corresponding to a least (e.g., a smallest) distance as a closest point of approach (CPA) of the respective flight trajectory relative to the grid location. Stated differently, the CPA corresponds to a sample of the flight trajectory at which the flight trajectory is closest to the grid location (e.g., relative to other samples of the flight trajectory). In some examples, the distance calculation circuitry 208 adds and/or stores the CPA in a third logical mask (e.g., CPAs) corresponding to the grid location. Further, the distance calculation circuitry 208 selects and/or determines the CPAs corresponding to remaining one(s) of the flight trajectories with respect to the grid location, and stores the selected CPAs in the third logical mask. Similarly, the distance calculation circuitry 208 determines, for remaining one(s) of the grid locations, the corresponding CPAs of the respective flight trajectories. In some examples, the distance calculation circuitry 208 stores the identified CPAs (e.g., in one or more third logical masks) in the example database 222. Example pseudocode shown below is representative of an example process performed by the distance calculation circuitry 208 of FIG. 2 to identify the CPAs of an ith flight trajectory relative to respective grid locations (e.g., k).

| Input : grid (Grid of k airspace locations) | |
|---|---|
| flightTrajectory ( [symbol] Flight trajectory) | |
| Output: CPAs (CPA list of ith flight to all k locations) | |
| /* Code start | */ |

| | |
|---|---|
| 1 | for each Pt [symbol] grid do |
| 2 | \| dists ← Compute distance between Pt and all edges of flightTrajectory |
| 3 | \| CPA ← Find Pt corresponding to the minimum distance in dists |
| 4 | end for |
| 5 | CPAs ← [symbol] all CPA |

[symbol]

indicates data missing or illegible when filed

In some examples, the distance calculation circuitry 208 is instantiated by programmable circuitry executing distance calculation circuitry instructions and/or configured to perform operations such as those represented by the flowchart(s) of FIGS. 23 and/or 25.

The example encounter detection circuitry 210 of FIG. 2 determines and/or estimates count(s) and/or duration(s) associated with one or more encounters between the grid locations and one(s) of the flight trajectories (e.g., the one(s) of the flight trajectories and/or the corresponding samples identified by the altitude analysis circuitry 206 as being within the vertical encounter region(s) of the corresponding grid location(s)). For example, for a corresponding grid location and flight trajectory, the encounter detection circuitry 210 detects an encounter (e.g., between the grid location and the flight trajectory) when the flight trajectory crosses or is likely to cross (e.g., intersect with) an example encounter boundary defining an encounter region of the grid location. In some examples, the encounter boundary corresponds to a circle centered at the grid location and having a radius corresponding to the threshold encounter horizontal distance (e.g., 4000 ft, 3000 ft, etc.) or the threshold encounter horizontal distance with buffer (e.g. 4100 ft, 4200 ft, etc.). In some examples, a shape and/or size of the encounter boundary and/or the corresponding encounter region may be different. In some examples, the encounter count for a corresponding grid location and flight trajectory corresponds to a number of times that an aircraft travelling along the flight trajectory enters the encounter region of the grid location. Further, the encounter duration for a corresponding grid location and flight trajectory corresponds to a duration (e.g., a length of time) for which the aircraft travelling along the flight trajectory is within the encounter region of the grid location.

In some situations (e.g., in helicopter and/or aircraft training), a particular flight trajectory may enter an encounter volume multiple times. In such examples, the encounter detection circuitry 210 counts each instance of the flight trajectory entering the encounter volume as a separate encounter. In this example, to determine the encounter count and/or encounter duration for a corresponding grid location and flight trajectory, the encounter detection circuitry 210 detects one or more example intersection points at which the flight trajectory crosses (e.g., intersects with) the encounter boundary of the grid location. In such examples, the encounter detection circuitry 210 determines whether one(s) of the intersection points corresponds to the flight trajectory entering or leaving the encounter region of the grid location. In some examples, the encounter detection circuitry 210 determines the encounter count based on the number of times the flight trajectory enters the encounter region. Further, in some examples, the encounter detection circuitry 210 calculates a total distance (e.g., a total 3-D distance) travelled by the aircraft within the encounter region based on distance(s) between first one(s) of the intersection point(s) (e.g., at which the aircraft enters the encounter region) and second one(s) of the intersection point(s) (e.g., at which the aircraft exits the encounter region). Additionally or alternatively, when the flight trajectory terminates within the encounter region, the total distance includes a distance between one of the first intersection points and a termination point of the flight trajectory within the encounter region. In some examples, when multiple encounters are determined, multiple CPAs can be found relative to the same grid location.

In some examples, the encounter detection circuitry 210 determines and/or calculates the encounter duration for the corresponding grid location and flight trajectory based on the total distance travelled by the aircraft within the encounter region and based on flight speed (e.g., an average flight speed, a variable flight speed) of the aircraft. For example, the encounter detection circuitry 210 can determine the encounter duration by dividing the total distance by the flight speed (e.g., the average flight speed). In some examples, when the flight speed of the aircraft varies between different legs (e.g., portions) of the flight trajectory, the encounter detection circuitry 210 can determine the encounter duration by dividing individual distances along the respective legs of the flight trajectory by the corresponding respective flight speeds, and subsequently aggregating the durations associated with the individual legs to determine the encounter duration. In some examples, when each of the samples corresponding to the flight trajectory is within the encounter region of the grid location (e.g., the flight trajectory begins and terminates within the encounter region and does not exit the encounter region), the encounter detection circuitry 210 determines that the encounter duration corresponds to a total flight time (e.g., in flight hours) associated with the flight trajectory. Example pseudocode representative of an example process to determine the encounter count and/or encounter duration (e.g., in flight hours) for a corresponding grid location and flight trajectory is shown below.

| | | |
|---|---|---|
| Input | : | gridPt ( [symbol] location) |

| | flight (ith Flight trajectory) |
|---|---|
| Output: | flightHour (flight hours in Encounter region) |

#ENC (number of encounters)

| | |
|---|---|
| /* Code start | */ |

| 1 | encCircle ← create an ENC circle centred [symbol] gridPt | | | |
|---|---|---|---|---|
| 2 | intersectPts ← find intersection points between encCircle and flight trajectory | | | |
| 3 | #ENC ← from intersectPts, count number of ENCs | | | |
| 4 | if flight intersects ENC region then | | | |
| 5 | \| | temp ← first trajectory sample | | |
| 6 | \| | for each intersect in intersectPts do | | |
| 7 | \| | \| | if flight is entering ENC area then | |
| 8 | \| | \| | \| | temp ← intersect |
| 9 | \| | \| | else if flight leaving ENC area then | |
| 10 | \| | \| | \| | dist ← dist + distance between temp and intersect |
| 11 | \| | \| | else if flight [symbol] inside ENC then | |
| 12 | \| | \| | \| | dist ← dist + distance between last trajectory sample and intersect |

| 13 | \| | end for |
|---|---|---|
| 14 | \| | flightHour ← dist/speed |
| 15 | else if flight is inside ENC area for all time then | |
| 16 | \| | encTime ← get trajectory total flight hour |

| | |
|---|---|
| 17 | end if |

[symbol]

indicates data missing or illegible when filed

In some examples, the encounter detection circuitry 210 repeats the encounter detection process described above for a portion (e.g., all) of respective pairs of grid locations and flight trajectories. As a result, the encounter detection circuitry 210 determines the encounter count(s) and/or the encounter duration(s) associated with respective one(s) of the flight trajectories with respect to one(s) of the grid locations. In some examples, the encounter detection circuitry 210 stores, in association with the corresponding grid location(s), the encounter count(s) and/or the encounter duration(s) in the example database 222.

In some examples, the encounter detection circuitry 210 determines, based on the corresponding encounter count(s) and/or encounter duration(s), one or more example risk metric components for respective one(s) of the grid locations. For example, for a corresponding grid location k ∈ S (e.g., where S represents a set of all coordinates in the region of interest), the encounter detection circuitry 210 determines a probability of an encounter given a movement (e.g., P(ENC|MOV)ₖ), an encounter rate per hour (e.g., λ_{ENC}_{_{H}}_{,k}), and/or an encounter rate per flight hour (e.g., λ_{ENC}_{_{FH}}_{,k}). For example, based on the encounter count determined for the grid location k (e.g., #ENCₖ), the encounter detection circuitry 210 executes example Equations 4A, 4B, and/or 4C below to determine the encounter probability, the encounter rate per hour, and/or the encounter rate per flight hour, respectively.

$${P ( ENC \vert MOV )}_{k} = \frac{\# {ENC}_{k}}{N} \qquad ( Equation 4 A )$$

$${λ}_{{ENC}_{H} , k} = \frac{\# {ENC}_{k}}{{T}_{h}} \qquad ( Equation 4 B )$$

$${λ}_{{ENC}_{FH} , k} = \frac{\# {ENC}_{k}}{{T}_{fh}} \qquad ( Equation 4 C )$$

In example Equations 4A, 4B, and/or 4C above, #ENCₖ represents the encounter count determined for grid location k, N represents a total number of flight trajectories observed in the surveillance data 106, Tₕ represents a total duration and/or time frame (e.g., in hours) represented in the surveillance data 106, and T_{fh} represents a total flight duration (e.g., total flight hours) represented in the surveillance data 106. In some examples, the encounter probability (e.g., P(ENC|MOV)ₖ) may exceed a value of one in situations in which a relatively small number of movements result in a relatively large number of encounters (e.g., when using circuit data for locations within an aerodrome). In some such examples, for encounter probabilities greater than one, the encounter detection circuitry 210 adjusts the encounter probability to be saturated at a value of one.

In this example, the encounter probability (e.g., P(ENC|MOV)ₖ) and the encounter rate per flight hour (e.g., λ_{ENC}_{_{FH}}_{,k}) are dependent on a region considered in the surveillance data 106. For example, expanding the region of interest increases N (e.g., the number of aircraft represented in the surveillance data 106) and T_{fh} (e.g., the total flight hours represented in the surveillance data 106), resulting in a reduction in the encounter probability and/or the encounter rate per flight hour. Alternatively, expanding the region of interest to include a major aerodrome with a relatively large number (e.g., thousands) of flights may reduce the resulting encounter rate at a location that is distant from the aerodrome. As such, the encounter rate per hour (e.g., λ_{ENC}_{_{H}}_{,k}) may be a more accurate representation of the encounter rate at grid location k, since the encounter rate per hour is independent of a size of the selected region of interest. However, in some examples, the encounter rate per hour may be prone to averaging effects resulting from variation in aircraft densities during a given time frame (e.g., peak time versus off-peak time). In some examples, the surveillance data 106 can be partitioned by time frame (e.g., daytime versus nighttime, by hour, etc.) to capture the effects of temporal variations on the resulting risk metric estimation(s). In some examples, the surveillance data 106 can be partitioned by other values of meta data available within the surveillance data 106 (e.g., cooperative versus non-cooperative traffic, by aircraft type, etc.) to capture the effects or contributions of various entities on the resulting risk metric estimation(s).

In some examples, the encounter detection circuitry 210 stores, in association with the corresponding grid locations, the risk metric component(s) (e.g., the encounter probability, the encounter rate per hour, and/or the encounter rate per flight hour) in the example database 222. In some examples, the encounter detection circuitry 210 is instantiated by programmable circuitry executing encounter detection circuitry instructions and/or configured to perform operations such as those represented by the flowchart(s) of FIGS. 23 and/or 26.

The example probability estimation circuitry 212 of FIG. 2 determines and/or estimates example NMAC probabilities for corresponding one(s) of the grid locations. In particular, the NMAC probability for a given grid location k (e.g., P(NMAC|ENC)ₖ) represents a probability (e.g., a likelihood) of a NMAC occurring when an encounter (and/or a well-clear violation) has occurred (e.g., a probability that an encounter leads to a NMAC). In some examples, the NMAC probability corresponding to a grid location k corresponds to (e.g., is proportional to) a probability of overlap between a first aircraft (e.g., a UAS) at the grid location k and a portion (e.g., all) of the flight trajectories represented in the surveillance data 106 that are (at least partially) within an encounter region of the grid location k. In some examples, the probability estimation circuitry 212 determines the NMAC probability for the grid location k based on example Equation 5 below.

$${P ( NMAC \vert ENC )}_{k} = \frac{1}{{N}_{k}} {\sum }_{i = 1}^{{N}_{k}} {{P}_{i} ( NMAC \vert ENC )}_{k}$$

In the example Equation 5 above, i=[1, . . . , Nₖ] represents the flight trajectory i, and Nₖ represents a total number of the flight trajectories observed in the encounter region of the grid location k. Further, in the example Equation 4 above, Pᵢ(NMAC|ENC)ₖ represents an individual risk contribution (e.g., an individual NMAC probability) from an encounter corresponding to flight trajectory i. As such, the NMAC probability for the grid location k (e.g., P(NMAC|ENC)ₖ) corresponds to a weighted sum of the individual risk contributions (Pᵢ(NMAC|ENC)ₖ) associated with respective ones of the flight trajectories i.

In some examples, the probability estimation circuitry 212 utilizes two assumptions to determine the NMAC probability for a grid location k. For example, the probability estimation circuitry 212 utilizes a first assumption that an encounter has occurred (e.g., by discarding and/or disregarding samples represented in the surveillance data 106 that are not within the encounter region of the grid location k). Additionally, the probability estimation circuitry 212 utilizes a second assumption that no more than a single encounter occurs instantaneously. Instead, multiple encounters occurring simultaneously can be indirectly captured by the encounter rate (e.g., λ_{ENC}) as opposed to the NMAC probability.

In some examples, navigation error of aircraft and/or measurement error in the surveillance data 106 may produce uncertainty (e.g., position uncertainty) in the position(s) of the grid locations and/or the flight trajectories represented in the surveillance data 106. For example, based on the type of surveillance equipment used to capture the surveillance data 106, a recorded flight trajectory of an aircraft represented in the surveillance data 106 may vary from an actual flight trajectory of the aircraft. In some examples, to account for such uncertainty in the surveillance data, the probability estimation circuitry 212 represents the positions of the respective grid locations and/or the positions of the respective points (e.g., CPAs) of the flight trajectories using one or more example probability distributions. For example, for a corresponding one of the grid locations or the CPAs, the probability estimation circuitry 212 determines an example vertical position distribution (e.g., ƒᵥₑᵣₜ) and an example horizontal position distribution (e.g., ƒ_{horz}) representative of the vertical and horizontal positions, respectively, of the corresponding grid location or CPA. Stated differently, the vertical position distribution represents the vertical position of a corresponding point (e.g., one of the grid locations and/or one of the CPAs) and associated uncertainty in the vertical direction, and the horizontal position distribution represents the horizontal position of the corresponding point and the associated uncertainty in the horizontal direction.

In some examples, the probability estimation circuitry 212 determines and/or estimates, for a given grid location (e.g., k) and a given flight trajectory (e.g., i), the individual risk contribution (e.g., Pᵢ(NMAC|ENC)ₖ) based on a positional overlap probability between the grid location and a CPA of the flight trajectory i. For example, the positional overlap probability is based on a vertical overlap probability and a horizontal overlap probability between the grid location and the CPA. In some examples, the vertical overlap probability is based on an overlap between a first vertical position distribution corresponding to the CPA and a second vertical position distribution corresponding to the grid location. Similarly, the horizontal overlap probability corresponds to an overlap between a first horizontal position distribution corresponding to the CPA and a second horizontal position distribution corresponding to the grid location. In some examples, the probability estimation circuitry 212 determines the individual risk contribution (e.g., Pᵢ(NMAC|ENC)ₖ) based on example Equation 6 below.

$${{P}_{i} ( NMAC \vert ENC )}_{k} = {P}_{horz , i , k} {P}_{vert , i , k} = {\int }_{u = - w}^{w} {f}_{horz , i} ∘ {f}_{horz , k} ( {d}_{horz} ) d u {\int }_{u = - v}^{v} {f}_{vert , i} ∘ {f}_{vert , k} ( {d}_{vert} ) d u \qquad ( Equation 6 )$$

In example Equation 6 above, P_{horz,i,k} represents the horizontal overlap probability between the grid location k and the CPA of flight trajectory i, and P_{vert,i,k} represents the vertical overlap probability between the grid location k and the CPA of flight trajectory i. Further, ƒ_{horz,i} represents the first horizontal position distribution corresponding to the CPA, ƒ_{horz,k} represents the second horizontal position distribution corresponding to the grid location, ƒ_{vert,i} represents the first vertical position distribution corresponding to the CPA, and θ_{vert,k} represents the second vertical position distribution corresponding to the grid location. Additionally, in example Equation 6 above, d_{horz} represents a horizontal distance between the grid location and the CPA, and dᵥₑᵣₜ represents a vertical distance between the grid location and the CPA. Further, w and v represent a threshold horizontal NMAC distance and a threshold vertical NMAC distance, respectively, defining an example NMAC region (e.g., a NMAC volume) of the grid location. For example, the NMAC region extends from the grid location by w in the horizontal direction, and extends from the grid location by ±v in the vertical direction. In this example, w=500 ft and v=100 ft. In some examples, the value(s) for w and/or v may be different.

In some examples, the probability estimation circuitry 212 determines and/or estimates a horizontal risk contribution (e.g., the horizontal overlap probability P_{horz,i,k}) representing, for grid location k, a contribution of flight trajectory i to the probability of NMAC due to horizontal proximity. In some examples, the probability estimation circuitry 212 estimates the horizontal risk contribution by integrating a convolution of the first and second horizontal position distributions. For example, the probability estimation circuitry 212 can estimate the horizontal overlap probability based on example Equation 7 below.

$${P}_{horz , i , k} = {\int }_{u = - w}^{w} {\int }_{x = - ∞}^{∞} {f}_{h o r z , i} ( x ) {f}_{h o r z , k} ( x + d - u ) dx du \qquad ( Equation 7 )$$

In example Equation 7 above, d represents a distance (e.g., the horizontal distance d_{horz}) between mean values of the respective first and second horizontal position distributions ƒ_{horz,i} and ƒ_{horz,k} (e.g., the distance between an expected UAS location at grid location k and an expected aircraft location at the CPA of flight trajectory i). In example Equation 7 above, the inner integral (e.g., from x=−28 to =∞) represents the convolution between the first and second horizontal position distributions (e.g., ƒ_{horz,i} and ƒ_{horz,k}), and the outer integral (e.g., from u=−w to u=w) represents a resulting horizontal separation distribution. Assuming NDE probability distributions for ƒ_{horz,i} and ƒ_{horz,k}, the probability estimation circuitry 212 can estimate the horizontal overlap probability based on example Equation 8 below (with parameters d and w omitted to improve readability).

$${P}_{horz , i , k} = \frac{1}{2} ( ( 1 - {α}_{i} ) ( 1 - {α}_{k} ) {g}_{1} ( ; \sqrt{{σ}_{i}^{2} + {σ}_{k}^{2}} ) + {α}_{k} ( 1 - {α}_{i} ) {g}_{1} ( ; {σ}_{i} ) + {α}_{i} ( 1 - {α}_{k} ) {g}_{1} ( ; {σ}_{k} ) + \frac{1}{4} ( {α}_{k} ( 1 - {α}_{i} ) {g}_{2} ( ; {σ}_{i} , {λ}_{k} ) + {α}_{i} ( 1 - {α}_{k} ) {g}_{2} ( ; {σ}_{k} , {λ}_{i} ) ) + {α}_{i} {α}_{k} {g}_{3} ( ; {λ}_{i} , {λ}_{k} ) \qquad ( Equation 8 )$$

In example Equation 8 above, g₁, g₂, and g₃ represent respective intermediate functions which are analytical solutions of integrals of convolutions of known probability distributions (e.g., Gaussian distributions, Laplacian distributions, etc.). For example, g₁ represents risk associated with overlap of two Gaussian (e.g., Normal) distributions. In some examples, the probability estimation circuitry 212 determines and/or estimates g₁ based on example Equation 9 below.

$${g}_{1} ( d , w , σ ) := {\int }_{u = - w}^{w} N ( u , σ ) ∘ N ( d , σ ) du = erfc ( \frac{d - w}{σ \sqrt{2}} ) - erfc ( \frac{d + w}{σ \sqrt{2}} ) \qquad ( Equation 9 )$$

Further, g₂ represents risk associated with overlap of a Gaussian distribution and a Laplacian (e.g., a Double Exponential) distribution. In some examples, the probability estimation circuitry 212 determines and/or estimates g₂ based on example Equation 10 below.

$$\begin{matrix}{g}_{2} ( d , w , σ , λ ) := {\int }_{u = - w}^{w} N ( u , σ ) ∘ L ( d , λ ) d u \\ = {e}^{{σ}^{2} / ( 2 {λ}^{2} )} [ {e}^{( d + w ) / λ} erfc ( \frac{{σ}^{2} + λ ( d + w )}{\sqrt{2} λ σ} ) \\ - {e}^{- ( d + w ) / λ} erfc ( \frac{{σ}^{2} - λ ( d + w )}{\sqrt{2} λ σ} ) + {e}^{- ( d - w ) / λ} erfc ( \frac{{σ}^{2} - λ ( d - w )}{\sqrt{2} λ σ} ) \\ - {e}^{( d - w ) / λ} erfc ( \frac{{σ}^{2} + λ ( d - w )}{\sqrt{2} λ σ} )\end{matrix} \qquad ( Equation 10 )$$

Finally, g₃ represents risk associated with overlap of two Laplacian distributions. In some examples, the probability estimation circuitry 212 determines and/or estimates g₃ based on example Equations 11 and 12 below.

$${g}_{3} ( d , w , {λ}_{1} , {λ}_{2} ) := {\int }_{u = - w}^{w} L ( u , {λ}_{1} ) ∘ L ( d , {λ}_{2} ) du \qquad ( Equation 11 )$$

$$= \{ \begin{matrix}\frac{{e}^{- d / {λ}_{2}} {λ}_{2}^{2} sin h ( w / {λ}_{2} ) - {e}^{- d / {λ}_{1}} {λ}_{1}^{2} sin h ( w / {λ}_{1} )}{( {λ}_{2}^{2} - {λ}_{1}^{2} )} , & d \geq w \\ \frac{{e}^{- w / {λ}_{1}} {λ}_{1}^{2} cos h ( d / {λ}_{1} ) - {e}^{- w / {λ}_{2}} {λ}_{2}^{2} cos h ( d / {λ}_{2} )}{( {λ}_{2}^{2} - {λ}_{1}^{2} )} + 1 , & d < w\end{matrix} \qquad ( Equation 12 )$$

In example Equations 9 and 10 above, erfc represents the complement of the Error Function, where the probability estimation circuitry 212 can determine erfc based on example Equations 13 and 14 below.

$$erfc ( x ) = 1 - erf ( x ) \qquad ( Equation 13 )$$

$$= 1 - \frac{2}{\sqrt{x}} {\int }_{0}^{x} {e}^{- {t}^{2}} d t \qquad ( Equation 14 )$$

In some examples, by executing and/or evaluating example Equations 7-14 above, the probability estimation circuitry 212 determines the horizontal overlap probability (e.g., P_{horz,i,k}) represented in example Equation 6 above. Further, the probability estimation circuitry 212 determines and/or estimates a vertical risk contribution (e.g., the vertical overlap probability P_{vert,i,k}) representing, for grid location k, a contribution of flight trajectory i to the probability of NMAC due to vertical proximity. In some examples, the probability estimation circuitry 212 estimates the vertical risk contribution based on an integral of a convolution of the first and second vertical position distributions (e.g., ƒ_{vert,i} and ƒ_{vert,k}). For example, the probability estimation circuitry 212 can estimate the vertical overlap probability based on example Equation 15 below.

$${P}_{vert , i , k} = {\int }_{u = - z}^{z} {\int }_{x = - ∞}^{∞} {f}_{vert , i} ( x ) {f}_{vert , k} ( x + d - u ) dx du \qquad ( Equation 15 )$$

In example Equation 15 above, d represents a distance (e.g., the vertical distance dᵥₑᵣₜ) between mean values of the respective first and second vertical position distributions ƒ_{vert,i} and ƒ_{vert,k} (e.g., the distance between an expected UAS vertical location at grid location k and an expected aircraft vertical location at the CPA of flight trajectory i). In example Equation 15 above, the inner integral (e.g., from x=−∞ to =∞) represents the convolution between the first and second vertical position distributions (e.g., ƒ_{vert,i} and ƒ_{vert,k}), and the outer integral (e.g., from u=−z to u=z) represents a resulting vertical separation distribution. Assuming Laplacian probability distributions for ƒ_{vert,i} and ƒ_{vert,k}, the probability estimation circuitry 212 can estimate the vertical overlap probability based on example Equation 16 below.

$${P}_{vert , i , k} = {g}_{3} ( d , z , {λ}_{1} , {λ}_{2} ) \qquad ( Equation 16 )$$

In example Equation 16 above, g₃ represents a function similar to a corresponding function used to determine the horizontal overlap probability (e.g., the function g₃ represented in example Equations 11 and 12 above), but the function g₃ of example Equation 16 above is re-parameterized. For example, the probability estimation circuitry 212 determines the inner integral (e.g., the convolution of Laplacians) based on example Equations 17 and 18 below.

$$L ( u , {λ}_{1} ) ◦ L ( d , {λ}_{2} ) := {\int }_{x = - ∞}^{∞} {f}_{vert , i} ( x ) {f}_{vert , k} ( x + d - u ) dx du \qquad ( Equation 17 )$$

$$= \{ \begin{matrix}\frac{( λ + \vert x - {μ}_{1} - {μ}_{2} \vert )}{2 λ} L ( x , {μ}_{1} + {μ}_{2} , λ ) , & {λ}_{1} = {λ}_{2} = λ \\ \begin{matrix}\frac{{λ}_{1}^{2}}{{λ}_{1}^{2} - {λ}_{2}^{2}} L ( x , {μ}_{1} + {μ}_{2} , {λ}_{1} ) - \\ \frac{{λ}_{2}^{2}}{{λ}_{1}^{2} - {λ}_{2}^{2}} L ( x , {μ}_{1} + {μ}_{2} , {λ}_{2} ) ,\end{matrix} & \begin{matrix}{λ}_{1} \neq {λ}_{2} \\ \end{matrix}\end{matrix} \qquad ( Equation 18 )$$

In some examples, the probability estimation circuitry 212 determines, for a given grid location k and a given flight trajectory i, the corresponding horizontal overlap probability P_{horz,i,k} (e.g., based on example Equations 7-14 above) and the corresponding vertical overlap probability P_{vert,i,k} (e.g., based on example Equations 15-18 above). Further, based on example Equation 6 above, the probability estimation circuitry 212 determines the NMAC probability Pᵢ(NMAC|ENC)ₖ corresponding to the grid location k and the flight trajectory i. In some examples, the probability estimation circuitry 212 similarly determines NMAC probabilities corresponding to remaining one(s) of the flight trajectories having a CPA within the encounter region of the grid location k. In some such examples, the probability estimation circuitry 212 determines, based on example Equation 5 above, a weighted sum of the NMAC probabilities determined for the respective different flight trajectories to determine a weighted NMAC probability (e.g., P(NMAC|ENC)ₖ) corresponding to the grid location k. Example pseudocode representative of an example NMAC probability estimation process to determine the weighted NMAC probability for the corresponding grid location k is shown below.

| 13 | \| | \| | horzDist ← Horizontal distances from CPAs to gridPts | | |
|---|---|---|---|---|---|
| 14 | \| | \| | vertDist ← Vertical distances from CPAs to gridPts | | |
| 15 | \| | \| | if horzDist smaller than ENC horizontal dimension then | | |
| | \| | \| | \| | /* Vectorised operations | */ |
| 16 | \| | \| | \| | horzOverlapP ← NDEs overlap probability (Equation (8) using NMAC horizontal | |
| | \| | \| | \| | dimension and horzDist); | /* Risk associated with horizontal proximity */ |
| 17 | \| | \| | \| | vertOverlapP ← [symbol] overlap probability (Equation (16) using NMAC vertical | |
| | \| | \| | \| | dimension and vertDist); | /* Risk associated with vertical proximity */ |
| 18 | \| | \| | \| | totalOverlapP ← horzRisk × vertRisk / #ENC; | /* [symbol] (NMAC\|ENC) map from |

| | | | |
|---|---|---|---|
| \| | \| | \| | flight i */ |

| | | | |
|---|---|---|---|
| 19 | \| | \| | end if |

| | | |
|---|---|---|
| 20 | \| | end for |
| 21 | \| | nmacEncProb ← Sum totalRisk maps from individual flights |

[symbol]

indicates data missing or illegible when filed

In some examples, the probability estimation circuitry 212 repeats the above process for remaining one(s) of the grid locations to determine the weighted NMAC probabilities for the respective grid locations. In some examples, the probability estimation circuitry 212 stores, in association with the respective grid locations, the weighted NMAC probabilities in the example database 222. In some examples, the probability estimation circuitry 212 is instantiated by programmable circuitry executing probability estimation circuitry instructions and/or configured to perform operations such as those represented by the flowchart(s) of FIGS. 23 and/or 27.

The example risk metric determination circuitry 214 determines one or more example risk metrics corresponding to respective one(s) of the grid locations. For example, the risk metric(s) can include, for respective one(s) of the grid locations, a probability of an encounter occurring when a movement has occurred (e.g., P(ENC|MOV)), a probability of a NMAC occurring when a movement has occurred (e.g., P(NMAC|MOV)), a probability of a MAC occurring when a movement has occurred (e.g., P(MAC|MOV)), an encounter rate per hour (e.g., λ_{ENC}_{_{H}})), an encounter rate per flight hour (e.g., λ_{ENC}_{_{FH}}), a MAC rate per hour (e.g., λ_{MAC}_{_{H}}), and/or a MAC rate per flight hour (e.g., λ_{MAC}_{_{H}}). For example, the risk metric determination circuitry 214 can determine the MAC probability for a corresponding grid location k (e.g., P(MAC|MOV)ₖ) based on example Equation 19 below.

$${P ( MAC \vert MOV )}_{k} = P ( MAC \vert NMAC ) {P ( NMAC \vert ENC )}_{k} {P ( ENC \vert MOV )}_{k} \qquad ( Equation 19 )$$

In example Equation 19 above, P(MAC|NMAC) represents the probability of a MAC occurring when a NMAC has occurred, and can be based on a simulated value(s) obtained via the user input 226 and/or computed using aircraft type (e.g., extent) information. In this example, P(MAC|NMAC)=0.01. In some examples, the value of P(MAC|NMAC) may be different. Further, in example Equation 19 above, P(NMAC|ENC)ₖ represents the weighted NMAC probability (e.g., the probability that a NMAC occurs when an encounter has occurred) determined by the probability estimation circuitry 212 for the grid location k. In example Equation 19 above, P(ENC|MOV)ₖ represents, for the grid location k, the probability of an encounter occurring when a movement has occurred (e.g., as determined by the encounter detection circuitry 210 based on example Equation 4A above). In some examples, the encounter detection circuitry 210 can determine, for the grid location k, the probability of a NMAC occurring when a movement has occurred (e.g., P(NMAC|MOV)) by multiplying P(ENC|MOV)ₖ by P(NMAC|ENC)ₖ.

In some examples, in addition to or instead of the MAC probability (e.g., P(MAC|MOV)ₖ), the risk metric determination circuitry 214 can determine the MAC rate(s) (e.g., per hour and/or per flight hour) corresponding to the grid location k based on example Equation 20 below.

$${λ}_{MAC , k} = P ( MAC \vert NMAC ) {P ( NMAC \vert ENC )}_{k} {λ}_{ENC , k} \qquad ( Equation 20 )$$

In example Equation 20 above, the right hand side is similar to the right hand side of example Equation 19 above, but the P(ENC|MOV)ₖ term of Equation 19 is replaced with an encounter rate λ_{ENC,k} corresponding to the grid location k. In some examples, when the encounter rate corresponds to a per-hour encounter rate (e.g., λ_{ENC}_{_{H}}_{,k}), the risk metric estimation circuitry 214 determines the MAC rate per hour (e.g., λ_{MAC}_{_{H}}_{,k}) based on example Equation 20 above. In some examples, when the encounter rate corresponds to a per-flight-hour encounter rate (e.g., λ_{ENC}_{_{FH}}_{,k}), the risk metric determination circuitry 214 determines the MAC rate per flight hour (e.g., λ_{MAC}_{_{FH}}_{,k}) based on example Equation 20 above. In some examples, the encounter rate per hour and/or the encounter rate per flight hour are determined by the encounter detection circuitry 210 using example Equations 4B and/or 4C above. Example pseudocode representative of an example risk metric determination process to determine the example risk metric(s) for the corresponding grid location k is shown below.

| Input : | encCount (encounter count) |
|---|---|
| | nmacEncProb (P(NMAC\|ENC)) |
| | macNmacProb (P(MAC\|NMAC) = 0.01) |
| | numberOfFlights (number of flight trajectories in the data) |
| | dataHours (time frame of data, in hours) |
| | flightHours (total flight hours in the data) |
| Output: | encMovProb (probability of ENC given MOV, at location k) |

encRatePH (rate of ENC, per hour, at location k)
encRatePFH (rate of ENC, per flight hour, at location k)
nmacMovProb (probability of NMAC given MOV, at location k)
macMovProb (probability of MAC given MOV, at location k)
macRatePH (rate of MAC, per hour, at location k)
macRatePFH (rate of MAC, per flight hour, at location k)
riskContours (contour map clustering locations with similar risk, in orders of

| | magnitude) | |
|---|---|---|
| | /* Code start | */ |
| 1 | encMovProb ← encCount/numberOfFlights ; | /* P(ENC\|MOV) */ |
| 2 | encRatePH ← encCount/dataHours ; | /* [symbol] */ |
| 3 | encRatePFH ← encCount/flightHours ; | /* [symbol] */ |
| 4 | nmacMovProb ← nmacEncProb × emcMovProb ; | /* P(NMAC\|MOV) */ |
| 5 | macMovProb ← nmacEncProb × macNmacProb × encMovProb ; | /* P(MAC\|MOV) */ |
| 6 | macRatePH ← nmacEncProb × macNmacProb × encRatePH ; | /* [symbol] */ |
| 7 | macRatePFH ← nmacEncProb × macNmacProb × encRatePFH ; | /* [symbol] */ |

| | |
|---|---|
| 8 | riskContours ← Draw a contour map clustering regions of similar risk value (in orders of |
| | magnitude intervals), for any desired metric above. |

[symbol]

indicates data missing or illegible when filed

In some examples, the risk metric determination circuitry 214 repeats the above process for remaining one(s) of the grid locations to determine the risk metric(s) corresponding to the respective one(s) of the grid locations. In some examples, the risk metric determination circuitry 214 stores, in association with the respective grid locations, the determined risk metric(s) in the database 222. In some examples, the risk metric determination circuitry 214 is instantiated by programmable circuitry executing risk metric determination circuitry instructions and/or configured to perform operations such as those represented by the flowchart(s) of FIGS. 23 and/or 28.

The example map generation circuitry 216 of FIG. 2 generates one or more example maps (e.g., risk map(s), contour map(s)) based on one(s) of the risk metrics determined by the risk metric determination circuitry 214. For example, the map generation circuitry 216 obtains the MAC probabilities (e.g., P(MAC|MOV)ₖ) and/or the MAC rates (e.g., λ_{MAC,k}) determined for respective ones of the grid locations. In some examples, the map generation circuitry 216 combines (e.g., concatenates) ones of the MAC probabilities to generate an example risk likelihood map (e.g., a risk likelihood matrix) based on example Equation 21 below.

$$Risk Likelihood Map = [ {P ( MAC \vert MOV )}_{k} ] \qquad ( Equation 21 )$$

In example Equation 21 above, [P(MAC|MOV)ₖ] represents a matrix of the MAC probabilities for a given airspace and/or region of interest. Additionally or alternatively, the map generation circuitry 216 combines (e.g., concatenates) ones of the MAC rates to generate an example risk rate map (e.g., a risk rate matrix) based on example Equation 22 below.

$$Risk Rate Map = [ {λ}_{MAC , k} ] \qquad ( Equation 22 )$$

In example Equation 22 above, [λ_{MAC,k}] represents a matrix of the MAC rates (e.g., per hour and/or per flight hour) for the given airspace and/or region of interest. In some examples, the map generation circuitry 216 outputs the risk map(s) (e.g., the risk likelihood map and/or the risk rate map) and/or portion(s) thereof for presentation (e.g., by the electronic device 104 of FIG. 1 and/or another user device).

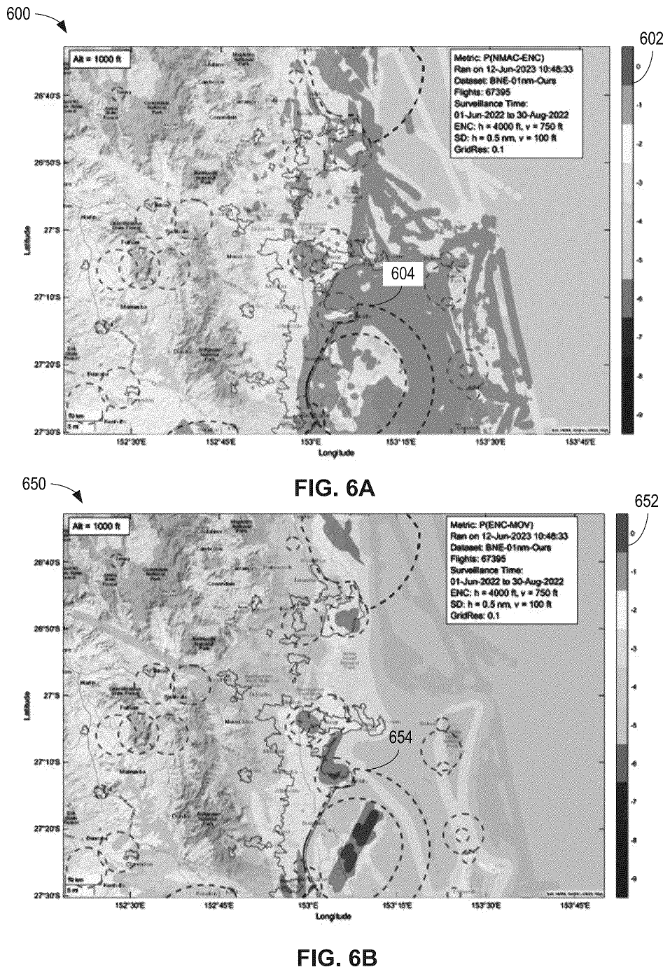

For example, the map generation circuitry 216 can present and/or display the risk map(s) as one or more example contour maps (e.g., 2-D contour map(s) and/or 3-D contour map(s)) representing the risk metric(s) with respect to a geographic region. In some examples, the contour map(s) can represent the risk metrics corresponding to a particular altitude level (or range of altitude levels) and/or a particular time frame (e.g., a hour(s), day(s), week(s), month(s), etc.). In some examples, different values (and/or ranges or values) of the risk metric(s) in the contour map(s) can be represented using respective contour lines, colors, patterns, etc. Example risk maps that can be generated by the example map generation circuitry 216 are described further below in connection with FIGS. 6A-19B. In some examples, the risk map(s) can be presented to an operator (e.g., via the electronic device 104 of FIG. 1 and/or a different user device) to facilitate flight planning and/or navigation for one or more aircraft. In some examples, the map generation circuitry 216 can store one(s) of the risk maps in the example database 222. In some examples, the map generation circuitry 216 is instantiated by programmable circuitry executing map generation circuitry instructions and/or configured to perform operations such as those represented by the flowchart of FIG. 23.

The example mission evaluation circuitry 218 of FIG. 2 estimates collision risk (e.g., MAC likelihood(s) and/or MAC rate(s)) corresponding to one or more mission locations and/or one or more mission trajectories of an aircraft (e.g., a UAS). For example, a mission trajectory refers to a planned flight trajectory (e.g., an intended flight path) of the aircraft, and the mission location(s) correspond to one or more positions of the mission trajectory. In some examples, based on the determined collision risk, the mission evaluation circuitry 218 can adjust one(s) of the mission trajectories and/or the mission locations to reduce the collision risk associated therewith. In some examples, the planned flight trajectory may correspond to a single altitude or altitude region (e.g., a 2-D altitude region). In some examples, the planned flight trajectory can be a 3-D flight trajectory. In some examples, the 2-D or 3-D planned flight trajectory can be selected based on the user input 226 and/or can be preloaded in the mission evaluation circuitry 218. In some examples, the 2-D altitude of the planned flight trajectory can be selected based on the user input 226 and/or can be preloaded in the mission evaluation circuitry 218.

In some examples, the mission evaluation circuitry 218 determines whether a given mission trajectory is within a region (e.g., an airspace) represented by one(s) of the risk maps generated by the map generation circuitry 216. In such examples, when the mission trajectory is within a region corresponding to one(s) of the risk maps, the mission evaluation circuitry 218 can determine the collision risk based on the one(s) of the risk maps. For example, based on the risk metric(s) (e.g., P(MAC|MOV)ₖ and λ_{MAC,k}) determined for grid locations k represented in the risk map(s) (e.g., where k ∈ S and S is a set of location coordinates within the surveillance data 106), the mission evaluation circuitry 218 can interpolate the risk metric(s) corresponding to the mission location(s) \hat{k}.

In some examples, when risk map(s) corresponding to the mission trajectory are not available (e.g., the mission trajectory is not included in one(s) of the risk maps generated by the map generation circuitry 216), the mission evaluation circuitry 218 directs the altitude analysis circuitry 206, the distance calculation circuitry 208, the encounter detection circuitry 210, the probability estimation circuitry 212, and/or the risk metric determination circuitry 214 to determine risk metric(s) corresponding to the mission location(s) \hat{k}. As a result, the mission evaluation circuitry 218 determines MAC likelihood(s) (e.g., P(MAC|MOV)_{\hat{k}}) and/or MAC rate(s) (e.g., λ_{MAC,\hat{k}}) corresponding to the mission location(s) \hat{k} (e.g., where \hat{k} ∈ M and M is a set of location coordinates along the mission trajectory).

In some examples, the mission evaluation circuitry 218 determines the collision risk for the mission trajectory based on the risk metric(s) determined for the corresponding mission locations. In some examples, using simple metrics, the mission evaluation circuitry 218 determines the collision risk corresponding to a statistical value (e.g., a maximum value, a minimum value, a mean value, a median value, etc.) of the risk metric(s) associated with the mission locations. In some examples, the mission evaluation circuitry 218 determines the collision risk corresponding to a statistical value of the risk metric(s) associated with a boundary region (e.g., a containment region) of the mission trajectory and/or an adjacent airspace region of the mission trajectory. In some such examples, the boundary region is defined by an example boundary (e.g., a 3-D boundary) that is spaced a threshold distance (e.g., in the vertical direction and/or in the horizontal direction) away from one(s) of the mission locations. In some examples, the adjacent airspace region corresponds to a bounding box containing the mission trajectory, with the threshold encounter horizontal distance added to the bounding box (e.g., to account for boundary effects on the resulting collision risk determination).

Additionally or alternatively, the mission evaluation circuitry 218 can determine the collision risk corresponding to the mission trajectory using complex metrics. For example, the mission evaluation circuitry 218 can determine the collision risk corresponding to an expected number of collisions per mission (e.g., λ_{MAC,M}). In some examples, the expected number of collisions per mission is based on duration(s) associated with one or more legs (e.g., portions) of the mission trajectory and individual risk metric(s) associated with corresponding one(s) of the legs. For example, the mission evaluation circuitry 218 can determine the collision risk based on example Equation 23 below.

$${λ}_{MAC , M} = {\sum }_{l = 1}^{M} Δ {t}_{l} {λ}_{MAC , l} , \qquad ( Equation 23 )$$

$$l = 1 , … , M$$

In example Equation 23 above, Δtₗ represents a duration corresponding to trajectory leg l (e.g., a duration for which an aircraft flies along the trajectory leg l). Further, λ_{MAC,l} represents the MAC rate corresponding to the trajectory leg l, and M represents a total number of the trajectory legs. In some examples, the number of trajectory legs can be selected based on the user input 226 and/or can be preloaded in the mission evaluation circuitry 218.

Example pseudocode shown below represents an example mission risk evaluation process performed by the mission evaluation circuitry 218 to estimate the collision risk associated with a given mission trajectory.

| | | |
|---|---|---|
| Input | : | riskContours (contour map of desired risk component, e.g. MACs per hour [symbol] ) |

| | missionTrajectory (UAS flight trajectory) |
|---|---|
| | uasSpeed (UAS speed) |
| Output: | missionRisk (MAC likelihood per mission) |

missionRiskStats (struct with risk statistics)

| | /* Code start | */ |
|---|---|---|
| 1 | intersectPts ← find intersection points between mission trajectory and the contour regions | |
| 2 | newTrajectory ← insert intersectPts into the missionTrajectory vector | |
| 3 | legDist ← Calculate the distance of each flight leg (great circle distance between elements of | |
| | newTrajectory) | |
| 4 | legTime ← legDist / uasSpeed ; | /* element-wise */ |

| 5 | for leg in newTrajectory do | | |
|---|---|---|---|
| 6 | \| | if original sample then | |
| 7 | \| | \| | legRisk ← get risk level of closest point in the riskContours matrix |
| 8 | \| | end if | |
| 9 | \| | if intersect point then | |
| 10 | \| | \| | legRisk ← get risk level of the region the UAS crossed |

| | | |
|---|---|---|
| 11 | \| | end if |

| 12 | end for | |
|---|---|---|
| 13 | missionRisk ← legRisk × legTime ; | /* cross product */ |

| | |
|---|---|
| 14 | missionRiskStats.max ← uasSpeed × max(legRisk) |
| 15 | missionRiskStats.min ← uasSpeed × min(legRisk) |
| 16 | missionkiskStats.mean ← uasSpeed × mean(legRisk) |
| 17 | missionRiskStats.mediam ← uasSpeed × median(legRisk) |

[symbol]

indicates data missing or illegible when filed

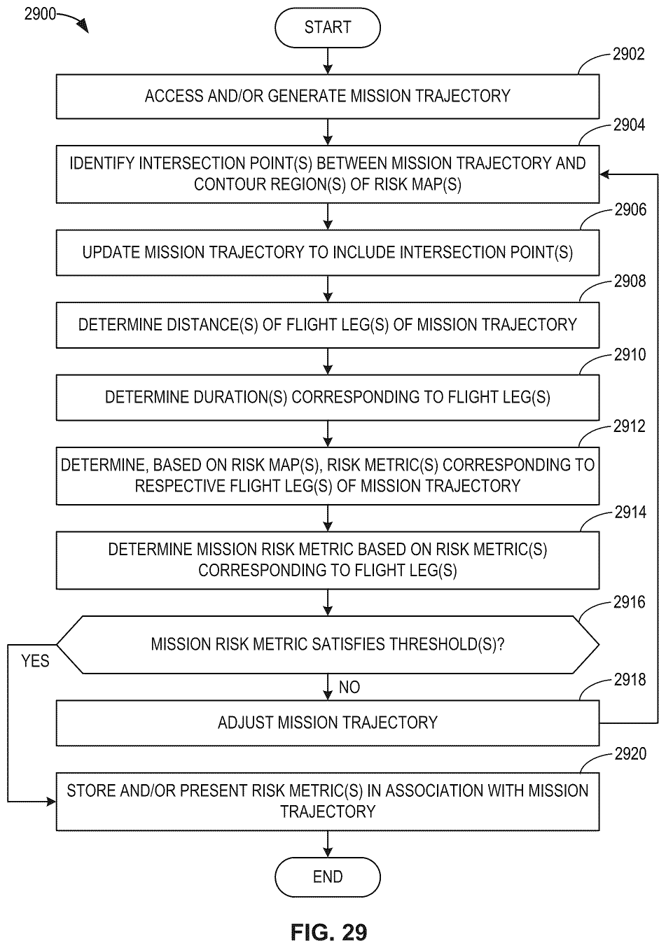

In some examples, the mission evaluation circuitry 218 is instantiated by programmable circuitry executing mission evaluation circuitry instructions and/or configured to perform operations such as those represented by the flowchart of FIG. 29.

The example flight planning circuitry 220 of FIG. 2 generates and/or adjusts one or more example flight plans (e.g., flight trajectories) for an aircraft (e.g., a UAS) based on the risk map(s) determined for a given airspace. For example, during and/or prior to flight of the aircraft, the flight planning circuitry 220 can generate a flight plan (and/or a portion thereof) based on the risk map(s) to guide the aircraft to a target destination while reducing a collision risk. In some examples, the flight planning circuitry 220 executes a gradient-based path planning algorithm based on the risk map(s) to generate a flight plan from a starting location of the aircraft to the target destination, where the generated flight plan corresponds to a reduced collision risk (e.g., compared to other possible flight plans from the starting location to the target destination). In some examples, the flight planning circuitry 220 stores the generated flight plan in the database 222, and/or causes presentation of the flight plan (e.g., via the electronic device 104 of FIG. 1 and/or via a display of the aircraft) to an operator of the aircraft to facilitate steering of the aircraft. In some examples, the flight planning circuitry 220 can generate flight instructions based on the generated flight plan to automatically (e.g., autonomously) steer the aircraft along the flight plan. For example, the flight instructions can enable autonomous control of the aircraft when communication with a remote operator of the aircraft is lost and/or unavailable.

In some examples, during flight of a first aircraft (e.g., a UAS), the flight planning circuitry 220 can utilize the risk map(s) to avoid and/or reduce risk of collision of the first aircraft with a second aircraft (e.g., a neighboring aircraft). For example, when the second aircraft is detected within a threshold distance (e.g., a threshold encounter distance) from the first aircraft (e.g., based on sensor data from one or more sensors), the flight planning circuitry 220 determines a position and/or a heading of the second aircraft. In some such examples, the flight planning circuitry 220 infers and/or predicts intent of the second aircraft (e.g., an expected flight trajectory and/or flight direction of the second aircraft) based on the position and/or the heading of the second aircraft with respect to the risk map(s). In some examples, the flight planning circuitry 220 predicts that the expected flight trajectory of the second aircraft corresponds to a path having a higher collision risk (e.g., compared to other possible path(s) starting from the position of the second aircraft). For example, the collision risk represented in the risk map(s) for a given geographic region typically increases with an increase in expected air traffic (e.g., a number of aircraft expected to fly) within the given geographic region. Therefore, the flight planning circuitry 220 may predict that the second aircraft forms and/or contributes to the expected air traffic of a first geographic region corresponding to a higher collision risk (e.g., compared to other geographic region(s) having a relatively reduced collision risk).

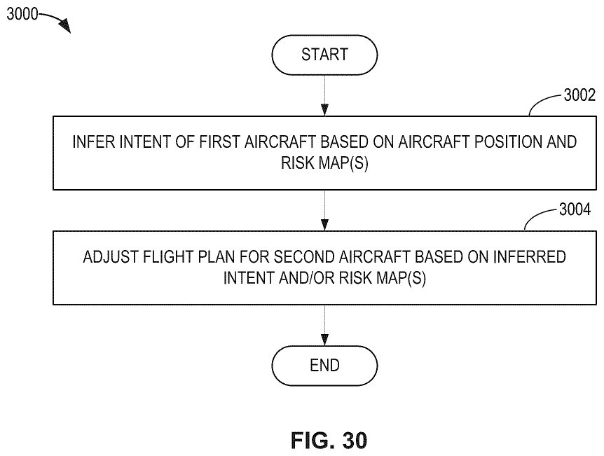

In some examples, the flight planning circuitry 220 adjusts and/or selects the flight trajectory of the first aircraft based on the expected flight trajectory of the second aircraft. For example, when the flight planning circuitry 220 predicts that the second aircraft is to fly in a first direction (e.g., toward and/or within a region of increased collision risk), the flight planning circuitry 220 may adjust and/or generate the flight trajectory of the first aircraft to follow a second direction (e.g., different and/or away from the first direction of the second aircraft, toward a region of relatively reduced collision risk, etc.). In some examples, the flight planning circuitry 220 generates flight instructions to automatically steer the first aircraft in the second direction. In some examples, the flight planning circuitry 220 causes a user device (e.g., the electronic device 104 of FIG. 1) to present the adjusted and/or generated flight trajectory of the first aircraft to an operator of the first aircraft. For example, the flight planning circuitry 220 can cause the user device to present a map indicating the flight trajectory relative to a geographic region and/or airspace. Additionally or alternatively, the flight planning circuitry 220 can cause the user device to output steering instructions (e.g., auditory and/or visual instructions) for the operator to facilitate steering of the first aircraft by the operator. For example, the instructions can direct the operator to steer the first aircraft left, right, forward, etc. In some examples, the flight planning circuitry 220 is instantiated by programmable circuitry executing flight planning circuitry instructions and/or configured to perform operations such as those represented by the flowchart of FIG. 30.

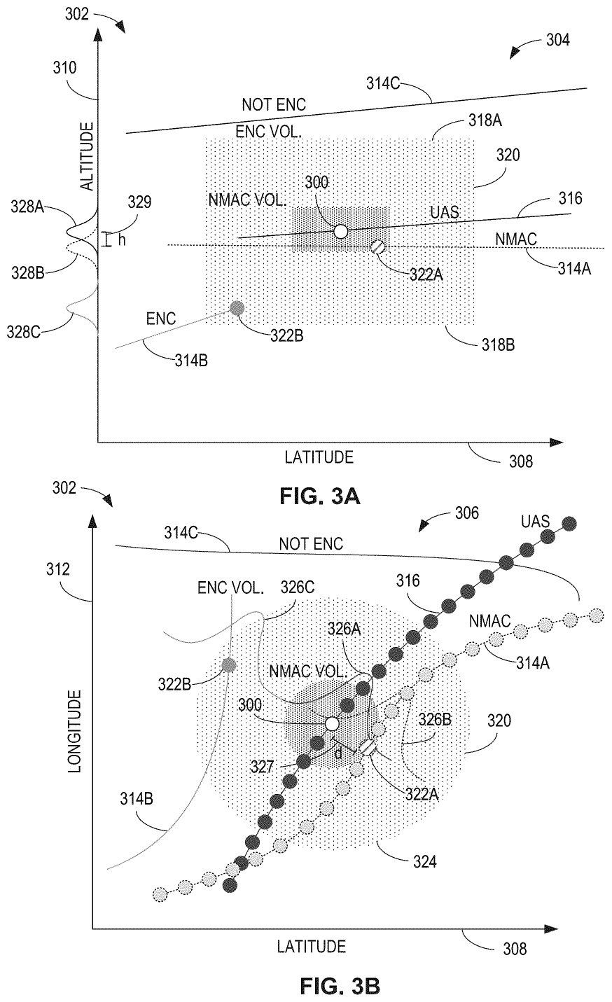

FIGS. 3A and 3B illustrate an example grid location 300 in an example airspace (e.g., a 3-D airspace, a region of interest) 302 for which the example risk estimation circuitry 102 of FIGS. 1 and/or 2 is to determine corresponding example risk metric(s). In the illustrated examples of FIGS. 3A and 3B, the airspace 302 is shown with respect to an example vertical plane (e.g., a latitude-altitude plane) 304 and an example horizontal plane (e.g., a latitude-longitude plane) 306 of the airspace 302, respectively. For example, an example latitude axis 308 and an example altitude axis 310 define the vertical plane 304 of FIG. 3A, and the latitude axis 308 and an example longitude axis 312 define the horizontal plane 306 of FIG. 3B. In the illustrated examples of FIGS. 3A and 3B, three example flight trajectories 314A, 314B, 314C (e.g., represented in the surveillance data 106) are shown in the respective vertical and horizontal planes 304, 306. Further, an example UAS trajectory 316 is shown passing through the grid location 300 for which the example risk estimation circuitry 102 of FIGS. 1 and/or 2 is to determine the corresponding risk metric(s).

Turning to FIG. 3A, the risk estimation circuitry 102 (e.g., via the altitude analysis circuitry 206 of FIG. 2) determines whether one(s) of the flight trajectories 314A, 314B, 314C are within (e.g., at least partially within) vertical encounter volume boundaries 318A, 318B defining an example encounter volume 320 of the grid location 300. In this example, the vertical encounter volume boundaries 318A, 318B are spaced away from the grid location 300 by a threshold encounter vertical distance along the altitude axis 310. In the illustrated example of FIG. 3A, the altitude analysis circuitry 206 determines that the first and second flight trajectories 314A, 314B are (at least partially) within the vertical encounter volume boundaries 318A, 318B, and the third flight trajectory 314C is outside of the vertical encounter volume boundaries 318A, 318B. As a result, the third flight trajectory 314C does not significantly contribute to the risk metric(s) corresponding to the grid location 300 and, thus, may be disregarded in further calculations by the risk estimation circuitry 102.

In the illustrated example of FIG. 3A, the risk estimation circuitry 102 (e.g., via the distance calculation circuitry 208 of FIG. 2) determines and/or identifies a first example closest point of approach (e.g., a first CPA) 322A of the first flight trajectory 314A relative to the grid location 300, and a second example closest point of approach (e.g., a second CPA) 322B of the second flight trajectory 314B relative to the grid location 300. In some examples, the distance calculation circuitry 208 determines the first and second CPAs 322A, 322B corresponding to points of the respective first and second flight trajectories 314A, 314B that have the least distance with respect to the grid location 300 (e.g., relative to other point(s) of the respective first and second flight trajectories 314A, 314B). In some examples, the distance calculation circuitry 208 utilizes 3-D distances to determine the first and second CPAs 322A, 322B instead of 2-D distances (e.g., between the grid location 300 and points of the first and second flight trajectories 314A, 314B projected onto the vertical and/or horizontal planes 304, 306).

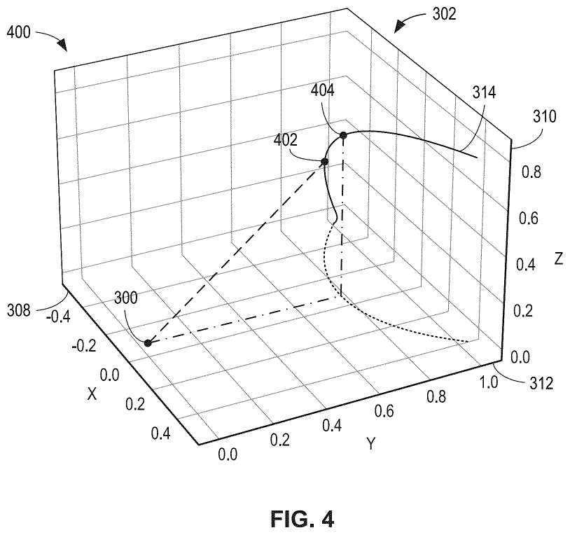

Turning to FIG. 4, an example plot (e.g., a 3-D plot) 400 is shown representative of the example airspace 302 of FIGS. 3A and/or 3B including the grid location 300 and an example flight trajectory 314 (e.g., the first flight trajectory 314A and/or the second flight trajectory 314B of FIGS. 3A and/or 3B). For example, the plot 400 of FIG. 4 is defined by the example latitude axis 308, the example longitude axis 312, and the example altitude axis 310 of FIGS. 3A and/or 3B. In the illustrated example of FIG. 4, a first example point 402 of the flight trajectory 314 corresponds to a 3-D CPA of the flight trajectory 314 relative to the grid location 300 (e.g., a point of the flight trajectory 314 corresponding to a least 3-D distance with respect to the grid location 300 relative to other point(s) of the flight trajectory 314). Further, a second example point 404 of the flight trajectory 314 corresponds to a 2-D CPA of the flight trajectory 314 (e.g., a point of the flight trajectory 314 corresponding to a least 2-D distance with respect to the grid location 300 relative to other point(s) of the flight trajectory 314). Because the 2-D CPA of a flight trajectory may be different in the horizontal plane 306 compared to the vertical plane 304 of FIGS. 3A and/or 3B, the distance calculation circuitry 208 selects the 3-D CPA (e.g., corresponding to the first point 402) as the CPA for purposes of risk metric estimation (e.g., based on the 3-D CPA being irrespective of the one of the planes 304, 306 being considered).

Returning to FIG. 3B, after determining the CPAs 322A, 322B of the respective first and second flight trajectories 314A, 314B, the risk estimation circuitry 102 detects (e.g., via the encounter detection circuitry 210 of FIG. 2) encounters between one(s) of the flight trajectories 314A, 314B and the grid location 300. For example, the encounter detection circuitry 210 determines that the first and second flight trajectories 314A, 314B are both associated with an encounter based on a determination that the first CPA 322A and the second CPA 322B are within an example encounter volume horizontal boundary 324 of the encounter region 320. In this example, the encounter volume horizontal boundary 324 corresponds to a circle centered at the grid location 300 and having a radius corresponding to a threshold encounter horizontal distance.

In some examples, the risk estimation circuitry 102 (e.g., via the probability estimation circuitry 212 of FIG. 2) determines example overlap probabilities between positional distributions (e.g., horizontal positional distributions and/or vertical positional distributions) corresponding to respective ones of the grid location 300 and the CPAs 322A, 322B. In the illustrated example of FIG. 3B, a first horizontal positional distribution 326A is associated with the grid location 300, a second horizontal positional distribution 326B is associated with the first CPA 322A, and the second horizontal positional distribution 326C is associated with the second CPA 322B. Further, first and second mean values of the respective first and second horizontal positional distributions 326A, 326B are separated by a distance (e.g., d) corresponding to a 2-D horizonal distance 327 between the grid location 300 and the first CPA 322A (e.g., along the horizontal plane 306). Further, FIG. 3A illustrates a first vertical positional distribution 328A associated with the grid location 300, a second vertical positional distribution 328B associated with the first CPA 322A, and a third vertical positional distribution 328C associated with the second CPA 322B. In FIG. 3A, first and second mean values of the respective first and second vertical positional distributions 328A, 328B are separated by a distance (e.g., h) corresponding to a vertical distance 329 between the first location 300 and the CPA (e.g., along the altitude axis 310).

In some examples, the positional distributions 326A, 326B, 326C, 328A, 328B, 328C represent positional uncertainty associated with the UAS and/or aircraft along the respective UAS trajectory 316 and/or the flight trajectories 314A, 314B. In some examples, the horizontal positional distributions 326A, 326B, 326C correspond to NDE distributions, and the vertical positional distributions 328A, 328B, 328C correspond to Laplacian distributions. For example, the Laplacian distribution correspond to an example probability density function represented in example Equation 27 below.

$${L}_{( x , μ , λ )} = \frac{{e}^{- \vert x - μ \vert / λ}}{2 λ} , \qquad ( Equation 27 )$$

$$- ∞ < x < ∞$$

In example Equation 27 above, μ represents a position parameter corresponding to a mean value, and λ represents a scale parameter (e.g., λ=λᵥ). In some examples, the Laplacian distribution corresponds to a standard deviation of \sqrt{2λ}.

In some examples, the NDE distributions correspond to an example probability density function represented in example Equation 28 below.

$$NDE ( x , μ , σ , κ , β , α ) := ( 1 - α ) N ( x , μ , σ ) + αℒ ( x , μ , κ , β ) \qquad ( Equation 28 )$$

In example Equation 28 above, α is a mixture parameter representative of proportions of both distributions (e.g., the Normal distribution and the Laplacian distribution), σ is a scale parameter of the Normal distribution, and κ and β are parameters (e.g., greater than zero) that determine tail behavior of the asymmetric Laplacian distribution [symbol] , where the probability density function of the asymmetric Laplacian distribution [symbol] is represented in example Equation 29 below.

$$ℒ ( x , μ , κ , β ) = \{ \begin{matrix}\frac{κβ}{κ + β} {e}^{β ( x - μ )} , & x \leq 0 \\ \frac{κβ}{κ + β} {e}^{- κ ( x - μ )} , & x > 0\end{matrix} \qquad ( Equation 29 )$$

In some examples, when

$$κ = β = \frac{1}{λ} = \frac{1}{{λ}_{h}} ,$$

the asymmetric Laplacian distribution corresponds to the symmetric Laplacian distribution of example Equation 27 above, such that the NDE distribution can be represented using example Equation 30 below.

$$NDE ( x , μ , σ , λ , α ) := ( 1 - α ) N ( x , μ , σ ) + αℒ ( x , μ , λ ) \qquad ( Equation 30 )$$

In some examples, example parameter values for one(s) of the positional distributions are shown in example Table 1 below.

TABLE 1
Example positional distribution parameter values

| Symbol | Nominal Value | | Description |
|---|---|---|---|
| d | — | | Distance between aircraft nominal positions |
| | | | (distribution means) |
| w | — | | Width of volume being considered (NMAC, |
| | | | ENC, etc.) |
| σ | 0.5 | nm | The standard deviation of the Gaussian |
| | | | distribution |
| λₕ | 0.5 | nm | The scale parameter of the Laplacian |
| | | | distribution (horizontal model) |
| λᵥ | 100 | ft | The scale parameter of the Laplacian |
| | | | distribution (vertical model) |
| α | 1 × 10⁻⁵ | | The mixture factor of the Normal-Double |
| | | | Exponential distribution. |
| H_{NMAC} | 500 | ft | Horizontal NMAC dimension |
| V_{NMAC} | 100 | ft | Vertical NMAC dimension |
| H_{ENC} | 4000 | ft | Horizontal ENC dimension |
| V_{ENC} | 750 | ft | Vertical ENC dimension |

In some examples, one(s) of the positional distributions can be different (e.g., can be different type(s) of distributions and/or can utilize different parameter values). For example, the positional distribution(s) (e.g., the horizontal positional distribution and/or the vertical positional distribution) corresponding to point(s) of the flight trajectories 314A, 314B may vary based on availability of data sources (e.g., radar data, ADS-B data, Global Positioning System (GPS) data, etc.) and/or preprocessing techniques. In some examples, the positional distribution(s) corresponding to point(s) of the UAS trajectory 316 may vary based on UAS navigation performance expectations and/or altimetry system errors.

In some examples, the probability estimation circuitry 212 determines horizontal overlap(s) between ones of the horizontal positional distributions 326A, 326B, 326C, and/or determines vertical overlap(s) between ones of the vertical positional distributions 328A, 328B, 328C. In such examples, based on the horizontal overlap(s) and/or the vertical overlap(s), the risk estimation circuitry 102 can determine one or more risk metrics corresponding to the grid location 300 of FIGS. 3A and/or 3B.

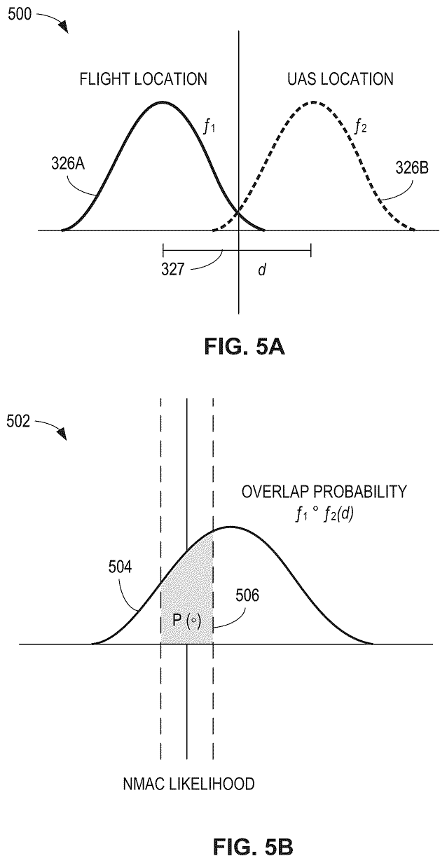

FIG. 5A illustrates a first example plot 500 representative of the first and second horizontal positional distributions 326A, 326B of FIG. 3B separated by the example distance (e.g., d) 327 between the grid location 300 and the first CPA 322A. Further, FIG. 5B illustrates a second example plot 502 representative of an example overlap probability (e.g., a horizonal overlap) between the first and second horizontal positional distributions 326A, 326B of FIGS. 3B and/or 5A. In the illustrated example of FIG. 5B, an example curve 504 represents an example convolution between the first and second horizontal positional distributions 326A, 326B. In some examples, the overlap probability corresponds to an example area 506 below the curve 504, where a width of the area 506 is based on the distance 327 between the first and second horizontal positional distributions 326A, 326B. In some examples, the overlap probability is used to determine an example NMAC probability (e.g., a probability of a NMAC with respect to an encounter occurring) between the first flight trajectory 314A and the grid location 300 of FIGS. 3A and/or 3B.

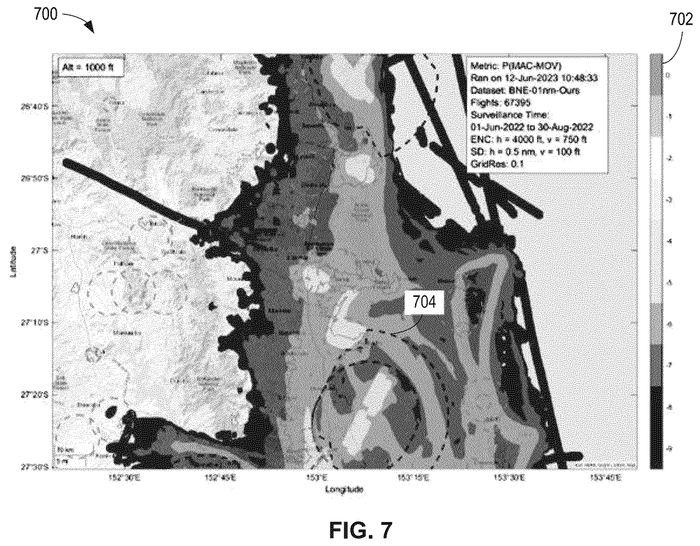

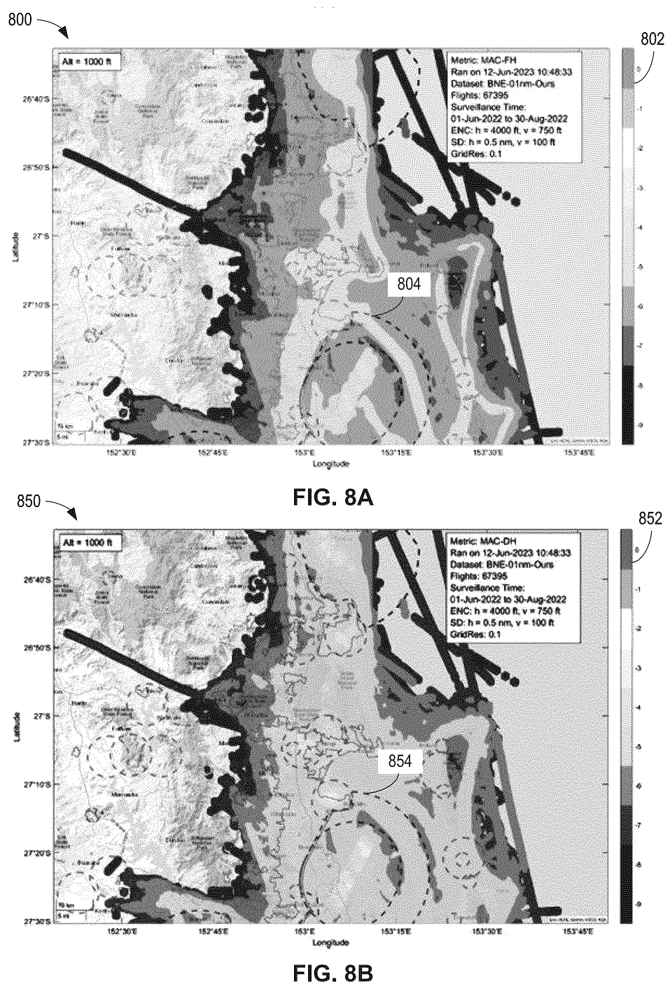

Example risk maps that may be generated by the example risk estimation circuitry 102 of FIGS. 1 and/or 2 are shown in example FIGS. 6A, 6B, 7, 8A, and/or 8B. In the illustrated examples of FIGS. 6A, 6B, 7, 8A, and/or 8B, the risk maps represent respective example risk metrics corresponding to a first example geographic location (e.g., Brisbane, Australia) and a first example altitude level (e.g., 1000 feet above mean sea level (AMSL)). For example, FIG. 6A illustrates a first example risk map 600 representative of example probabilities of a NMAC occurring when an encounter occurs (e.g., P(NMAC|ENC)), FIG. 6B illustrates a second example risk map 650 representative of example probabilities of an encounter occurring when a movement occurs (e.g., P(ENC|MOV)), FIG. 7 illustrates a third example risk map 700 representative of example probabilities of a MAC occurring when a movement occurs (e.g., P(MAC|MOV)), FIG. 8A illustrates a fourth example risk map 800 representative of example collision rates per flight hour (e.g., λ_{MAC}_{_{FH}}), and FIG. 8B illustrates a fifth example risk map 850 representative of example collision rates per hour (e.g., λ_{MAC}_{_{H}}).

In the illustrated examples of FIGS. 6A, 6B, 7, 8A, and/or 8B, the risk map(s) 600, 650, 700, 800, 850 include respective example indicators (e.g., color bars) 602, 652, 702, 802, 852 to indicate example values (e.g., ranges of values) of the respective risk metric(s) (e.g., P(NMAC|ENC), P(ENC|MOV), P(MAC|MOV), λ_{MAC}_{_{FH}}, and λ_{MAC}_{_{H}}). For example, the indicators 602, 652, 702, 802, 852 indicate the values corresponding to respective different colors, shades, patterns, etc. in the risk map(s) 600, 650, 700, 800, 850. In some examples, the values of the respective risk metric(s) are represented in orders of magnitude (e.g., a value of −1 on a corresponding one of the indicators 602, 652, 702, 802, 852 represents a corresponding risk metric value in a range of [10⁻², 10⁻¹]). In some examples, the risk map(s) 600, 650, 700, 800, 850 include respective example boundary lines (e.g., dotted lines) 604, 654, 704, 804, 854 corresponding to one or more example aerodrome areas of the first geographic location. In some examples, the aerodrome areas are used for arrival, departure, and/or movement of aircraft and, thus, typically correspond to increased collision risk (e.g., compared to other area(s) of the first geographic location).

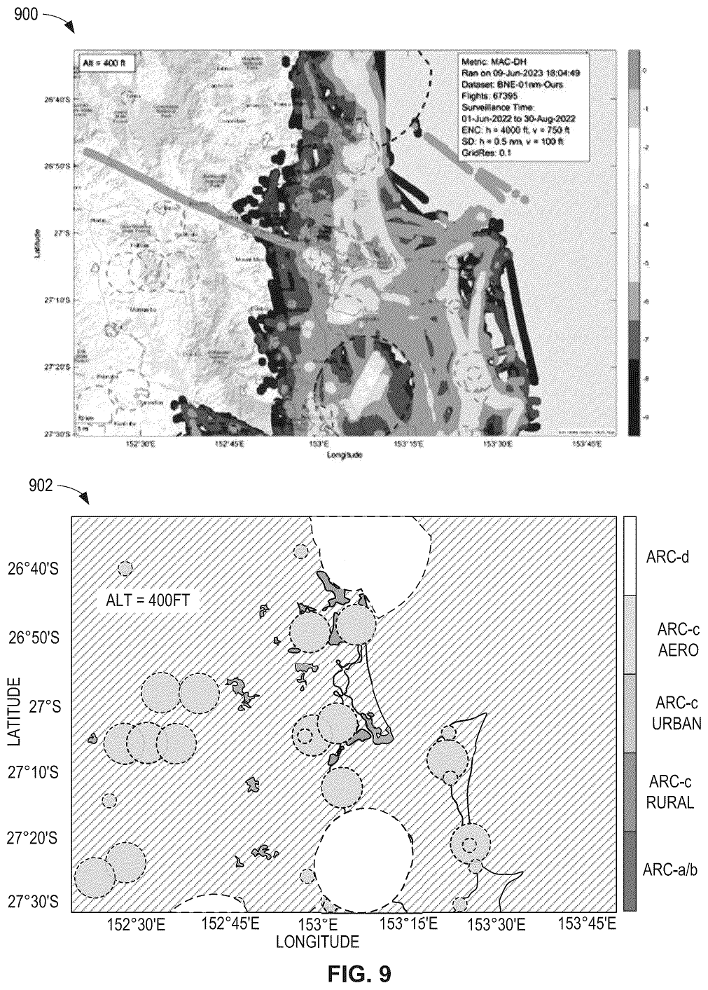

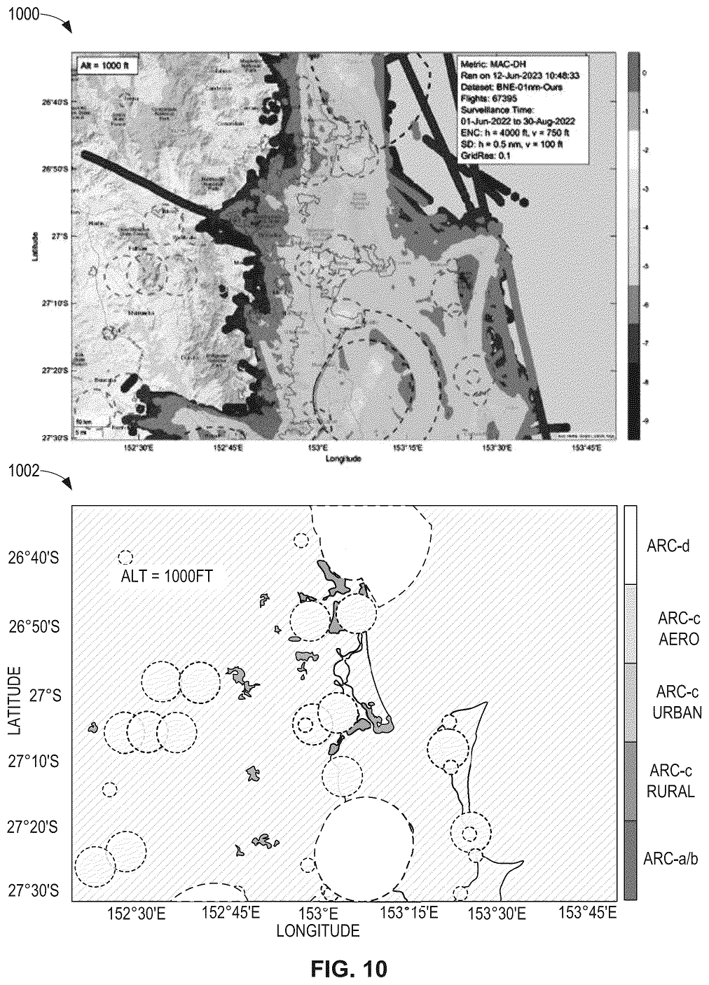

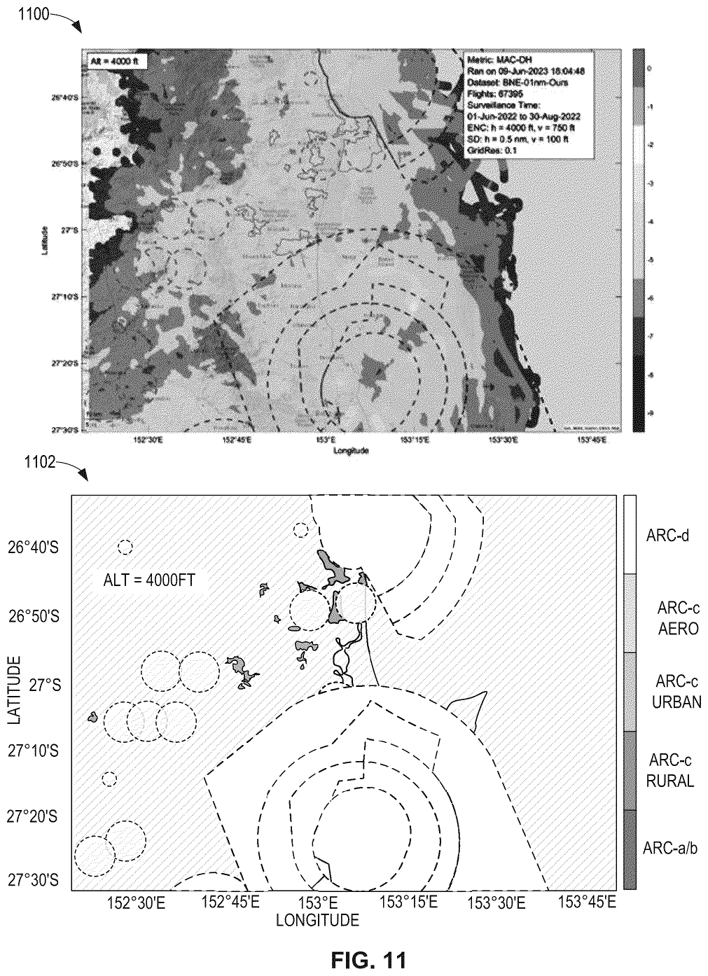

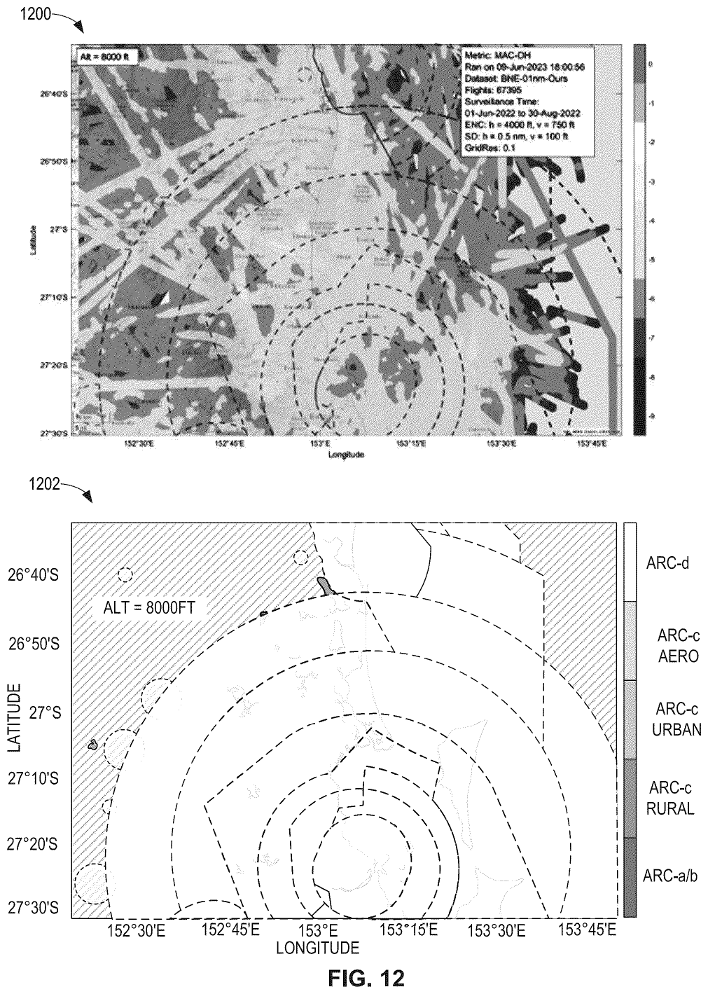

Comparisons between example risk maps generated using an example quantitative-based risk estimation model (e.g., the example risk estimation model(s) disclosed herein) and a qualitative-based model (e.g., a Joint Authorities for Rulemaking of Unmanned Systems (JARUS) Specific Operations Risk Assessment (SORA) model) are described below in connection with FIGS. 9, 10, 11, and/or 12. In particular, FIG. 9 illustrates a first example quantitative model-based risk map 900 and a first example qualitative model-based risk map 902 corresponding to a first example altitude level (e.g., 400 ft), FIG. 10 illustrates a second example quantitative model-based risk map 1000 and a second example qualitative model-based risk map 1002 corresponding to a second example altitude level (e.g., 1000 ft), FIG. 11 illustrates a third example quantitative model-based risk map 1100 and a third example qualitative model-based risk map 1102 corresponding to a third example altitude level (e.g., 4000 ft), and FIG. 12 illustrates a fourth example quantitative model-based risk map 1200 and a fourth example qualitative model-based risk map 1202 corresponding to a fourth example altitude level (e.g., 8000 ft). In the illustrated examples of FIGS. 9, 10, 11, and/or 12, the respective risk maps 900, 902, 1000, 1002, 1100, 1102, 1200, 1202 represent estimated MAC rate per hour (e.g., λ_{MAC}_{_{H}}) corresponding to the first geographic location (e.g., Brisbane, Australia).

In the illustrated examples of FIGS. 9, 10, 11, and/or 12, the JARUS SORA model can be used to generate the respective qualitative model-based risk map(s) 902, 1002, 1102, 1202 as a known risk estimation approach in which an airspace is divided into Air Risk Classes (ARC), where the ARC is a qualitative classification of a rate at which a UAS is expected to encounter a manned aircraft in generalized civil airspace. A first ARC (e.g., ARC-a) corresponds to an airspace where the collision risk between a UAS and a manned aircraft is acceptable without the addition of tactical mitigation. A second ARC (e.g., ARC-b), a third ARC (e.g., ARC-c), and a fourth ARC (e.g., ARC-d) correspond to airspace with an increased risk of collision (e.g., compared to ARC-a). In particular, ARC-b corresponds to a risk of airspace above 60,000 ft and under 500 ft in uncontrolled airspace over rural areas. ARC-c corresponds to the risk over an airport environment in airspace other than Class B, C, or D, airspace between 500 ft and 60,000 ft in uncontrolled airspace, and under 500 ft other than controlled airspace over rural areas. ARC-d corresponds to the risk over an airport environment in Class B, C, or D airspace, and between 500 ft and 60,000 ft in Mode-C Veil (or TMZ) or controlled airspace.

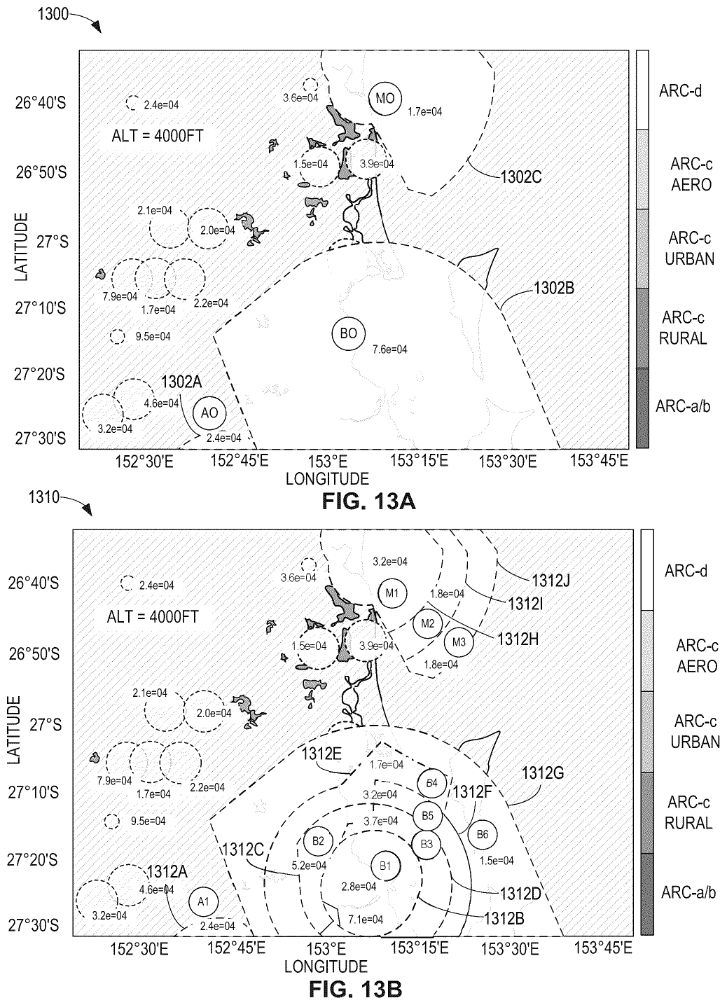

Risk maps generated using data-informed gas model(s) are described below in connection with FIGS. 13A and/or 13B. In particular, gas models refer to a set of collision risk models that assume aircraft behave similarly to gas molecules in a fixed volume (e.g., random motion without specific spatial structure). Using the gas model(s), a collision risk can be estimated based on relative volumes swept by each aircraft in the region and, thus, based on aircraft velocity, aircraft size, and/or a number of aircraft in a region.

Data-informed gas models utilize high-level (e.g., fleet or averaged) track data or statistical data. Such models are based on a relationship between collision rate, average relative motion (e.g., velocities of aircraft in an airspace region), and airspace density (e.g., number of aircraft per unit volume over a given time). For example, a data-informed gas model can be executed based on example Equations 24A, 24B, and/or 24C below.

$${λ}_{{MAC}_{H}} = \frac{1}{T} {P}_{H} {P}_{V} P ( MAC \vert NMAC ) \qquad ( Equation 24 A )$$

$${P}_{H} = 2 {H}_{NMAC} E ( v ) dt \frac{\hat{N}}{A} \qquad ( Equation 24 B )$$

$${P}_{V} = \frac{2 {V}_{NMAC}}{H} \qquad ( Equation 24 C )$$

In example Equations 24A, 24B, and/or 24C above, T represents a total surveillance time (e.g., in hours), H_{NMAC} represents a horizontal dimension of the NMAC volume, E(v) represents an expected velocity of aircraft in the region, and \hat{N}/A represents a horizontal density of the airspace region (e.g., constant over an interval dt). The number of aircraft \hat{N} within a fixed airspace region of area A and H=2V_{ENC} is constant. Vertical component P_{V} assumes a uniform distribution of aircraft over altitude H, such that P_{V} corresponds to an integral of a uniform distribution over the vertical NMAC dimension (e.g., V_{NMAC}). Horizontal component P_{H} assumes a uniform distribution of aircraft within the region, such that P_{H} approximates the NMAC likelihood based on an expected ratio between the area sweep by each aircraft (e.g., 2H_{NMAC}E(v)dt) and the region area (e.g., A). The multiplicative term \hat{N} accounts for a portion (e.g., all) aircraft in the region. Typically, E(v) is estimated based on a triple integral over relative heading and velocity bounds of the aircraft in the region and assumed UAS velocity. Without data, such bounds are assumed and, as such, particular motion may be assumed (e.g., random fixed headings for each aircraft). With data, E(v) can be estimated directly.

FIG. 13A illustrates a first example risk map 1300 generated based on data-informed gas model(s), where the first risk map 1300 is representative of collision rates for a first geographic location (e.g., Brisbane, Australia) considering example outer airspace regions (e.g., A0, B0, and M0) 1302A, 1302B, 1302C (collectively referred to as outer airspace regions 1302). Additionally, FIG. 13B illustrates a second example risk map 1310 generated based on data-informed gas model(s), where the second risk map 1310 is representative of collision rates for the first geographic location considering example inner airspace regions (e.g., A1, B1-B6, and M1-M3) 1312A-J (collectively referred to as inner airspace regions 1312). In some examples, the inner airspace regions 1312 of FIG. 13B correspond to subdivisions of corresponding one(s) of the outer airspace regions 1302 of FIG. 13A. In the illustrated examples of FIG. 13A and/or 13B, the first and second risk maps 1300, 1310 include example airspace region labels and/or collision rates corresponding to respective ones of the inner and outer airspace regions 1302, 1312.

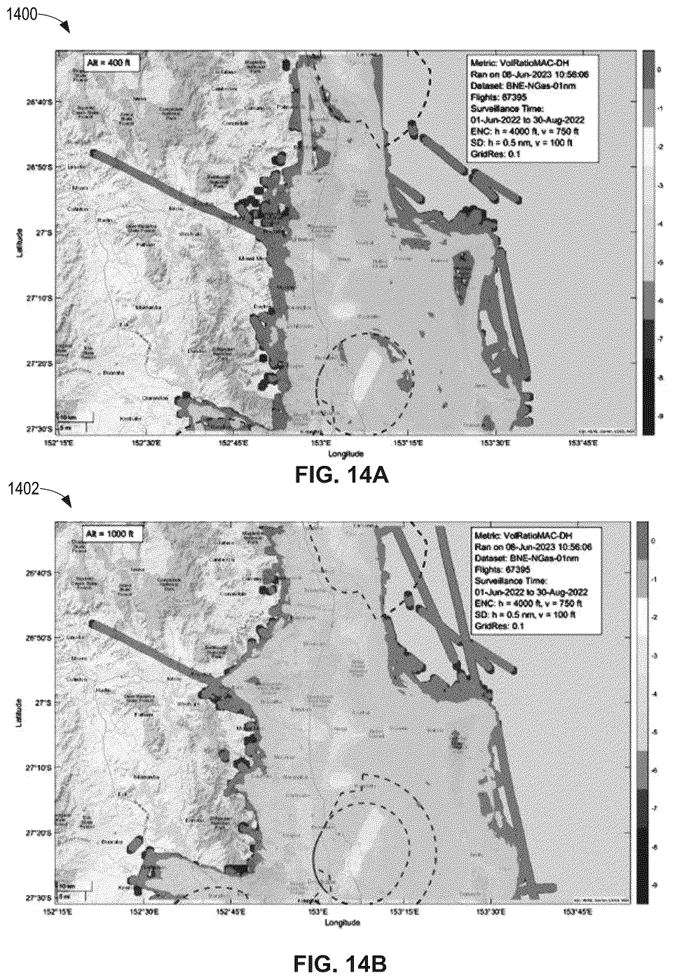

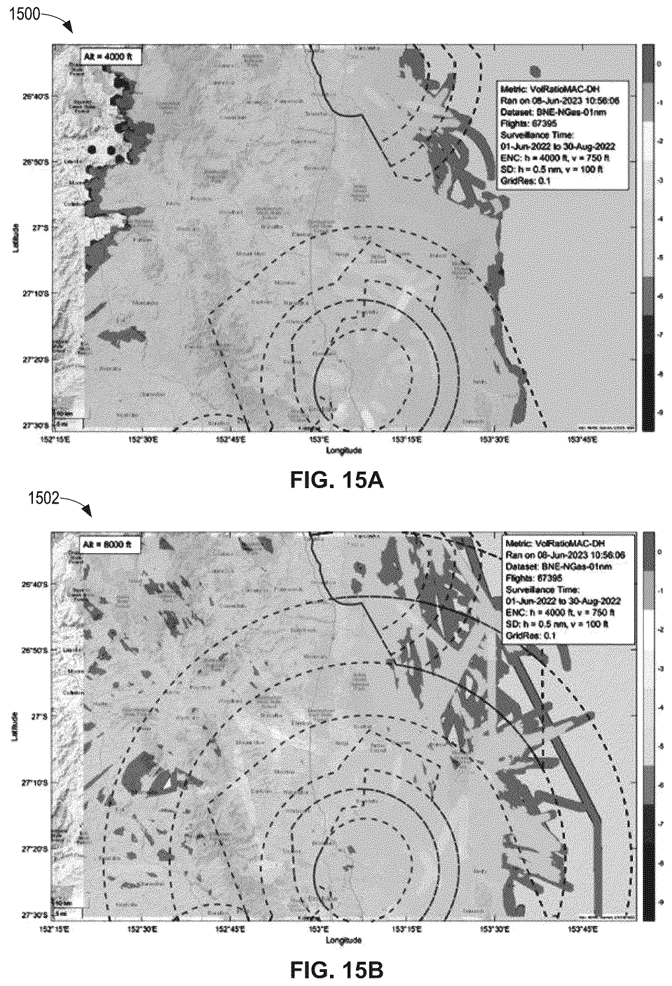

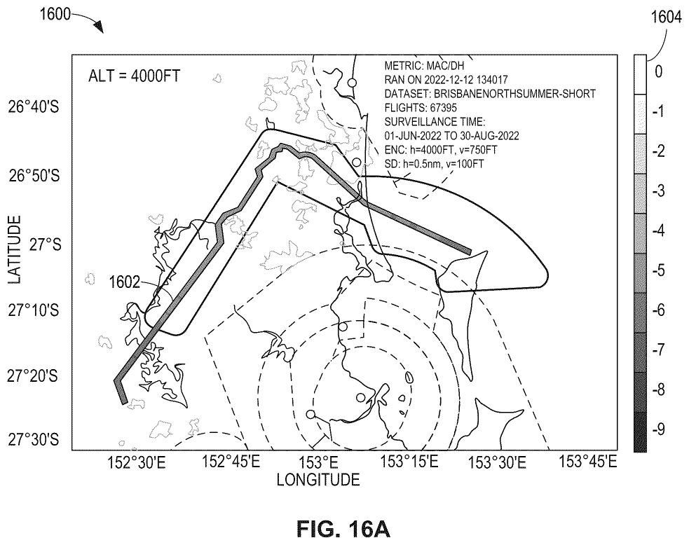

Example risk maps generated using example data-driven gas model(s) are described below in connection with FIGS. 14A, 14B, 15A, and/or 15B. Data-driven gas models utilize low-level (e.g., individual and/or specific) track data. Some data-driven gas models enable estimation of collision likelihood(s) and/or rate(s) corresponding to respective locations based on volumes swept by respective aircraft in the encounter regions of the respective locations. Using data-driven gas model(s), a MAC likelihood corresponding to a location k (e.g., P(MAC|MOV)ₖ) can be determined by aggregating (e.g., adding) areas swept by a portion of (e.g., all) aircraft in an encounter volume of the location k, and dividing the aggregated value by the encounter volume and by a total number of the aircraft. Similarly, a MAC rate per hour corresponding to a location k (e.g., λ_{MAC}_{_{H}}_{,k}) can be determined by aggregating the area swept by a portion (e.g., all) the aircraft in the encounter volume and dividing the aggregated value by the encounter volume and by a surveillance duration. For example, P(MAC|MOV)ₖ and λ_{MAC}_{_{H}}_{,k} can be determined based on example Equations 25 and 26 below, respectively.

$${P ( MAC \vert MOV )}_{k} = P ( MAC \vert NMAC ) ( \frac{1}{{N}_{k}} \frac{1}{V} {\sum }_{i}^{{N}_{k}} ( {dt}_{i} {v}_{i} ( 4 {H}_{NMAC} {V}_{NMAC} ) + π {H}_{NMAC}^{2} {\sum }_{j}^{M} \vert {dh}_{i , j} \vert ) ) \qquad ( Equation 25 )$$

$${λ}_{{MAC}_{H} , k} = P ( MAC \vert NMAC ) ( \frac{1}{T} \frac{1}{V} {\sum }_{i}^{{N}_{k}} ( {dt}_{i} {v}_{i} ( 4 {H}_{NMAC} {V}_{NMAC} ) + π {H}_{NMAC}^{2} {\sum }_{j}^{M} \vert {dh}_{i , j} \vert ) ) \qquad ( Equation 26 )$$

In example Equations 25 and/or 26 above, the inner summation terms represent the volume swept by N aircraft over a duration T within the encounter volume V based on horizontal and/or vertical velocities of the aircraft. In some examples, the velocities are assumed constant over the encounter volume and can be approximated from surveillance data based on average forward speed (e.g., v) and duration (e.g., dt) (e.g., for horizontal velocity) and/or based on change in altitude (e.g., dhₖ) over M data samples included in the encounter volume (e.g., for vertical velocity). The volume swept is based on NMAC dimensions, where H_{NMAC} and V_{NMAC} represent the horizontal and vertical NMAC dimensions, respectively. Further, V_{H} and V_{V} represent horizontal and vertical swept volumes, respectively, for a corresponding track.

FIGS. 14A, 14B, 15A, and 15B illustrate respective example risk maps 1400, 1402, 1500, 1502 generated using data-driven gas model(s) and corresponding to respective different altitude levels. For example, FIG. 14A illustrates a first example risk map 1400 corresponding to a first example altitude level (e.g., 400 ft), FIG. 14B illustrates a second example risk map 1402 corresponding to a second example altitude level (e.g., 1000 ft), FIG. 15A illustrates a third example risk map 1500 corresponding to a third example altitude level (e.g., 4000 ft), and FIG. 15B illustrates a fourth example risk map 1502 corresponding to a fourth example altitude level (e.g., 8000 ft). In the illustrated examples of FIGS. 14A, 14B, 15A, and/or 15B, the risk maps 1400, 1402, 1500, 1502 represent estimated MAC rate per hour (e.g., λ_{MAC}_{_{H}}) corresponding to the first geographic location (e.g., Brisbane, Australia). In some examples, the gas-driven approach described in connection with FIGS. 14A, 14B, 15A, and 15B is unable to recover more granular details (e.g., compared to the example risk estimation approach performed using the risk estimation circuitry 102 of FIGS. 1 and/or 2). Further, the data-driven gas model(s) may produce higher risk values compared to the example risk estimation approach described in connection with FIGS. 1 and/or 2. Additionally, in contrast to the example risk estimation approach described in connection with FIGS. 1 and/or 2, the data-driven gas model(s) do not account for uncertainty associated with surveillance data.

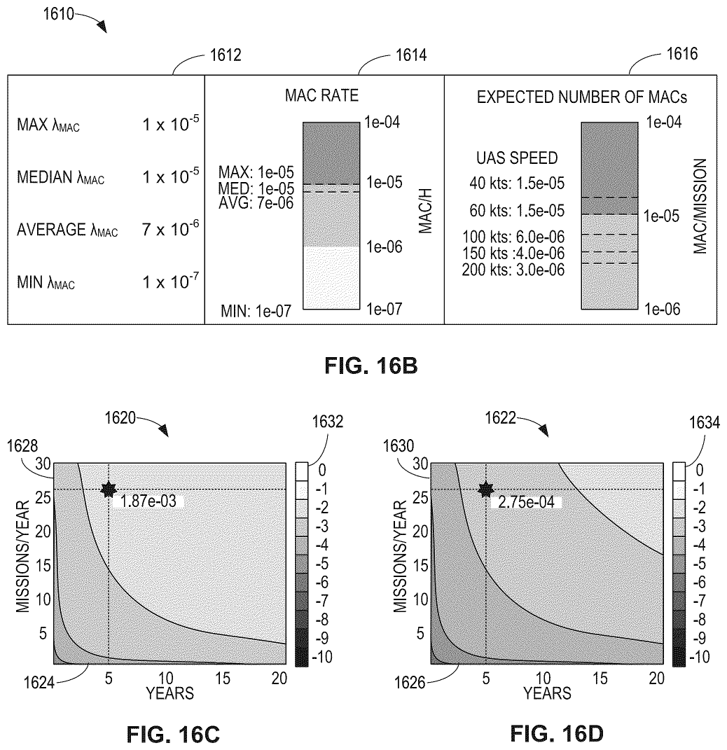

FIG. 16A illustrates an example risk map 1600 generated by the example risk estimation circuitry 102 of FIGS. 1 and/or 2, where the risk map 1600 includes an example mission trajectory 1602 generated and/or evaluated by the example mission evaluation circuitry 218 of FIG. 2. In the illustrated example of FIG. 16A, the mission trajectory 1602 represents a multi-leg flight from an example starting location (e.g., Coominya) to an example destination (e.g., Moreton Island) with a first example geographic location (e.g., north of Brisbane). In some examples, different colors, shades, and/or patterns (e.g., dash patterns) correspond to respective different values (and/or ranges of values) of an associated risk metric. For example, in FIG. 16A, the different colors of the mission trajectory 1602 represent respective different MAC rates per hour (e.g., λ_{MAC}_{_{H}}) at the respective locations of the mission trajectory 1602, where the MAC rates corresponding to respective colors are indicated via an example indicator 1604 associated with the risk map 1600. In some examples, the mission trajectory 1602 may correspond to a single altitude or altitude region (e.g., a 2-D altitude region). In some examples, the mission trajectory 1602 is a 3-D trajectory. In some examples, the 2-D or 3-D mission trajectory 1602 can be selected based on the user input 226 and/or can be preloaded in the mission evaluation circuitry 218. In some examples, the 2-D altitude of the mission trajectory 1602 can be selected based on the user input 226 and/or can be preloaded in the mission evaluation circuitry 218.

FIG. 16B illustrates an example table 1610 representative of example collision risk statistics corresponding to the example mission trajectory 1602 of FIG. 16A. In some examples, the mission evaluation circuitry 218 of FIG. 2 generates the example table 1610 in response to evaluating the collision risk associated with the mission trajectory 1602. In the illustrated example of FIG. 16B, a first example column 1612 represents a maximum example collision rate, a median example collision rate, an average example collision rate, and a minimum example collision rate corresponding to the mission trajectory 1602 of FIG. 16A. Further, a second example column 1614 includes a first example graph representative of the example statistics of the first column 1612. A third example column 1616 includes a second example graph representative of an expected number of collisions per mission based on the collision rate and/or based on durations associated with respective legs of the mission trajectory 1602.

FIGS. 16C and 16D illustrate first and second graphs 1620, 1622 representative of expected example MAC counts corresponding to a first example UAS speed (e.g., 40 knots (kts)) and a second example UAS speed (e.g., 200 kts), respectively. In the illustrated examples of FIGS. 16C and/or 16D, first example axes (e.g., horizontal axes) 1624, 1626 of the respective first and second graphs 1620, 1622 represent durations (e.g., in years), and second example axes (e.g., vertical axes) 1628, 1630 of the respective first and second graphs 1620, 1622 represent mission counts per year. In some examples, different colors, shades, and/or patterns of the respective graphs 1620, 1622 correspond to respective different MAC counts. For example, the MAC counts corresponding to the respective colors are indicated via example indicators 1632, 1634 associated with the respective graphs 1620, 1622. In some examples, increasing UAS speed (e.g., from 40 kts to 200 kts) can reduce time spent by the UAS in a given airspace region and, as a result, can reduce collision risk associated with the UAS.

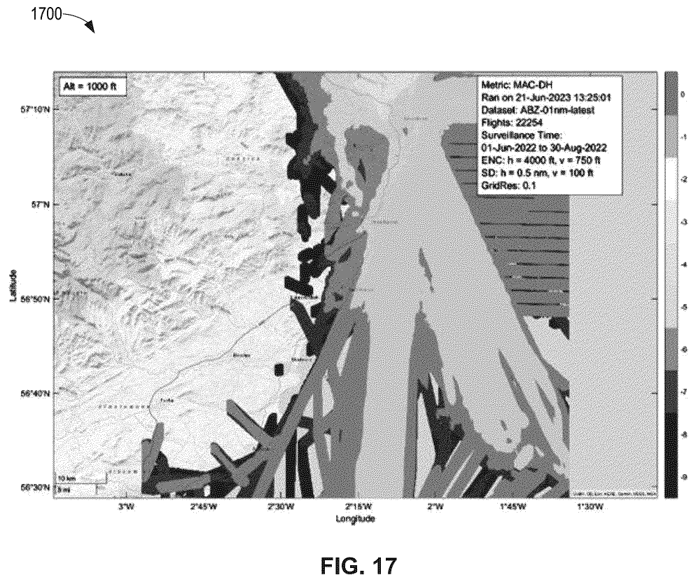

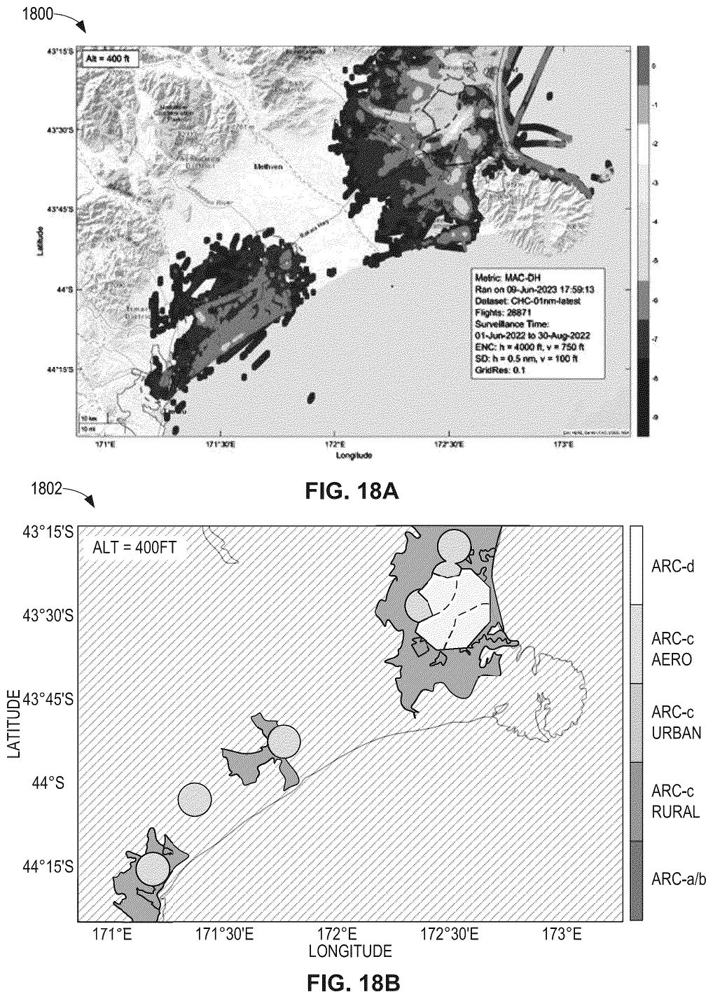

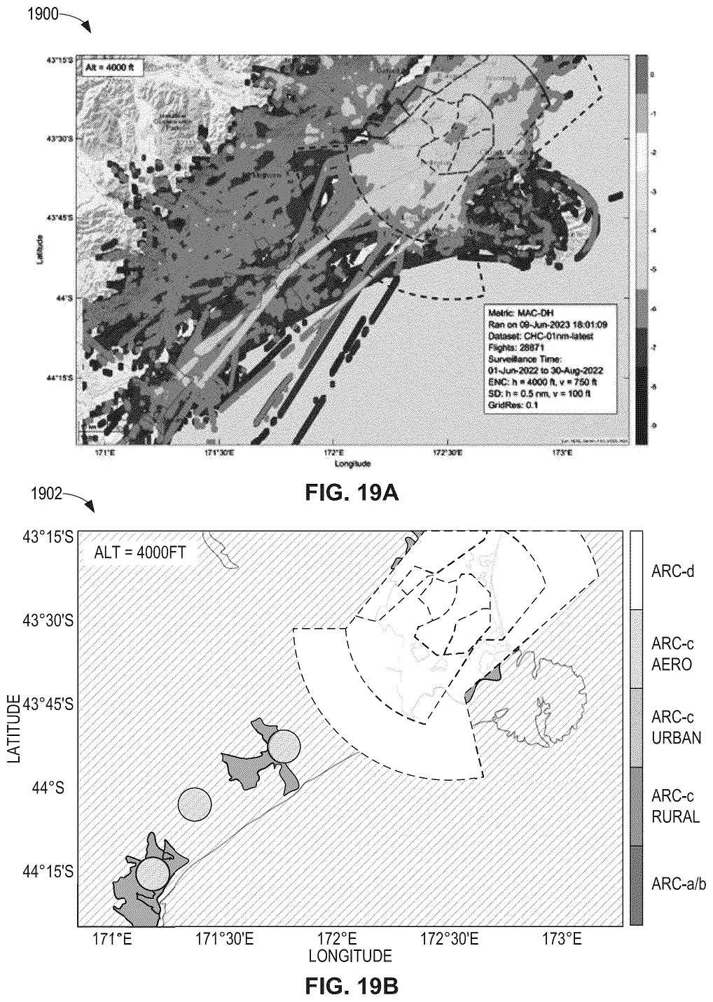

FIGS. 17, 18A, 18B, 19A, and/or 19B illustrate additional example risk maps corresponding to one or more example geographic locations. For example, FIG. 17 illustrates an example risk map 1700 representative of example collision rates per hour (e.g., λ_{MAC}_{_{H}})) corresponding to Aberdeen, United Kingdom, and an altitude level of 1000 ft. Further, FIG. 18 illustrates first and second example risk maps 1800, 1802 representative of example collision rates per hour corresponding to Christchurch, New Zealand, at a first altitude level of 400 ft, and FIG. 19 illustrates third and fourth example risk maps 1900, 1902 representative of example collision rates per hour corresponding to Christchurch, New Zealand, at a second altitude level of 4000 ft. In the illustrated examples of FIGS. 18 and 19, the first and third risk maps 1800, 1900 are generated based on example quantitative risk estimation model(s) (e.g., the risk estimation model(s) implemented by the risk estimation circuitry 102 of FIGS. 1 and/or 2), and the second and fourth risk maps 1802, 1902 are generated based on qualitative risk estimation model(s) (e.g., JARUS SORA). In some examples, the quantitative risk estimation model(s) can be used to produce risk map(s) (e.g., the first and third risk maps 1800, 1900) having increased granularity and/or reduced averaging effects compared to risk map(s) (e.g., the second and fourth risk maps 1802, 1902) produced using the qualitative risk estimation model(s).

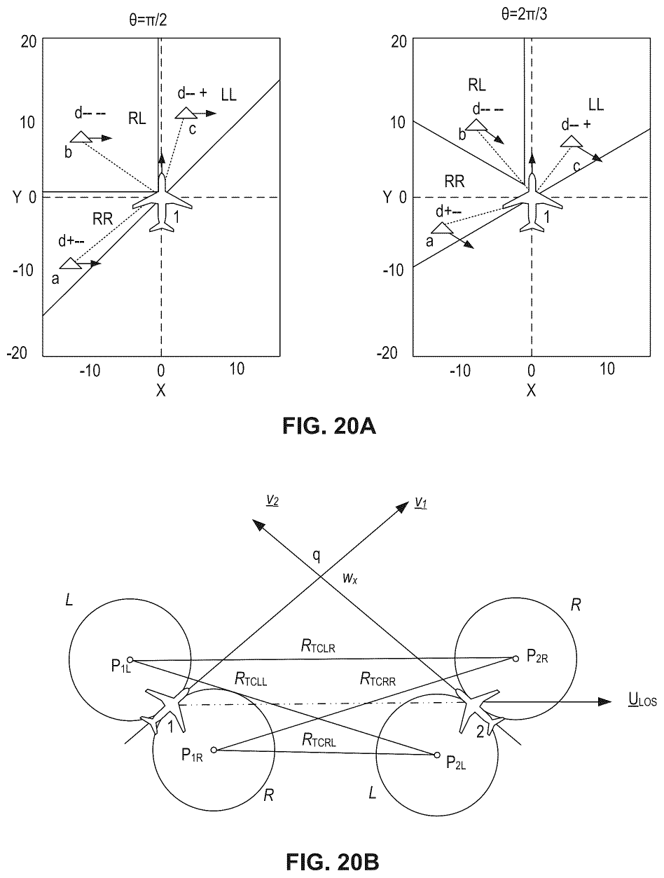

FIG. 20A illustrates first and second example plots 2002, 2204 representative of an example Merz frame approach that may be utilized by the example flight planning circuitry 220 of FIG. 2 to determine a turn direction to increase CPA of aircraft in proximity. The use of the Merz Frame approach is based on inferred and/or predicted aircraft intent from the flight planning circuitry 220. Further, FIG. 20B illustrates an example diagram 2206 representative of an example geometric minimum miss-distance approach that may be utilized by the example flight planning circuitry 220 of FIG. 2 to determine the turn direction to increase distance to the CPA of aircraft in proximity. The use of the geometric minimum miss-distance approach is based on inferred and/or predicted aircraft intent from the flight planning circuitry 220. In some examples, the Merz frame approach of FIG. 20A and the geometric minimum miss-distance approach of FIG. 20B may be combined and/or analyzed based on data associated with MAC high risk areas (e.g., from one or more example risk maps generated by the map generation circuitry 216 of FIG. 2) to provide a tactical assessment while considering aircraft intent. In some examples, the flight planning circuitry 220 determines an example MAC risk gradient based on the risk map(s), where the MAC risk gradient can be used to provide the magnitude and direction of maximum rate of change of the mid-air collision risk in particular areas.

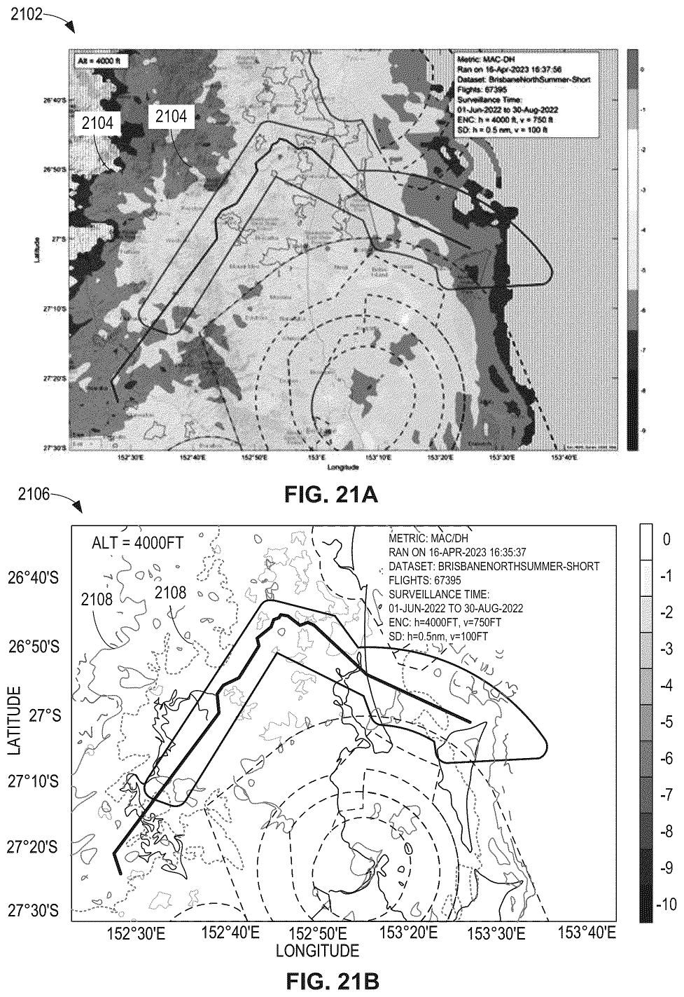

FIGS. 21A and 21B illustrate example contour maps (e.g., risk contour maps) 2102, 2106 that may be generated by the example risk estimation circuitry 102 of FIG. 2. In particular, FIG. 21A illustrates a first example contour map 2102 in which different risk metric values are represented using corresponding example shaded areas 2104, and FIG. 21B illustrates a second example contour map 2106 in which the different risk metric values are represented using corresponding example contour lines 2108 (e.g., instead of shading). In some examples, the map generation circuitry 216 of FIG. 2 can determine, based on the example user input 226 of FIG. 2, whether to use shaded areas and/or contour lines to generate one or more risk maps.

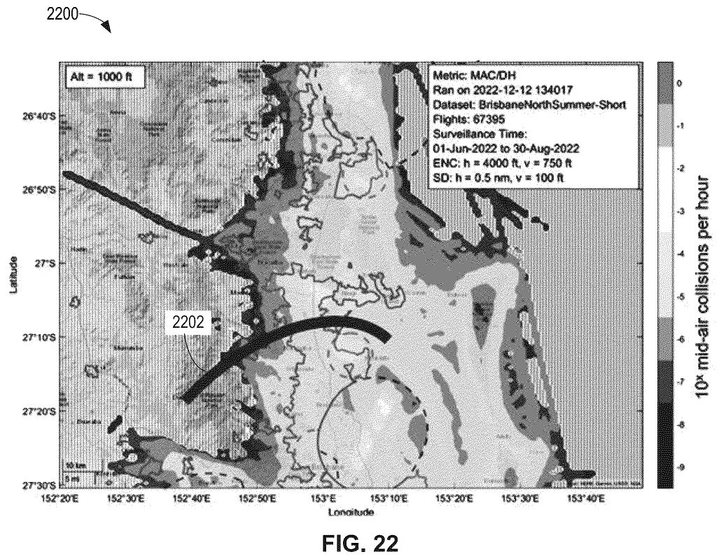

FIG. 22 illustrates an example risk map 2200 including an example flight plan 2202 generated by the example risk estimation circuitry 102 of FIGS. 1 and/or 2. In some examples, the example flight planning circuitry 220 of FIG. 2 generates the flight plan 2202 corresponding to an example risk gradient (e.g., a maximum rate of change) across one or more example contour regions of the risk map 2200.

While an example manner of implementing the risk estimation circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example input interface circuitry 202, the example data preprocessing circuitry 204, the example altitude analysis circuitry 206, the example distance calculation circuitry 208, the example encounter detection circuitry 210, the example probability estimation circuitry 212, the example risk metric determination circuitry 214, the example map generation circuitry 216, the example mission evaluation circuitry 218, the example flight planning circuitry 220, the example database 222, and/or, more generally, the example risk estimation circuitry 102 of FIG. 2, may be implemented by hardware alone or by hardware in combination with software and/or firmware. Thus, for example, any of the example input interface circuitry 202, the example data preprocessing circuitry 204, the example altitude analysis circuitry 206, the example distance calculation circuitry 208, the example encounter detection circuitry 210, the example probability estimation circuitry 212, the example risk metric determination circuitry 214, the example map generation circuitry 216, the example mission evaluation circuitry 218, the example flight planning circuitry 220, the example database 222, and/or, more generally, the example risk estimation circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example risk estimation circuitry 102 of FIG. 2 may include one or more elements, processes, and/or devices in addition to, or instead of, those illustrated in FIG. 2, and/or may include more than one of any or all of the illustrated elements, processes and devices.

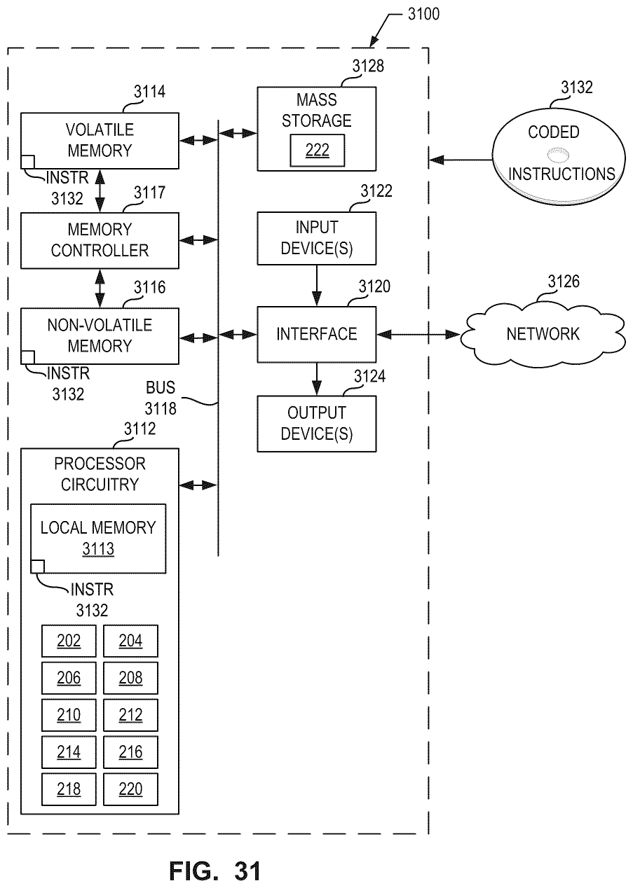

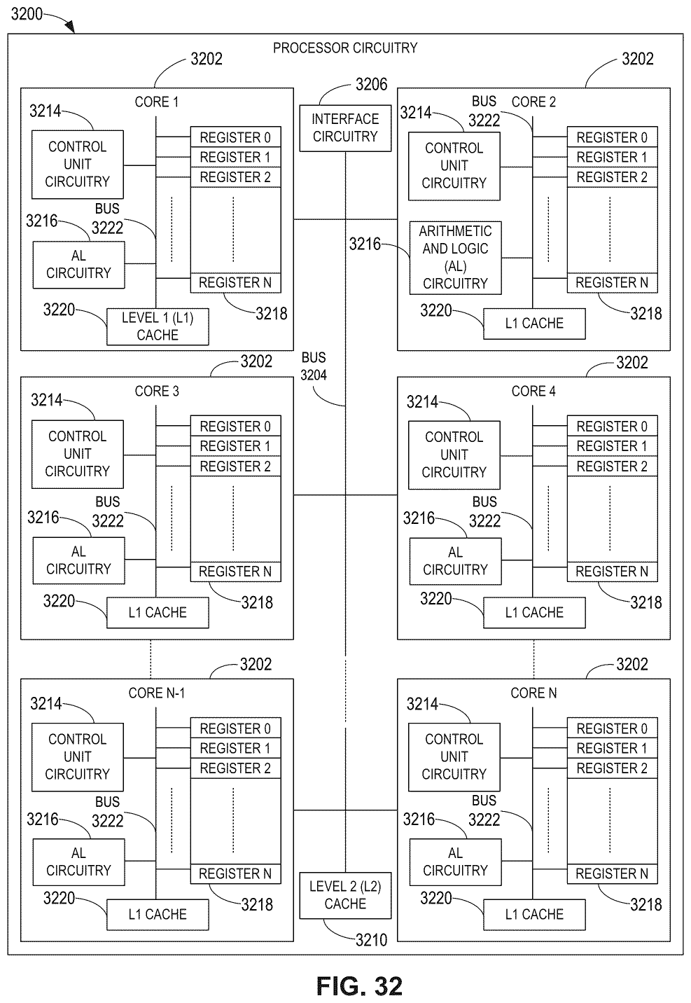

Flowchart(s) representative of example machine readable instructions, which may be executed by programmable circuitry to implement and/or instantiate the risk estimation circuitry 102 of FIG. 2 and/or representative of example operations which may be performed by programmable circuitry to implement and/or instantiate the risk estimation circuitry 102 of FIG. 2, are shown in FIGS. 23-30. The machine readable instructions may be one or more executable programs or portion(s) of one or more executable programs for execution by programmable circuitry such as the programmable circuitry 3112 shown in the example processor platform 3100 discussed below in connection with FIG. 31 and/or may be one or more function(s) or portion(s) of functions to be performed by the example programmable circuitry (e.g., an FPGA) discussed below in connection with FIGS. 32 and/or 33. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 23-30, many other methods of implementing the example risk estimation circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 23-30 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 23 is a flowchart representative of example machine readable instructions and/or example operations 2300 that may be executed, instantiated, and/or performed by the example risk estimation circuitry 102 of FIGS. 1 and/or 2 to generate one or more example risk maps. The example machine-readable instructions and/or the example operations 2300 of FIG. 23 begin at block 2302, at which the example risk estimation circuitry 102 accesses the example surveillance data 106 representative of an example airspace (e.g., an airspace of interest, a region of interest). For example, the example input interface circuitry 202 of FIG. 2 accesses the surveillance data 106 including one or more example flight trajectories observed in the airspace across a given duration (e.g., hour(s), day(s), month(s), etc.).

At block 2304, the example risk estimation circuitry 102 performs preprocessing of the surveillance data 106 (and/or a portion thereof). For example, the example data preprocessing circuitry 204 of FIG. 2 performs at least one of a track creation process, a cleaning and/or splitting process, a track smoothing process, or a track correction process based on the surveillance data 106 and the corrective data 110.

At block 2306, the example risk estimation circuitry 102 selects example grid locations in the airspace of interest. For example, the example input interface circuitry 202 selects the grid locations based on an example spacing parameter (e.g., selected via the example user input 226 and/or preloaded in the risk estimation circuitry 102).

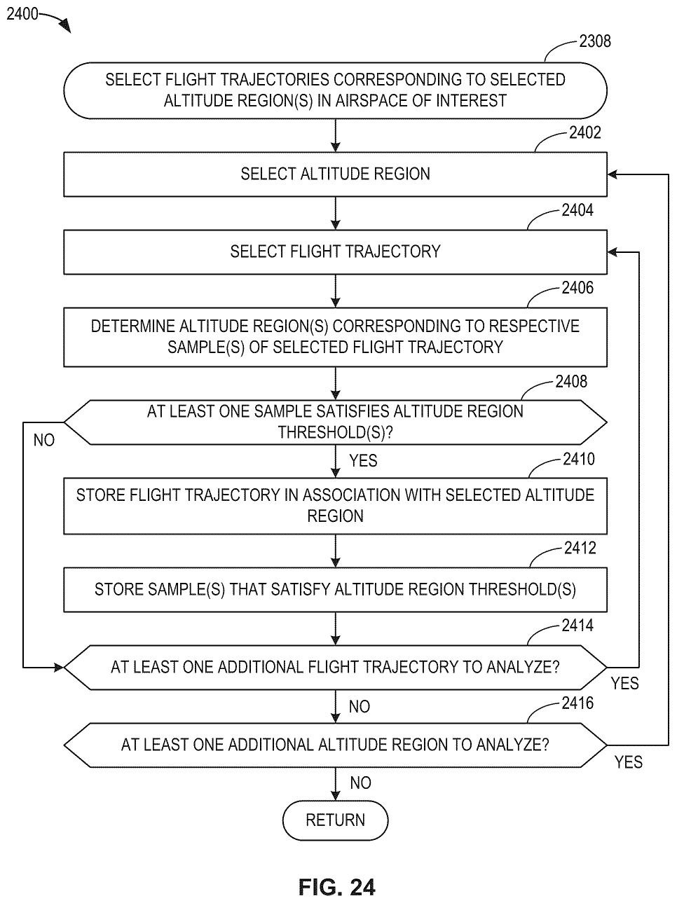

At block 2308, the example risk estimation circuitry 102 selects one(s) of the flight trajectories corresponding to selected altitude region(s) in the airspace of interest. For example, the example altitude analysis circuitry 206 of FIG. 2 performs an example altitude slicing process described further below in connection with FIG. 24.

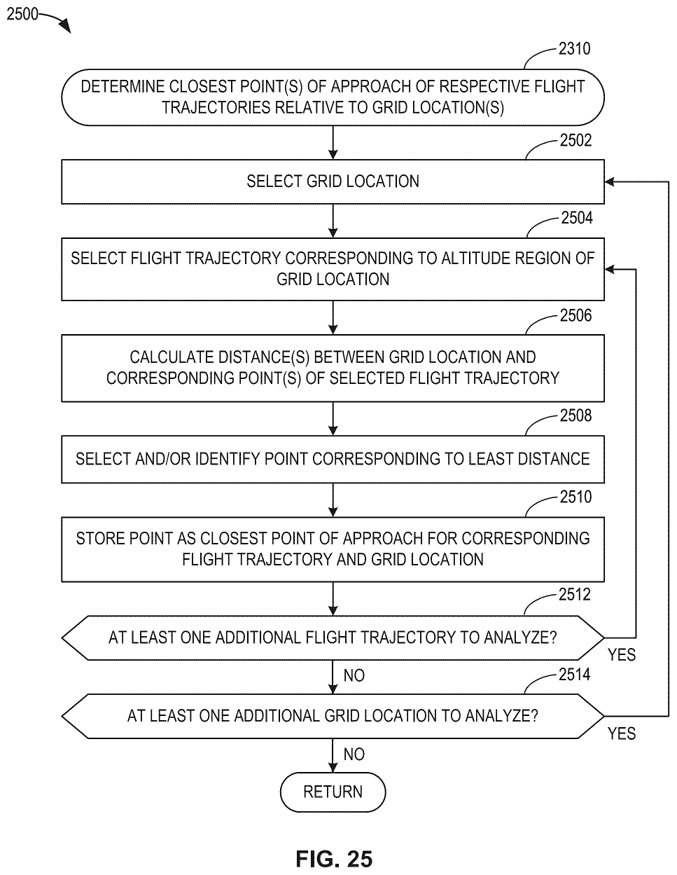

At block 2310, the example risk estimation circuitry 102 determines example closest point(s) of approach (CPA(s)) of respective one(s) of the flight trajectories relative to the grid location(s). For example, the example distance calculation circuitry 208 of FIG. 2 determines the CPA(s) based on an example process described further below in connection with FIG. 25.

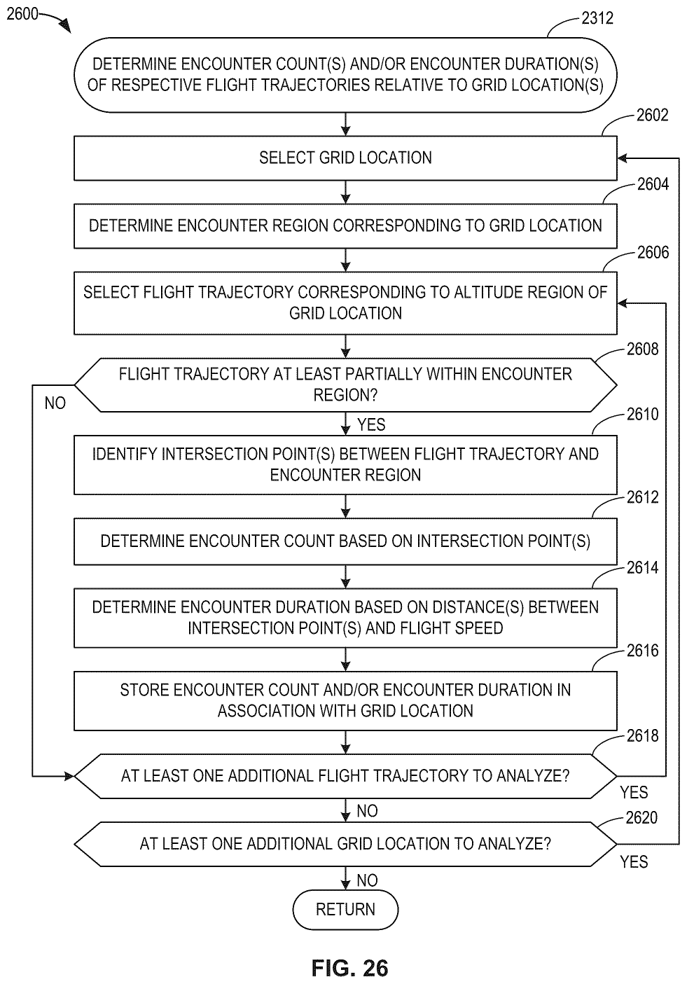

At block 2312, the example risk estimation circuitry 102 determines example encounter count(s) and/or encounter duration(s) corresponding to respective one(s) of the flight trajectories relative to the grid location(s). For example, the example encounter detection circuitry 210 of FIG. 2 determines the encounter count(s) and/or the encounter duration(s) based on an example process described further below in connection with FIG. 26.

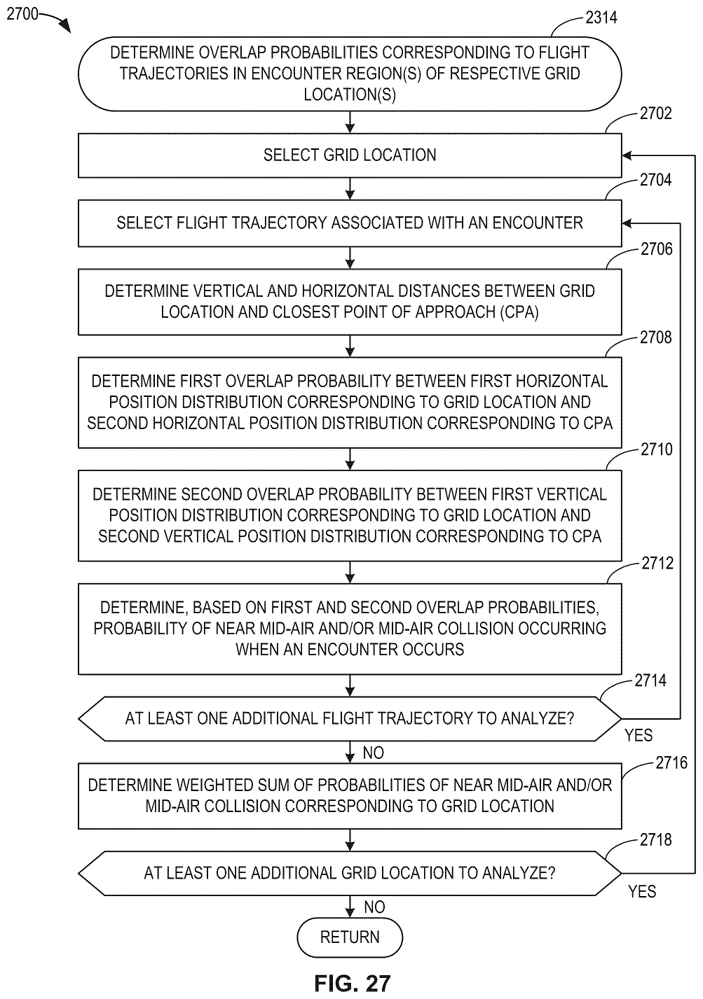

At block 2314, the example risk estimation circuitry 102 determines example overlap probabilities (e.g., vertical and/or horizontal overlap probabilities) corresponding to one(s) of the flight trajectories in example encounter region(s) of the respective grid location(s). For example, the example probability estimation circuitry 212 determines the overlap probabilities based on an example process described further below in connection with FIG. 27.

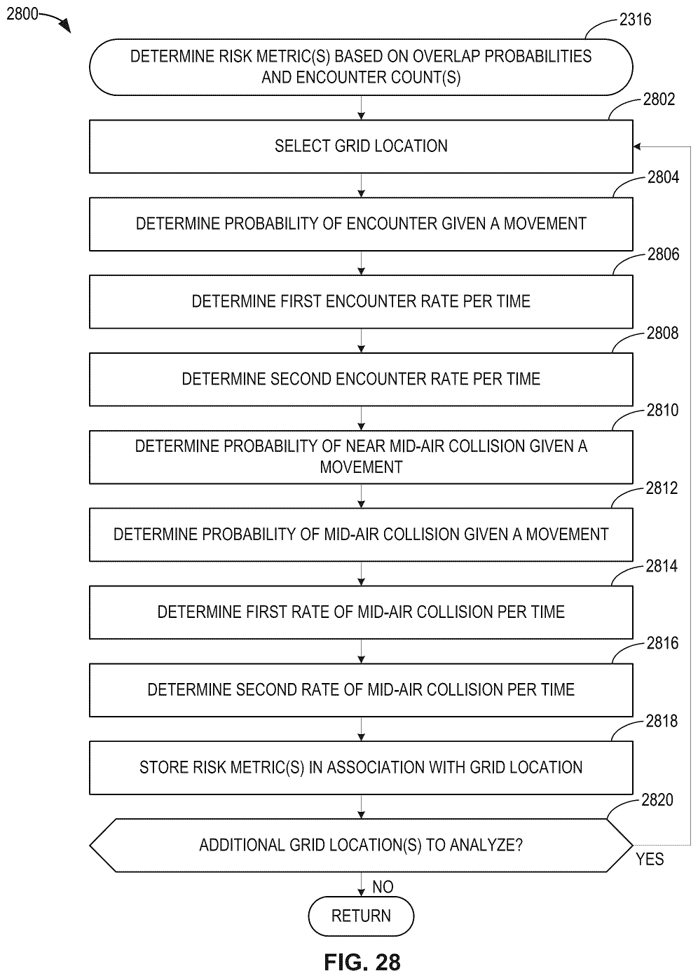

At block 2316, the example risk estimation circuitry 102 determines one or more example risk metrics based on the overlap probabilities and/or the encounter count(s). For example, the example risk metric determination circuitry 214 determines the risk metric(s) based on an example process described further below in connection with FIG. 28.

At block 2318, the example risk estimation circuitry 102 generates one or more example risk maps based on the determined risk metric(s) and the process ends. For example, the example map generation circuitry 216 of FIG. 2 generates the risk map(s) representative of the risk metric(s) determined for respective geographic location(s), altitude level(s), and/or duration(s). In some examples, the map generation circuitry 216 causes presentation (e.g., display) of the risk map(s) (e.g., via the electronic device 104 of FIG. 1) to facilitate flight planning and/or navigation for one or more aircraft.

FIG. 24 is a flowchart representative of example machine readable instructions and/or example operations 2400 that may be executed, instantiated, and/or performed by the example risk estimation circuitry 102 of FIGS. 1 and/or 2 to select one or more example flight trajectories corresponding to example selected altitude region(s) (e.g., in connection with block 2308 of FIG. 23). The example machine-readable instructions and/or the example operations 2400 of FIG. 24 begin at block 2402, at which the example altitude analysis circuitry 206 selects an example altitude region (e.g., an altitude level region) from one or more altitude regions of interest that are within a given airspace (e.g., an airspace of interest). For example, the altitude region(s) of interest correspond to one or more grid locations for which risk metric(s) are to be determined.

At block 2404, the altitude analysis circuitry 206 selects a flight trajectory (e.g., a first flight trajectory) from one(s) of the flight trajectories included in the example surveillance data 106 of FIGS. 1 and/or 2.

At block 2406, the altitude analysis circuitry 206 determines the altitude region(s) corresponding to respective sample(s) of the selected flight trajectory.

At block 2408, the altitude analysis circuitry 206 determines whether at least one of the altitude region(s) of the respective sample(s) satisfies one or more example altitude region threshold(s) (e.g., threshold encounter vertical distance(s)). For example, the altitude analysis circuitry 206 determines whether one or more of the sample(s) are within a threshold encounter vertical distance (e.g., ±750 ft, ±1000 ft, etc.) from the selected altitude region of interest.

In response to the altitude analysis circuitry 206 determining that at least one of the sample(s) satisfies the altitude region threshold(s) (e.g., block 2408 returns a result of YES), the altitude analysis circuitry 206 stores (e.g., in the example database 222 of FIG. 2) the selected flight trajectory in association with the selected altitude region (block 2410), and further stores (e.g., in the database 222) the sample(s) that satisfy the altitude region threshold(s) (block 2412). Alternatively, in response to the altitude analysis circuitry 206 determining that the sample(s) do not satisfy the altitude region threshold(s) (e.g., block 2408 returns a result of NO), control proceeds to block 2414.

At block 2414, the altitude analysis circuitry 206 determines whether there is at least one additional flight trajectory to analyze. In response to the altitude analysis circuitry 206 determining there is at least one additional flight trajectory to analyze (e.g., block 2414 returns a result of YES), control returns to block 2404. Alternatively, in response to the altitude analysis circuitry 206 determining there are no additional flight trajectories to analyze (e.g., block 2414 returns a result of NO), the altitude analysis circuitry 206 determines whether there is at least one additional altitude level to analyze (block 2416). In response to the altitude analysis circuitry 206 determining there is at least one additional altitude region to analyze (e.g., block 2416 returns a result of YES), control returns to block 2402. Alternatively, in response to the altitude analysis circuitry 206 determining there are no additional altitude regions to analyze (e.g., block 2416 returns a result of NO), control proceeds to block 2310 of FIG. 23.

FIG. 25 is a flowchart representative of example machine readable instructions and/or example operations 2500 that may be executed, instantiated, and/or performed by the example risk estimation circuitry 102 of FIGS. 1 and/or 2 to determine one or more example CPAs (e.g., in connection with block 2310 of FIG. 23). The example machine-readable instructions and/or the example operations 2500 of FIG. 25 begin at block 2502, at which the example distance calculation circuitry 208 of FIG. 2 selects an example grid location (e.g., a first grid location) from the grid location(s) to be analyzed.

At block 2504, the distance calculation circuitry 208 selects an example flight trajectory (e.g., a first flight trajectory) corresponding to an altitude region of the selected grid location. For example, the distance calculation circuitry 208 selects the flight trajectory from the flight trajectories satisfying one or more altitude region thresholds (e.g., identified by the example altitude analysis circuitry 206 of FIG. 2 in connection with block 2308 of FIG. 23).

At block 2506, the distance calculation circuitry 208 calculates example distance(s) (e.g., 3-D distances) between the selected grid location and corresponding example point(s) (e.g., sample(s)) of the selected flight trajectory.

At block 2508, the distance calculation circuitry 208 selects and/or identifies one of the points corresponding to a least distance to the selected grid location (e.g., compared to remaining one(s) of the points).

At block 2510, the distance calculation circuitry 208 stores (e.g., in the example database 222 of FIG. 2) the selected point as the closest point of approach (CPA) corresponding to the selected grid location and the selected flight trajectory.

At block 2512, the distance calculation circuitry 208 determines whether there is at least one additional flight trajectory to analyze (e.g., from the flight trajectories satisfying one or more altitude level thresholds of the grid location). In response to the distance calculation circuitry 208 determining that there is at least one additional flight trajectory to analyze (e.g., block 2512 returns a result of YES), control returns to block 2504. Alternatively, in response to the distance calculation circuitry 208 determining that there are no more flight trajectories to analyze (e.g., block 2512 returns a result of NO), the distance calculation circuitry 208 determines whether there is at least one additional grid location to analyze (block 2514). In response to the distance calculation circuitry 208 determining that there is at least one additional grid location to analyze (e.g., block 2514 returns a result of YES), control returns to block 2502. Alternatively, in response to the distance calculation circuitry 208 determining that there are no more grid locations to analyze (e.g., block 2514 returns a result of NO), control proceeds to block 2312 of FIG. 23.

FIG. 26 is a flowchart representative of example machine readable instructions and/or example operations 2600 that may be executed, instantiated, and/or performed by the example risk estimation circuitry 102 of FIGS. 1 and/or 2 to determine example encounter counts and/or example encounter durations (e.g., in connection with block 2312 of FIG. 23). The example machine-readable instructions and/or the example operations 2600 of FIG. 26 begin at block 2602, at which the example encounter detection circuitry 210 of FIG. 2 selects an example grid location (e.g., a first grid location) from one or more grid locations in an airspace to be analyzed.

At block 2604, the encounter detection circuitry 210 determines an encounter region (e.g., an encounter volume) corresponding to the selected grid location. For example, the encounter region can correspond to a circular region centered at the grid location and having a radius corresponding to an example threshold encounter horizontal distance (e.g., 4000 ft, 3000 ft, etc.).

At block 2606, the encounter detection circuitry 210 selects an example flight trajectory (e.g., a first flight trajectory) corresponding to an altitude region of the selected grid location. For example, the encounter detection circuitry 210 selects the flight trajectory from the flight trajectories satisfying one or more altitude region thresholds (e.g., identified by the example altitude analysis circuitry 206 of FIG. 2 in connection with block 2308 of FIG. 23).

At block 2608, the encounter detection circuitry 210 determines whether the selected flight trajectory is at least partially within the encounter region of the selected grid location. For example, the encounter detection circuitry 210 determines that the selected flight trajectory is at least partially within the encounter region when at least one sample of the selected flight trajectory is within a threshold distance (e.g., a threshold encounter horizontal distance) from the grid location. In response to the encounter detection circuitry 210 determining that the selected flight trajectory is at least partially within the encounter region (e.g., block 2608 returns a result of YES), the encounter detection circuitry 210 identifies one or more example intersection points between the selected flight trajectory and a boundary of the encounter region (block 2610), and determines an example encounter count based on the intersection point(s) (block 2612). In some examples, when multiple encounters are detected for an example flight trajectory, CPAs for respective encounter segments are determined. Further, the encounter detection circuitry 210 determines an example encounter duration based on example distance(s) between respective intersection point(s) and/or based on flight speed(s) along corresponding portion(s) of the selected flight trajectory (block 2614). In some examples, the encounter detection circuitry 210 stores (e.g., in the example database 222 of FIG. 2) the encounter count and/or encounter duration in association with the grid location and/or the selected flight trajectory (block 2616).

Alternatively, in response to the encounter detection circuitry 210 determining that the selected flight trajectory is not within the encounter region (e.g., block 2608 returns a result of NO), the encounter detection circuitry 210 determines whether there is at least one additional flight trajectory to analyze (e.g., from the flight trajectories satisfying one or more altitude level thresholds of the grid location). In response to the encounter detection circuitry 210 determining that there is at least one additional flight trajectory to analyze (e.g., block 2618 returns a result of YES), control returns to block 2606. Alternatively, in response to the encounter detection circuitry 210 determining that there are no more flight trajectories to analyze (e.g., block 2618 returns a result of NO), the encounter detection circuitry 210 determines whether there is at least one additional grid location to analyze (block 2620). In response to the encounter detection circuitry 210 determining that there is at least one additional grid location to analyze (e.g., block 2620 returns a result of YES), control returns to block 2602. Alternatively, in response to the encounter detection circuitry 210 determining that there are no more grid locations to analyze (e.g., block 2620 returns a result of NO), control proceeds to block 2314 of FIG. 23.

FIG. 27 is a flowchart representative of example machine readable instructions and/or example operations 2700 that may be executed, instantiated, and/or performed by the example risk estimation circuitry 102 of FIGS. 1 and/or 2 to determine example overlap probabilities (e.g., in connection with block 2314 of FIG. 23). The example machine-readable instructions and/or the example operations 2700 of FIG. 27 begin at block 2702, at which the example probability estimation circuitry 212 of FIG. 2 selects an example grid location (e.g., k) from one or more grid locations in an airspace to be analyzed.

At block 2704, the probability estimation circuitry 212 selects a flight trajectory (e.g., i) from one or more flight trajectories associated with an encounter with the selected grid location.

At block 2706, the probability estimation circuitry 212 determines example vertical and horizontal distances (e.g., d) between the selected grid location and the CPA of the selected flight trajectory.

At block 2708, the probability estimation circuitry 212 determines a first example overlap probability (e.g., a horizontal overlap probability P_{horz,i,k}) between a first horizontal position distribution corresponding to the grid location k (e.g., ƒ_{horz,k}) and a second horizontal position distribution corresponding to the CPA of the flight trajectory i (e.g., ƒ_{horz,i}). For example, the probability estimation circuitry 212 can determine the first overlap probability based on example Equations 7-14 above.

At block 2710, the probability estimation circuitry 212 determines a second example overlap probability (e.g., a vertical overlap probability P_{vert,i,k}) between a first vertical position distribution corresponding to the grid location k (e.g., ƒ_{vert,k}) and a second vertical position distribution corresponding to the CPA of the flight trajectory i (e.g., ƒ_{vert,i}). For example, the probability estimation circuitry 212 can determine the second overlap probability based on example Equations 15-18 above.

At block 2712, the probability estimation circuitry 212 determines, based on the first and second overlap probabilities, a probability of a NMAC occurring when an encounter occurs (e.g., Pᵢ(NMAC|ENC)ₖ) corresponding to the grid location k and the flight trajectory i. For example, the probability estimation circuitry 212 can determine the NMAC probability Pᵢ(NMAC|ENC)ₖ based on example Equation 6 above. In some examples, the probability estimation circuitry 212 determines the probability of a MAC occurring when an encounter occurs (e.g., Pᵢ(MAC|ENC)ₖ).

At block 2714, the probability estimation circuitry 212 determines whether there are any additional flight trajectories to analyze for the grid location k (e.g., whether there is at least one additional trajectory in an encounter region of the grid location). In response to the probability estimation circuitry 212 determining there is at least one additional flight trajectory to analyze (e.g., block 2714 returns a result of YES), control returns to block 2704. Alternatively, in response to the probability estimation circuitry 212 determining there are no additional flight trajectories to analyze (e.g., block 2714 returns a result of NO), control proceeds to block 2716.

At block 2716, the probability estimation circuitry 212 determines a sum of NMAC probabilities corresponding to the grid location k (e.g., P(NMAC|ENC)ₖ). For example, the probability estimation circuitry 212 can determine the sum of the NMAC probabilities based on example Equation 5 above. In some examples, the probability estimation circuitry 212 determines a sum of MAC probabilities corresponding to the grid location k (e.g., P(MAC|ENC)ₖ).

At block 2718, the probability estimation circuitry 212 determines whether there is at least one additional grid location to analyze. In response to the probability estimation circuitry 212 determining that there is at least one additional grid location to analyze (e.g., block 2718 returns a result of YES), control returns to block 2702. Alternatively, in response to the probability estimation circuitry 212 determining that there are no additional grid locations to analyze (e.g., block 2718 returns a result of NO), control proceeds to block 2316 of FIG. 23.

FIG. 28 is a flowchart representative of example machine readable instructions and/or example operations 2800 that may be executed, instantiated, and/or performed by the example risk estimation circuitry 102 of FIGS. 1 and/or 2 to determine one or more example risk metrics (e.g., in connection with block 2316 of FIG. 23). The example machine-readable instructions and/or the example operations 2800 of FIG. 28 begin at block 2802, at which the example risk metric determination circuitry 214 of FIG. 2 selects an example grid location (e.g., k) from one or more grid locations in an airspace to be analyzed.

At block 2804, the example risk metric determination circuitry 214 determines, for the selected grid location k, an example probability of an encounter occurring when a movement occurs (e.g., P(ENC|MOV)ₖ) based on example Equation 4A above.

At block 2806, the example risk metric determination circuitry 214 determines, for the selected grid location k, a first example encounter rate per time (e.g., per hour) (e.g., λ_{ENC}_{_{H}}_{,k}) based on example Equation 4B above.

At block 2808, the example risk metric determination circuitry 214 determines, for the selected grid location k, a second example encounter rate per time (e.g., per flight hour) (e.g., λ_{ENC}_{_{FH}}_{,k}) based on example Equation 4C above.

At block 2810, the example risk metric determination circuitry 214 determines, for the selected grid location k, an example probability of a NMAC occurring when a movement occurs (e.g., P(NMAC|MOV)ₖ) based on the probability of a NMAC occurring when an encounter occurs (e.g., P(NMAC|ENC)ₖ) and the probability of an encounter occurring when a movement occurs (e.g., P(ENC|MOV)ₖ).

At block 2812, the example risk metric determination circuitry 214 determines, for the selected grid location k, an example probability of a MAC occurring when a movement occurs (e.g., P(MAC|MOV)ₖ) based on example Equation 19 above.

At block 2814, the example risk metric determination circuitry 214 determines, for the selected grid location k, a first example MAC rate per time (e.g., per hour) (e.g.,λ_{MAC}_{_{H}}_{,k}) based on example Equation 20 above and the first example encounter rate per time (e.g., per hour) (e.g., λ_{ENC}_{_{H}}_{,k}).

At block 2816, the example risk metric determination circuitry 214 determines, for the selected grid location k, a second example MAC rate per time (e.g., per flight hour) (e.g., λ_{MAC}_{_{FH}}_{,k}) based on example Equation 20 above and the second example encounter rate per time (e.g., per flight hour) (e.g., λ_{ENC}_{_{FH}}_{,k}).

At block 2818, the example risk metric determination circuitry 214 stores (e.g., in the example database 222 of FIG. 2) one(s) of the risk metrics (e.g., the probability of an encounter occurring when a movement occurs P(ENC|MOV)ₖ, the encounter rate per hour λ_{ENC}_{_{H}}_{,k}, the encounter rate per flight hour λ_{ENC}_{_{FH}}_{,k}, the probability of a NMAC occurring when a movement occurs P(NMAC|MOV)ₖ, the probability of a MAC occurring when a movement occurs P(MAC|MOV)ₖ, the MAC rate per time (e.g., per hour) λ_{MAC}_{_{H}}_{,k}, and/or the MAC rate per time (e.g., per flight hour) λ_{MAC}_{_{FH}}_{,k}) in association with the grid location k.

At block 2820, the example risk metric determination circuitry 214 determines whether there are additional grid location(s) to analyze (e.g., whether there are additional grid location(s) for which risk metric(s) are to be determined). In response to the risk metric determination circuitry 214 determining that there is at least one additional grid location to analyze (e.g., block 2820 returns a result of YES), control returns to block 2820. Alternatively, in response to the risk metric determination circuitry 214 determining that there are no additional grid locations to analyze (e.g., block 2820 returns a result of NO), control proceeds to block 2318 of FIG. 23.

FIG. 29 is a flowchart representative of example machine readable instructions and/or example operations 2900 that may be executed, instantiated, and/or performed by the example risk estimation circuitry 102 of FIGS. 1 and/or 2 to evaluate example risk metric(s) corresponding to an example mission trajectory. The example machine-readable instructions and/or the example operations 2900 of FIG. 29 begin at block 2902, at which the example mission evaluation circuitry 218 of FIG. 2 accesses and/or generates an example mission trajectory for an example aircraft (e.g., a UAS) from an example starting location to an example target destination within an example airspace.

At block 2904, the mission evaluation circuitry 218 identifies one or more example intersection points between the mission trajectory and one or more example contours (e.g., risk contours) of one or more example risk map(s) generated for the example airspace.

At block 2906, the mission evaluation circuitry 218 updates the mission trajectory to include the example intersection point(s). For example, the mission evaluation circuitry 218 includes, in addition to existing sample(s) of the mission trajectory, additional sample(s) corresponding to the intersection point(s).

At block 2908, the mission evaluation circuitry 218 determines example distance(s) of one or more example flight legs of the mission trajectory. Further, at block 2910, the mission evaluation circuitry 218 determines duration(s) corresponding to the respective flight leg(s).

At block 2912, the mission evaluation circuitry 218 determines, based on the risk map(s) corresponding to the airspace of the mission trajectory, example risk metric(s) corresponding to respective flight leg(s) of the mission trajectory. For example, the mission evaluation circuitry 218 determines, based on the risk map(s), MAC rates (e.g., per hour and/or per flight hour) corresponding to respective one(s) of the flight leg(s).

At block 2914, the mission evaluation circuitry 218 determines an example mission risk metric based on the risk metric(s) corresponding to the respective flight leg(s). For example, the mission evaluation circuitry 218 determines the mission risk metric (e.g., a MAC rate per mission λ_{MAC,M}) based on example Equation 23 above.

At block 2916, the mission evaluation circuitry 218 determines whether the mission risk satisfies one or more example threshold(s) (e.g., mission risk threshold(s)). For example, the mission evaluation circuitry 218 determines whether the mission risk metric of the mission trajectory and/or the risk metric(s) for respective flight leg(s) satisfy the mission risk threshold(s). In response to the mission evaluation circuitry 218 determining that the mission risk metric(s) do not satisfy the mission risk threshold(s) (e.g., block 2916 returns a result of NO), the mission evaluation circuitry 218 adjusts the mission flight trajectory (block 2918) by adjusting, for example, position(s) of one or more of the flight legs of the mission trajectory. In some examples, control returns to block 2904, and the mission evaluation circuitry 218 re-evaluates (e.g., determines new mission risk metric(s)) corresponding to the adjusted mission trajectory.

Alternatively, in response to the mission evaluation circuitry 218 determining that the mission risk metric(s) satisfy the mission risk threshold(s) (e.g., block 2916 returns a result of YES), the mission evaluation circuitry 218 stores (e.g., in the example database 222 of FIG. 2) and/or presents (e.g., via the example electronic device 104 of FIG. 1) the determined mission risk metric(s) in association with the mission trajectory (block 2920), and the process ends.

FIG. 30 is a flowchart representative of example machine readable instructions and/or example operations 3000 that may be executed, instantiated, and/or performed by the example risk estimation circuitry 102 of FIGS. 1 and/or 2 to adjust a flight plan based on inferred intent of an aircraft. The example machine-readable instructions and/or the example operations 3000 of FIG. 30 begin at block 3002, at which the example flight planning circuitry 220 of FIG. 2 infers intent of a first example aircraft based on a position of the first aircraft and/or based on one or more example risk maps. For example, the flight planning circuitry 220 infers and/or predicts a flight trajectory and/or a direction of travel of the first aircraft based on the risk map(s).

At block 3004, the flight planning circuitry 220 adjusts a flight plan for a second aircraft based on the inferred intent and/or based the risk map(s), and the process ends. For example, the flight planning circuitry 220 adjusts the flight plan to move in a direction different from (e.g., away from) the predicted flight trajectory of the first aircraft to avoid and/or reduce risk of collision with the first aircraft. In some examples, the flight planning circuitry 220 can present the adjusted flight plan to an operator of the second aircraft (e.g., via the electronic device 104 of FIG. 1) and/or can automatically steer and/or control the second aircraft along the adjusted flight path.

FIG. 31 is a block diagram of an example programmable circuitry platform 3100 structured to execute and/or instantiate the example machine-readable instructions and/or the example operations of FIGS. 23-30 to implement the risk estimation circuitry 102 of FIG. 2. The programmable circuitry platform 3100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 3100 of the illustrated example includes programmable circuitry 3112. The programmable circuitry 3112 of the illustrated example is hardware. For example, the programmable circuitry 3112 can be implemented by one or more integrated circuits, logic circuits, FPGAs, microprocessors, CPUs, GPUs, DSPs, and/or microcontrollers from any desired family or manufacturer. The programmable circuitry 3112 may be implemented by one or more semiconductor based (e.g., silicon based) devices. In this example, the programmable circuitry 3112 implements the example input interface circuitry 202, the example data preprocessing circuitry 204, the example altitude analysis circuitry 206, the example distance calculation circuitry 208, the example encounter detection circuitry 210, the example probability estimation circuitry 212, the example risk metric determination circuitry 214, the example map generation circuitry 216, the example mission evaluation circuitry 218, the example flight planning circuitry 220, and the example database 222.

The programmable circuitry 3112 of the illustrated example includes a local memory 3113 (e.g., a cache, registers, etc.). The programmable circuitry 3112 of the illustrated example is in communication with main memory 3114, 3116, which includes a volatile memory 3114 and a non-volatile memory 3116, by a bus 3118. The volatile memory 3114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 3116 may be implemented by flash memory and/or any other desired type of memory device. Access to the main memory 3114, 3116 of the illustrated example is controlled by a memory controller 3117. In some examples, the memory controller 3117 may be implemented by one or more integrated circuits, logic circuits, microcontrollers from any desired family or manufacturer, or any other type of circuitry to manage the flow of data going to and from the main memory 3114, 3116.

The programmable circuitry platform 3100 of the illustrated example also includes interface circuitry 3120. The interface circuitry 3120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 3122 are connected to the interface circuitry 3120. The input device(s) 3122 permit(s) a user (e.g., a human user, a machine user, etc.) to enter data and/or commands into the programmable circuitry 3112. The input device(s) 3122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 3124 are also connected to the interface circuitry 3120 of the illustrated example. The output device(s) 3124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 3120 of the illustrated example, thus, typically includes a graphics driver card, a graphics driver chip, and/or graphics processor circuitry such as a GPU.

The interface circuitry 3120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 3126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 3100 of the illustrated example also includes one or more mass storage discs or devices 3128 to store firmware, software, and/or data. Examples of such mass storage discs or devices 3128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 3132, which may be implemented by the machine readable instructions of FIGS. 23-30, may be stored in the mass storage device 3128, in the volatile memory 3114, in the non-volatile memory 3116, and/or on at least one non-transitory computer readable storage medium such as a CD or DVD which may be removable.

FIG. 32 is a block diagram of an example implementation of the programmable circuitry 3112 of FIG. 31. In this example, the programmable circuitry 3112 of FIG. 31 is implemented by a microprocessor 3200. For example, the microprocessor 3200 may be a general-purpose microprocessor (e.g., general-purpose microprocessor circuitry). The microprocessor 3200 executes some or all of the machine-readable instructions of the flowcharts of FIGS. 23-30 to effectively instantiate the circuitry of FIG. 2 as logic circuits to perform operations corresponding to those machine readable instructions. In some such examples, the circuitry of FIG. 2 is instantiated by the hardware circuits of the microprocessor 3200 in combination with the machine-readable instructions. For example, the microprocessor 3200 may be implemented by multi-core hardware circuitry such as a CPU, a DSP, a GPU, an XPU, etc. Although it may include any number of example cores 3202 (e.g., 1 core), the microprocessor 3200 of this example is a multi-core semiconductor device including N cores. The cores 3202 of the microprocessor 3200 may operate independently or may cooperate to execute machine readable instructions. For example, machine code corresponding to a firmware program, an embedded software program, or a software program may be executed by one of the cores 3202 or may be executed by multiple ones of the cores 3202 at the same or different times. In some examples, the machine code corresponding to the firmware program, the embedded software program, or the software program is split into threads and executed in parallel by two or more of the cores 3202. The software program may correspond to a portion or all of the machine readable instructions and/or operations represented by the flowcharts of FIGS. 23-30.

The cores 3202 may communicate by a first example bus 3204. In some examples, the first bus 3204 may be implemented by a communication bus to effectuate communication associated with one(s) of the cores 3202. For example, the first bus 3204 may be implemented by at least one of an Inter-Integrated Circuit (I2C) bus, a Serial Peripheral Interface (SPI) bus, a PCI bus, or a PCIe bus. Additionally or alternatively, the first bus 3204 may be implemented by any other type of computing or electrical bus. The cores 3202 may obtain data, instructions, and/or signals from one or more external devices by example interface circuitry 3206. The cores 3202 may output data, instructions, and/or signals to the one or more external devices by the interface circuitry 3206. Although the cores 3202 of this example include example local memory 3220 (e.g., Level 1 (L1) cache that may be split into an L1 data cache and an L1 instruction cache), the microprocessor 3200 also includes example shared memory 3210 that may be shared by the cores (e.g., Level 2 (L2 cache)) for high-speed access to data and/or instructions. Data and/or instructions may be transferred (e.g., shared) by writing to and/or reading from the shared memory 3210. The local memory 3220 of each of the cores 3202 and the shared memory 3210 may be part of a hierarchy of storage devices including multiple levels of cache memory and the main memory (e.g., the main memory 3114, 3116 of FIG. 31). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 3202 may be referred to as a CPU, DSP, GPU, etc., or any other type of hardware circuitry. Each core 3202 includes control unit circuitry 3214, arithmetic and logic (AL) circuitry (sometimes referred to as an ALU) 3216, a plurality of registers 3218, the local memory 3220, and a second example bus 3222. Other structures may be present. For example, each core 3202 may include vector unit circuitry, single instruction multiple data (SIMD) unit circuitry, load/store unit (LSU) circuitry, branch/jump unit circuitry, floating-point unit (FPU) circuitry, etc. The control unit circuitry 3214 includes semiconductor-based circuits structured to control (e.g., coordinate) data movement within the corresponding core 3202. The AL circuitry 3216 includes semiconductor-based circuits structured to perform one or more mathematic and/or logic operations on the data within the corresponding core 3202. The AL circuitry 3216 of some examples performs integer based operations. In other examples, the AL circuitry 3216 also performs floating-point operations. In yet other examples, the AL circuitry 3216 may include first AL circuitry that performs integer-based operations and second AL circuitry that performs floating-point operations. In some examples, the AL circuitry 3216 may be referred to as an Arithmetic Logic Unit (ALU).

The registers 3218 are semiconductor-based structures to store data and/or instructions such as results of one or more of the operations performed by the AL circuitry 3216 of the corresponding core 3202. For example, the registers 3218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 3218 may be arranged in a bank as shown in FIG. 32. Alternatively, the registers 3218 may be organized in any other arrangement, format, or structure, such as by being distributed throughout the core 3202 to shorten access time. The second bus 3222 may be implemented by at least one of an I2C bus, a SPI bus, a PCI bus, or a PCIe bus.

Each core 3202 and/or, more generally, the microprocessor 3200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 3200 is a semiconductor device fabricated to include many transistors interconnected to implement the structures described above in one or more integrated circuits (ICs) contained in one or more packages.

The microprocessor 3200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 3200, in the same chip package as the microprocessor 3200 and/or in one or more separate packages from the microprocessor 3200.

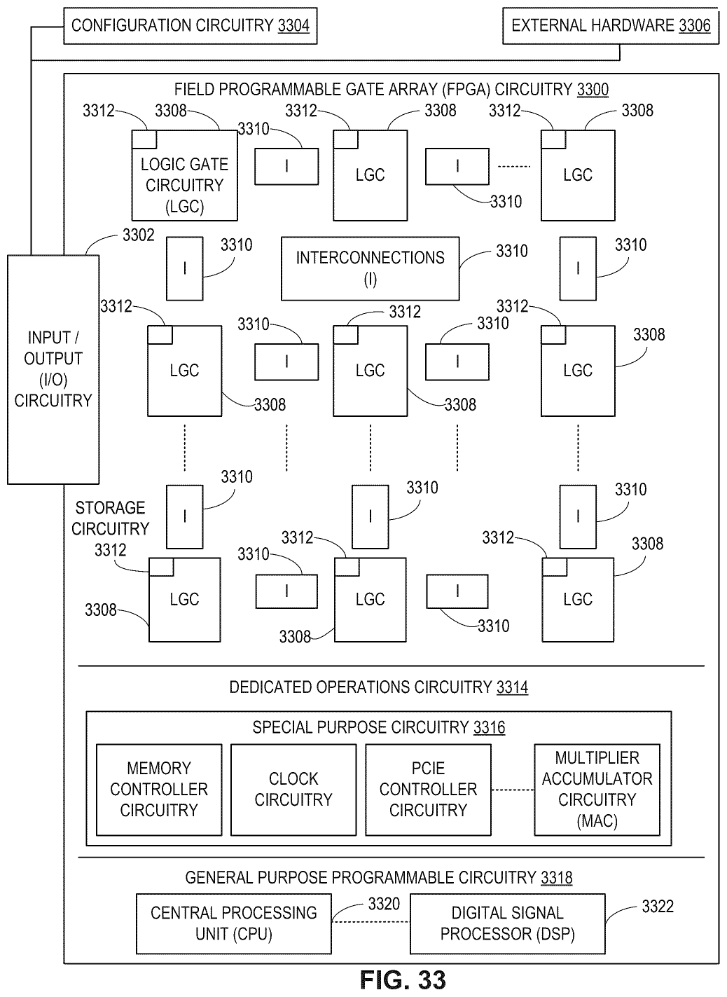

FIG. 33 is a block diagram of another example implementation of the programmable circuitry 3112 of FIG. 31. In this example, the programmable circuitry 3112 is implemented by FPGA circuitry 3300. For example, the FPGA circuitry 3300 may be implemented by an FPGA. The FPGA circuitry 3300 can be used, for example, to perform operations that could otherwise be performed by the example microprocessor 3200 of FIG. 32 executing corresponding machine readable instructions. However, once configured, the FPGA circuitry 3300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 3200 of FIG. 32 described above (which is a general purpose device that may be programmed to execute some or all of the machine readable instructions represented by the flowchart(s) of FIGS. 23-30 but whose interconnections and logic circuitry are fixed once fabricated), the FPGA circuitry 3300 of the example of FIG. 33 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 23-30. In particular, the FPGA circuitry 3300 may be thought of as an array of logic gates, interconnections, and switches. The switches can be programmed to change how the logic gates are interconnected by the interconnections, effectively forming one or more dedicated logic circuits (unless and until the FPGA circuitry 3300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 23-30. As such, the FPGA circuitry 3300 may be configured and/or structured to effectively instantiate some or all of the operations/functions corresponding to the machine readable instructions of the flowchart(s) of FIGS. 23-30 as dedicated logic circuits to perform the operations/functions corresponding to those software instructions in a dedicated manner analogous to an ASIC. Therefore, the FPGA circuitry 3300 may perform the operations/functions corresponding to the some or all of the machine readable instructions of FIGS. 23-30 faster than the general-purpose microprocessor can execute the same.

In the example of FIG. 33, the FPGA circuitry 3300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 3300 of FIG. 33 may access and/or load the binary file to cause the FPGA circuitry 3300 of FIG. 33 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 3300 of FIG. 33 to cause configuration and/or structuring of the FPGA circuitry 3300 of FIG. 33, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 3300 of FIG. 33 may access and/or load the binary file to cause the FPGA circuitry 3300 of FIG. 33 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 3300 of FIG. 33 to cause configuration and/or structuring of the FPGA circuitry 3300 of FIG. 33, or portion(s) thereof.

The FPGA circuitry 3300 of FIG. 33, includes example input/output (I/O) circuitry 3302 to obtain and/or output data to/from example configuration circuitry 3304 and/or external hardware 3306. For example, the configuration circuitry 3304 may be implemented by interface circuitry that may obtain a binary file, which may be implemented by a bit stream, data, and/or machine-readable instructions, to configure the FPGA circuitry 3300, or portion(s) thereof. In some such examples, the configuration circuitry 3304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 3306 may be implemented by external hardware circuitry. For example, the external hardware 3306 may be implemented by the microprocessor 3200 of FIG. 32.

The FPGA circuitry 3300 also includes an array of example logic gate circuitry 3308, a plurality of example configurable interconnections 3310, and example storage circuitry 3312. The logic gate circuitry 3308 and the configurable interconnections 3310 are configurable to instantiate one or more operations/functions that may correspond to at least some of the machine readable instructions of FIGS. 23-30 and/or other desired operations. The logic gate circuitry 3308 shown in FIG. 33 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 3308 to enable configuration of the electrical structures and/or the logic gates to form circuits to perform desired operations/functions. The logic gate circuitry 3308 may include other electrical structures such as look-up tables (LUTs), registers (e.g., flip-flops or latches), multiplexers, etc.

The configurable interconnections 3310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 3308 to program desired logic circuits.

The storage circuitry 3312 of the illustrated example is structured to store result(s) of the one or more of the operations performed by corresponding logic gates. The storage circuitry 3312 may be implemented by registers or the like. In the illustrated example, the storage circuitry 3312 is distributed amongst the logic gate circuitry 3308 to facilitate access and increase execution speed.

The example FPGA circuitry 3300 of FIG. 33 also includes example dedicated operations circuitry 3314. In this example, the dedicated operations circuitry 3314 includes special purpose circuitry 3316 that may be invoked to implement commonly used functions to avoid the need to program those functions in the field. Examples of such special purpose circuitry 3316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 3300 may also include example general purpose programmable circuitry 3318 such as an example CPU 3320 and/or an example DSP 3322. Other general purpose programmable circuitry 3318 may additionally or alternatively be present such as a GPU, an XPU, etc., that can be programmed to perform other operations.

Although FIGS. 32 and 33 illustrate two example implementations of the programmable circuitry 3112 of FIG. 31, many other approaches are contemplated. For example, FPGA circuitry may include an on-board CPU, such as one or more of the example CPU 3320 of FIG. 32. Therefore, the programmable circuitry 3112 of FIG. 31 may additionally be implemented by combining at least the example microprocessor 3200 of FIG. 32 and the example FPGA circuitry 3300 of FIG. 33. In some such hybrid examples, one or more cores 3202 of FIG. 32 may execute a first portion of the machine readable instructions represented by the flowchart(s) of FIGS. 23-30 to perform first operation(s)/function(s), the FPGA circuitry 3300 of FIG. 33 may be configured and/or structured to perform second operation(s)/function(s) corresponding to a second portion of the machine readable instructions represented by the flowcharts of FIG. 23-30, and/or an ASIC may be configured and/or structured to perform third operation(s)/function(s) corresponding to a third portion of the machine readable instructions represented by the flowcharts of FIGS. 23-30.

It should be understood that some or all of the circuitry of FIG. 2 may, thus, be instantiated at the same or different times. For example, same and/or different portion(s) of the microprocessor 3200 of FIG. 32 may be programmed to execute portion(s) of machine-readable instructions at the same and/or different times. In some examples, same and/or different portion(s) of the FPGA circuitry 3300 of FIG. 33 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 3200 of FIG. 32 may execute machine readable instructions in one or more threads executing concurrently and/or in series. In some examples, the FPGA circuitry 3300 of FIG. 33 may be configured and/or structured to carry out operations/functions concurrently and/or in series. Moreover, in some examples, some or all of the circuitry of FIG. 2 may be implemented within one or more virtual machines and/or containers executing on the microprocessor 3200 of FIG. 32.

In some examples, the programmable circuitry 3112 of FIG. 31 may be in one or more packages. For example, the microprocessor 3200 of FIG. 32 and/or the FPGA circuitry 3300 of FIG. 33 may be in one or more packages. In some examples, an XPU may be implemented by the programmable circuitry 3112 of FIG. 31, which may be in one or more packages. For example, the XPU may include a CPU (e.g., the microprocessor 3200 of FIG. 32, the CPU 3320 of FIG. 33, etc.) in one package, a DSP (e.g., the DSP 3322 of FIG. 33) in another package, a GPU in yet another package, and an FPGA (e.g., the FPGA circuitry 3300 of FIG. 33) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that generate example risk map(s) (e.g., MAC risk map(s)) for use in flight planning. Examples disclosed herein determine overlap between a first probability distribution corresponding to a grid location and a second probability distribution corresponding to a point (e.g., a CPA) along a flight trajectory. Based on the overlap, disclosed examples determine one or more example risk metric(s) corresponding to the grid location, where the risk metric(s) can include at least one of a MAC probability (e.g., a MAC likelihood) or a MAC rate. In some examples, the risk metric(s) can be used to generate one or more risk maps which, in turn, can be used to select and/or adjust flight trajectories of aircraft to reduce collision risk during flight of the aircraft. Advantageously, by utilizing probability distributions to represent expected positions of aircraft in an airspace, disclosed examples can account for uncertainty associated with navigation and/or surveillance of the aircraft, thereby improving accuracy of risk estimates based on surveillance data. Further, by utilizing surveillance data to estimate the risk metric(s), examples disclosed herein can produce more detailed and/or granular risk map(s) (e.g., compared to some known qualitative-based risk estimation approaches). Based on the risk map(s), disclosed systems, apparatus, articles of manufacture, and methods can enable autonomous control of unmanned aircraft (e.g., a UAS) along a flight trajectory of reduced (e.g., least) collision risk when remote communication with the aircraft is severed and/or unavailable. Additionally, by reducing risk of collision during flight of an aircraft, examples disclosed herein can reduce risk of injuries, fatalities, loss of aircraft, etc. associated with a collision. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to generate example risk maps are disclosed herein. Further examples and combinations thereof include the following:
Example 1 includes an apparatus comprising interface circuitry, machine-readable instructions, and at least one processor circuit to be programmed by the machine-readable instructions to determine a horizontal distance and a vertical distance between a grid location in an airspace and a point of a flight trajectory, the flight trajectory associated with an encounter event with respect to the grid location, determine a first overlap probability between (a) a first horizontal probability distribution corresponding to the grid location and (b) a second horizontal probability distribution corresponding to the point, the second horizontal probability distribution corresponding to the horizontal distance, determine a second overlap probability between (c) a first vertical probability distribution corresponding to the grid location and (d) a second vertical probability distribution corresponding to the point, the second vertical probability distribution corresponding to the vertical distance, determine, based on the first overlap probability and the second overlap probability, a risk metric corresponding to the grid location, and generate a risk map based on the risk metric.
Example 2 includes the apparatus of example 1, wherein one or more of the at least one processor circuit is to determine, based on the risk map, a mission risk metric associated with a mission trajectory of an aircraft, compare the mission risk metric to a risk threshold, and adjust the mission trajectory based on the comparison.
Example 3 includes the apparatus of example 1, wherein the first and second horizontal probability distributions correspond to Normal-Double Exponential distributions, and the first and second vertical probability distributions correspond to Laplacian distributions.
Example 4 includes the apparatus of example 1, wherein one or more of the at least one processor circuit is to calculate three-dimensional (3-D) distances between the grid location and a plurality of points along the flight trajectory, and select the point corresponding to a lesser one of the calculated 3-D distances.
Example 5 includes the apparatus of example 1, wherein the risk metric includes at least one of a first probability of an encounter event occurring when a movement occurs in the airspace, a second probability of a mid-air collision (MAC) occurring when the movement occurs in the airspace, a first encounter rate per hour, a second encounter rate per flight hour, a MAC rate per hour, or a MAC rate per flight hour.
Example 6 includes the apparatus of example 1, wherein one or more of the at least one processor circuit is to predict intent of a first aircraft based on a position of the first aircraft and the risk map, the intent corresponding to an expected flight trajectory of the first aircraft, and adjust a flight plan of a second aircraft based on the predicted intent.
Example 7 includes the apparatus of example 1, wherein one or more of the at least one processor circuit is to identify the flight trajectory based on surveillance data associated with the airspace, the surveillance data filtered based on at least one of an altitude level corresponding to the grid location or a time frame.
Example 8 includes At least one non-transitory machine-readable medium comprising machine-readable instructions to cause at least one processor circuit to at least determine a horizontal distance and a vertical distance between a grid location in an airspace and a point of a flight trajectory, the flight trajectory associated with an encounter event with respect to the grid location, determine a first overlap probability between (a) a first horizontal probability distribution corresponding to the grid location and (b) a second horizontal probability distribution corresponding to the point, the second horizontal probability distribution corresponding to the horizontal distance, determine a second overlap probability between (c) a first vertical probability distribution corresponding to the grid location and (d) a second vertical probability distribution corresponding to the point, the second vertical probability distribution corresponding to the vertical distance, determine, based on the first overlap probability and the second overlap probability, a risk metric corresponding to the grid location, and generate a risk map based on the risk metric.
Example 9 includes the at least one non-transitory machine-readable medium of example 8, wherein the machine-readable instructions are to cause one or more of the at least one processor circuit to determine, based on the risk map, a mission risk metric associated with a mission trajectory of an aircraft, compare the mission risk metric to a risk threshold, and adjust the mission trajectory based on the comparison.
Example 10 includes the at least one non-transitory machine-readable medium of example 8, wherein the machine-readable instructions are to cause one or more of the at least one processor circuit to select the first and second horizontal probability distributions based on Normal-Double Exponential distributions, and select the first and second vertical probability distributions based on Laplacian distributions.
Example 11 includes the at least one non-transitory machine-readable medium of example 8, wherein the machine-readable instructions are to cause one or more of the at least one processor circuit to calculate three-dimensional (3-D) distances between the grid location and a plurality of points along the flight trajectory, and select the point corresponding to a lesser one of the calculated 3-D distances.
Example 12 includes the at least one non-transitory machine-readable medium of example 8, wherein the machine-readable instructions are to cause one or more of the at least one processor circuit to determine the risk metric by determining at least one of a first probability of an encounter event occurring when a movement occurs in the airspace, a second probability of a mid-air collision (MAC) occurring when the movement occurs in the airspace, a first encounter rate per hour, a second encounter rate per flight hour, a MAC rate per hour, or a MAC rate per flight hour.
Example 13 includes the at least one non-transitory machine-readable medium of example 8, wherein the machine-readable instructions are to cause one or more of the at least one processor circuit to predict intent of a first aircraft based on a position of the first aircraft and the risk map, the intent corresponding to an expected flight trajectory of the first aircraft, and adjust a flight plan of a second aircraft based on the predicted intent.
Example 14 includes the at least one non-transitory machine-readable medium of example 8, wherein the machine-readable instructions are to cause one or more of the at least one processor circuit to identify the flight trajectory based on surveillance data associated with the airspace, the surveillance data filtered based on at least one of an altitude level corresponding to the grid location or a time frame.
Example 15 includes a method comprising determining a horizontal distance and a vertical distance between a grid location in an airspace and a point of a flight trajectory, the flight trajectory associated with an encounter event with respect to the grid location, determining a first overlap probability between (a) a first horizontal probability distribution corresponding to the grid location and (b) a second horizontal probability distribution corresponding to the point, the second horizontal probability distribution corresponding to the horizontal distance, determining a second overlap probability between (c) a first vertical probability distribution corresponding to the grid location and (d) a second vertical probability distribution corresponding to the point, the second vertical probability distribution corresponding to the vertical distance, determining, based on the first overlap probability and the second overlap probability, a risk metric corresponding to the grid location, and generating a risk map based on the risk metric.
Example 16 includes the method of example 15, further including determining, based on the risk map, a mission risk metric associated with a mission trajectory of an aircraft, comparing the mission risk metric to a risk threshold, and adjusting the mission trajectory based on the comparison.
Example 17 includes the method of example 15, further including selecting the first and second horizontal probability distributions based on Normal-Double Exponential distributions, and selecting the first and second vertical probability distributions based on Laplacian distributions.
Example 18 includes the method of example 15, further including calculating three-dimensional (3-D) distances between the grid location and a plurality of points along the flight trajectory, and selecting the point corresponding to a lesser one of the calculated 3-D distances.
Example 19 includes the method of example 15, further including determining the risk metric by determining at least one of a first probability of an encounter event occurring when a movement occurs in the airspace, a second probability of a mid-air collision (MAC) occurring when the movement occurs in the airspace, a first encounter rate per hour, a second encounter rate per flight hour, a MAC rate per hour, or a MAC rate per flight hour.
Example 20 includes the method of example 15, further including predicting intent of a first aircraft based on a position of the first aircraft and the risk map, the intent corresponding to an expected flight trajectory of the first aircraft, and adjusting a flight plan of a second aircraft based on the predicted intent.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
determine a horizontal distance and a vertical distance between a grid location in an airspace and a point of a flight trajectory, the flight trajectory associated with an encounter event with respect to the grid location;
determine a first overlap probability between (a) a first horizontal probability distribution corresponding to the grid location and (b) a second horizontal probability distribution corresponding to the point, the second horizontal probability distribution corresponding to the horizontal distance;
determine a second overlap probability between (c) a first vertical probability distribution corresponding to the grid location and (d) a second vertical probability distribution corresponding to the point, the second vertical probability distribution corresponding to the vertical distance;
determine, based on the first overlap probability and the second overlap probability, a risk metric corresponding to the grid location; and
generate a risk map based on the risk metric.

2. The apparatus of claim 1, wherein one or more of the at least one processor circuit is to:
determine, based on the risk map, a mission risk metric associated with a mission trajectory of an aircraft;
compare the mission risk metric to a risk threshold; and
adjust the mission trajectory based on the comparison.

3. The apparatus of claim 1, wherein the first and second horizontal probability distributions correspond to Normal-Double Exponential distributions, and the first and second vertical probability distributions correspond to Laplacian distributions.

4. The apparatus of claim 1, wherein one or more of the at least one processor circuit is to:
calculate three-dimensional (3-D) distances between the grid location and a plurality of points along the flight trajectory; and
select the point corresponding to a lesser one of the calculated 3-D distances.

5. The apparatus of claim 1, wherein the risk metric includes at least one of a first probability of an encounter event occurring when a movement occurs in the airspace, a second probability of a mid-air collision (MAC) occurring when the movement occurs in the airspace, a first encounter rate per hour, a second encounter rate per flight hour, a MAC rate per hour, or a MAC rate per flight hour.

6. The apparatus of claim 1, wherein one or more of the at least one processor circuit is to:
predict intent of a first aircraft based on a position of the first aircraft and the risk map, the intent corresponding to an expected flight trajectory of the first aircraft; and
adjust a flight plan of a second aircraft based on the predicted intent.

7. The apparatus of claim 1, wherein one or more of the at least one processor circuit is to identify the flight trajectory based on surveillance data associated with the airspace, the surveillance data filtered based on at least one of an altitude level corresponding to the grid location or a time frame.

8. At least one non-transitory machine-readable medium comprising machine-readable instructions to cause at least one processor circuit to at least:
determine a horizontal distance and a vertical distance between a grid location in an airspace and a point of a flight trajectory, the flight trajectory associated with an encounter event with respect to the grid location;
determine a first overlap probability between (a) a first horizontal probability distribution corresponding to the grid location and (b) a second horizontal probability distribution corresponding to the point, the second horizontal probability distribution corresponding to the horizontal distance;
determine a second overlap probability between (c) a first vertical probability distribution corresponding to the grid location and (d) a second vertical probability distribution corresponding to the point, the second vertical probability distribution corresponding to the vertical distance;
determine, based on the first overlap probability and the second overlap probability, a risk metric corresponding to the grid location; and
generate a risk map based on the risk metric.

9. The at least one non-transitory machine-readable medium of claim 8, wherein the machine-readable instructions are to cause one or more of the at least one processor circuit to:
determine, based on the risk map, a mission risk metric associated with a mission trajectory of an aircraft;
compare the mission risk metric to a risk threshold; and
adjust the mission trajectory based on the comparison.

10. The at least one non-transitory machine-readable medium of claim 8, wherein the machine-readable instructions are to cause one or more of the at least one processor circuit to:
select the first and second horizontal probability distributions based on Normal-Double Exponential distributions; and
select the first and second vertical probability distributions based on Laplacian distributions.

11. The at least one non-transitory machine-readable medium of claim 8, wherein the machine-readable instructions are to cause one or more of the at least one processor circuit to:
calculate three-dimensional (3-D) distances between the grid location and a plurality of points along the flight trajectory; and
select the point corresponding to a lesser one of the calculated 3-D distances.

12. The at least one non-transitory machine-readable medium of claim 8, wherein the machine-readable instructions are to cause one or more of the at least one processor circuit to determine the risk metric by determining at least one of a first probability of an encounter event occurring when a movement occurs in the airspace, a second probability of a mid-air collision (MAC) occurring when the movement occurs in the airspace, a first encounter rate per hour, a second encounter rate per flight hour, a MAC rate per hour, or a MAC rate per flight hour.

13. The at least one non-transitory machine-readable medium of claim 8, wherein the machine-readable instructions are to cause one or more of the at least one processor circuit to:
predict intent of a first aircraft based on a position of the first aircraft and the risk map, the intent corresponding to an expected flight trajectory of the first aircraft; and
adjust a flight plan of a second aircraft based on the predicted intent.

14. The at least one non-transitory machine-readable medium of claim 8, wherein the machine-readable instructions are to cause one or more of the at least one processor circuit to identify the flight trajectory based on surveillance data associated with the airspace, the surveillance data filtered based on at least one of an altitude level corresponding to the grid location or a time frame.

15. A method comprising:
determining a horizontal distance and a vertical distance between a grid location in an airspace and a point of a flight trajectory, the flight trajectory associated with an encounter event with respect to the grid location;
determining a first overlap probability between (a) a first horizontal probability distribution corresponding to the grid location and (b) a second horizontal probability distribution corresponding to the point, the second horizontal probability distribution corresponding to the horizontal distance;
determining a second overlap probability between (c) a first vertical probability distribution corresponding to the grid location and (d) a second vertical probability distribution corresponding to the point, the second vertical probability distribution corresponding to the vertical distance;
determining, based on the first overlap probability and the second overlap probability, a risk metric corresponding to the grid location; and
generating a risk map based on the risk metric.

16. The method of claim 15, further including:
determining, based on the risk map, a mission risk metric associated with a mission trajectory of an aircraft;
comparing the mission risk metric to a risk threshold; and
adjusting the mission trajectory based on the comparison.

17. The method of claim 15, further including:
selecting the first and second horizontal probability distributions based on Normal-Double Exponential distributions; and
selecting the first and second vertical probability distributions based on Laplacian distributions.

18. The method of claim 15, further including:
calculating three-dimensional (3-D) distances between the grid location and a plurality of points along the flight trajectory; and
selecting the point corresponding to a lesser one of the calculated 3-D distances.

19. The method of claim 15, further including determining the risk metric by determining at least one of a first probability of an encounter event occurring when a movement occurs in the airspace, a second probability of a mid-air collision (MAC) occurring when the movement occurs in the airspace, a first encounter rate per hour, a second encounter rate per flight hour, a MAC rate per hour, or a MAC rate per flight hour.

20. The method of claim 15, further including:
predicting intent of a first aircraft based on a position of the first aircraft and the risk map, the intent corresponding to an expected flight trajectory of the first aircraft; and
adjusting a flight plan of a second aircraft based on the predicted intent.
